(19) United States
(12) Patent Application Publication
(10) Pub. No.: US 2014/0081652 A1
(43) Pub. Date: Mar. 20, 2014

(54) Automated Healthcare Risk Management System Utilizing Real-time Predictive Models, Risk Adjusted Provider Cost Index, Edit Analytics, Strategy Management, Managed Learning Environment, Contact Management, Forensic GUI, Case Management And Reporting System For Preventing And Detecting Healthcare Fraud, Abuse, Waste And Errors

(71) Applicant: Risk Management Solutions LLC, Maple Grove, MN (US)

(72) Inventor: Walter Allan Klindworth, Maple Grove, MN (US)

(73) Assignee: Risk Management Solutions LLC, Maple Grove, MN (US)

(21) Appl. No.: 14/027,193

(22) Filed: Sep. 14, 2013

Related U.S. Application Data
(60) Provisional application No. 61/701,087, filed on Sep. 14, 2012.

(51) Int. Cl. G06Q 10/06; G06Q 50/22; G06Q 20/00

(52) U.S. Cl. CPC G06Q 10/0635; G06Q 20/00; G06Q 50/22
USPC 705/2

(57) ABSTRACT

The Automated Healthcare Risk Management System is a real-time Software as a Service application which interfaces and assists investigators, law enforcement and risk management analysts by focusing their efforts on the highest risk and highest value healthcare payments. The system's Risk Management design utilizes real-time Predictive Models, a Provider Cost Index, Edit Analytics, Strategy Management, a Managed Learning Environment, Contact Management, Forensic GUI, Case Management and Reporting System for individually targeting, identifying and preventing fraud, abuse, waste and errors prior to payment. The Automated Healthcare Risk Management System analyzes hundreds of millions of transactions and automatically takes actions such as declining or queuing a suspect payment. Claim payment risk is optimally prioritized through a Managed Learning environment, from high risk to low risk for efficient resolution by investigators.

### CROSS-REFERENCE TO RELATED APPLICATIONS

This application claims priority to and provisional patent application 61/701,087, filed Sep. 14, 2012, the entire contents of which are hereby incorporated by reference. This application also incorporates the entire contents of each of the following patent applications: utility patent application Ser. No. 13/074,576, filed Mar. 29, 2011; provisional patent application 61/319,554, filed Mar. 31, 2010, provisional patent application 61/327,256, filed Apr. 23, 2010, utility patent application Ser. No. 13/617,085, filed Sep. 14, 2012, and provisional patent application 61/561,561, filed Nov. 18, 2011.

### STATEMENT REGARDING FEDERALLY SPONSORED RESEARCH

Not Applicable.

### FIELD OF THE INVENTION

The present invention is in the technical field of Analytical Technology focusing on Healthcare Improper Payment Prevention and Detection. Improper payments are hereby defined, collectively, as those payments containing or potentially containing individual cost dynamics, including but not limited to, fraud, abuse, over-servicing, over-utilization, waste or errors.

A plurality of external and internal data and predictive models, empirical Decision Management Strategies and decision codes are utilized in concert within a Software as a Service Risk Management System to identify and investigate claims that are potentially fraudulent, contain abuse, or over-servicing, over-utilization, waste or errors, or claims that are submitted by a potentially fraudulent, abusive or wasteful provider or healthcare merchant. The claim payments are researched, analyzed, reported on and subjected to empirical probabilistic strategy management procedures, actions or treatments.

More particularly, the present invention utilizes a research, analysis, empirical probabilistic strategy management and reporting software application system in order to optimally facilitate human interaction with and automated review of hundreds of millions of healthcare claims or transactions, or hundreds of thousands of providers or healthcare merchants that have been determined to be at high-risk for fraud and abusive practices or over servicing, wasteful or perpetrators of errors.

The invention is intended for use by government payers or merchants, defined as public sector, and private payers or merchants, defined as private sector, healthcare organizations, as well as any healthcare intermediary. Healthcare intermediary is defined as any entity that accepts healthcare data or payment information and completes data aggregation or standardization, claims processing or program administration, applies rules or edits, stores data or offers data mining software, performs address or identity analysis or credentialing, offers case management or workflow management or performs investigations for fraud, abuse, waste or errors or any other entity which handles, evaluates, approves or submits claim payments through any means. The invention can also be used by healthcare merchants or self-insured employers to reduce improper payments.

The invention can be applied within a plurality of healthcare segments such as Hospital, Inpatient Facilities, Outpatient Institutions, Physician, Pharmaceutical, Skilled Nursing Facilities, Hospice, Home Health, Durable Medical Equipment and Laboratories. The invention is also applicable to a plurality of medical specialties, such as family practice, orthopedics, internal medicine and dermatology, for example. The invention can be deployed in diverse data format environments and in separate or a plurality of geographies, such as by zip code, county, metropolitan statistical area, state or healthcare processor region. This application can integrate within multiple types of claims processing systems, or systems similar in logical structure to claims process flows to enable the review for law enforcement, investigators, analysts and business experts to interact with the suspect providers, healthcare merchants, claims, transactions or beneficiaries, in order to:
1. Review, in an automated and systematic method, hundreds of millions of claims or transactions to determine both valid and improper payments
2. Determine why providers, healthcare merchants, claims or beneficiaries were selected as suspect or potentially improper and provide reasons or explanations why they have a high likelihood or probability of being fraudulent, abusive, over-servicing, over-utilization, wasteful or containing errors
3. Define and set criteria and parameters real time, using for example, predictive models, scores, provider cost or waste indexes, edits or internal or external data to trigger and analyze why specific claims or transactions, created by providers, healthcare merchants or beneficiaries were determined to be risky
4. Provide a method to evaluate and analyze:
   a. Why individual claims and groups of claims or transactions have a high probability of being fraudulent or abusive, or even why claims or transactions were determined to not be fraudulent or abusive
   b. Import and assess current and historical data from multiple sources in a real-time fashion
   c. Complete cost benefit analysis that provides normalized estimates for fraud and abuse prevention, detection or recovery
   d. Risk adjusted waste, over servicing or overutilization assessments that calculate provider cost overages, that are presented mathematically and graphically for use in educating the provider or creating cohort benchmarks for determining punitive actions
   e. Provide an edit analytics “landing page” for claim or transaction error assessment analysis utilizing configurable tables for industry accepted or proprietary policy, compliance, or payment reject edits
5. Define and set overall fraud, abuse, over-servicing, over-utilization, waste or error treatment policies, strategies, procedures, actions or treatments
6. Set priorities and procedures for communications across multiple media types, including but not limited to mail, phone call, text message or email, with providers or beneficiaries and for treatment of high risk claim issues
7. Determine and create effective strategies that:
   a. Provides differing different levels of treatments or actions based upon economic spend and subsequent benefit or value measurement
   b. Allow contact optimization across multiple media and communication formats, including but not limited to, phone, email, letter or face to face
   c. Maximize return on investment (ROI) and use of capital, for dealing with claims or payments that have differing probability or likelihood levels of fraud or abuse, over-servicing, over-utilization, waste or errors, through use of tiered staffing levels based upon experience and cost
8. Create a Managed Learning Environment that:
   a. Monitors each empirical probabilistic strategy and measures behavior patterns and performance between test and control treatments or test and control actions
   b. Measures, identifies and provides for the quick adaptations of empirical strategies to changing patterns of improper payments associated with fraud or abuse, over-servicing, over-utilization, waste or errors
   c. Optimizes improper prevention and detection, which in turn optimizes return on investment (ROI), through differing levels of treatments and actions for each risk group or population
   d. Provides real-time triggers to activate intelligence capabilities, combined with predictive scoring models, provider cost or waste indexes, policy edits, for example, to take action when risk thresholds are exceeded
   e. Provides real time monitoring, measuring, identification and visual presentation of performance and changing patterns of fraud, abuse, over-servicing, over-utilization, waste or errors in a dashboard format for an operations (“ops”) room, control room or war-room type display environment
9. Provide standard, ad hoc, customizable and dynamic reporting capabilities to summarize performance, statistics and to better manage fraud and abuse risk, over-servicing, over-utilization, waste or error prevention and return on investment
10. Securely memorialize investigations, documentation, action, files and data that can be accessed through multiple electronic mediums, including, but not limited to such vehicles as a phone, computer and note pad.

### BACKGROUND

Healthcare fraud is a major policy concern. In a Senate Finance Committee hearing, Chairman Baucus (D-Mont.) stressed the need for measurable results in fighting fraud, which costs taxpayers an estimated $60 billion each year.ⁱ Senator Coburn (R-OK), an advocate for paring down deficits and debt into the future, stressed in a NPR interview, that reducing Medicare fraud is the first step in reducing the deficit.ⁱⁱ

The increase in improper payments associated with fraud, abuse, waste and errors will continue to escalate until core functional issues are addressed such as disparate systems, lack of meaningful analytics, ability to measure performance and lack of a coordinated risk management approach to attacking individual cost dynamics

Steps have been taken over the past several years in an attempt to attack rising healthcare expenditures due to healthcare fraud—but with minimal results. For example, The Tax Relief and Health Care Act of 2006 required Congress to implement a permanent and national Recovery Audit Contractor (RAC) program by Jan. 1, 2010. The national RAC program was the outgrowth of a successful demonstration program launched by the Centers for Medicare and Medicaid Services (CMS) that used RAC's to identify Medicare overpayments and underpayments to health care providers and suppliers in California, Florida, New York, Massachusetts, South Carolina and Arizona. The demonstration resulted in over $900 million in overpayments being returned to the Medicare Trust Fund between 2005 and 2008 and nearly $38 million in underpayments returned to health care providers.ⁱⁱⁱ While providing necessary and incremental success in attacking over payments after implementation, vulnerabilities surround the program. Examples include, the focus on post-payment high-dollar overpayments, mostly to hospitals, that recover pennies on the dollar versus pre-payment, the lack of innovation and sophisticated targeting to identify perpetrators which ultimately causes a high-false positive rate among those providers and suppliers identified, the negative impact to providers as part of the audit and measurement process which ultimately increases their administrative costs because they need to hire more staff, accuracy of RAC determinations, and antiquated database capabilities.^{iv,v,vi} It is difficult to ascertain the overall financial benefit of the program, depending upon whether the sources of the estimates are advocates for the RAC program, such as CMS, or adversaries of the RAC's, such as the American Hospital Association (AHA). The AHA is claiming significant appeals and overturned denials, while CMS presents minimal provider impact with maximum results. While the numbers quoted are distinctly different between CMS and AHA, both sides can agree that there is room for improvement to reduce negative impacts on good providers.

CMS continued its goal of reducing improper payments by launching Medically Unlikely Edits (MUE) in January of 2007. A MUE for a HCPCS/CPT (procedure) code is the maximum units of service that a provider would report under most circumstances for a single beneficiary on a single date of service.^{vii} These edits followed earlier National Correct Coding Initiative (NCCI) edits implemented by CMS in the mid-1990's. The NCCI edits identify where two procedures cannot be performed for the same patient encounter because the two procedures are mutually exclusive based on anatomic, temporal, or gender considerations.^{viii} While both edit types are progressive in identifying payment errors, neither identifies fraud and abuse schemes perpetrated by providers or organized fraud rings.

In 2009, the Department of Justice (DOJ) and Health and Human Services (HHS) announced the creation of the Health Care Fraud Prevention and Enforcement Action Team (HEAT). With the creation of the HEAT team, the fight against Medicare fraud became a Cabinet-level priority.^{ix} These law enforcement professionals took the war on reducing Medicare fraud to the doorstep of the individual perpetrators and organized fraud rings. For full-year 2011, strike force operations had charged a record number of 323 defendants, who allegedly collectively billed the Medicare program more than $1 billion. Strike force teams secured 172 guilty pleas, convicted 26 defendants at trial and sentenced 175 defendants to prison. The average prison sentence in strike force cases in FY 2011 was more than 47 months.^{x}

In mid-2011, in an effort to bring sophistication and improvement to fraud prevention, a $77 million computer system was launched to stop Medicare fraud before it happens—defined as the Fraud Prevention System (FPS). Unfortunately, the program had only prevented just one suspicious payment by Christmas 2011—for approximately $7,000. Frustration in the lack of progress in attacking Medicare fraud and abuse by this expensive new program was outwardly promulgated by Senator Carper (D-DE) in his quote in February 2012, “Medicare has got to explain to us clearly that they are implementing the program, that their goals are well-established, reasonable, achievable, and they're making progress.”^{xi}

More recently the Government Accountability Office (GAO) reported that Private contractors received $102 million to review Medicaid fraud data, yet had only found about $20 million in overpayments since 2008. The audits were found to be so ineffective they were stopped or put on hold, according to a report by the Government Accountability Office. The agency studied Medicaid audits performed by 10 companies. The audits relied on Medicaid data that was often missing basic information, such as beneficiary's names or addresses and provider ID numbers, experts testified during a Senate hearing.^{xii}

In addition to struggling to find effective methods to reduce Medicare fraud, an additional barrier has arisen. That is, in order to achieve results that maximize return on investment from capital dollars invested, measuring performance is an administrative obstacle. Neither CMS nor members of the Senate can get an accurate gage on how programs are performing separately or collectively. An example of this issue was highlighted in a hearing on Jul. 12, 2011, where Senator Brown (R-MA) inquired whether $150 million in expenditures for program integrity systems had been good investments—when no outcome performance metrics had been established to measure their actual benefit.^{xiii}

A clear message that occurs throughout the select chronology of events outlined above is the amount of potential savings is massive, but there are many obstacles address before significant benefits or savings be realized in reducing annual healthcare expenditures.

### Defining the Issue

Congressional testimony, agency oversight reports, government program communications and requests for proposals (RFP's), as well as peer-to-peer conversations have utilized several phrases to imply the issue associated with escalating healthcare costs—to the point where multiple descriptions have blurred the issue:

1) Fraud

2) Fraud, Waste and Abuse

3) Waste and Over-Utilization

4) Improper Payments

5) Payment Errors

6) Over Payments

While used generically and interchangeably—fraud, abuse, waste, over-servicing, over-utilization and errors are not all the same cost dynamic in financial terms. Each dynamic is different in terms of intent, financial impact, difficulty to identify and approach to pursue savings. It is impossible to address their negative influence until they are clearly defined at the lowest common denominator—the individual cost dynamic.

For this invention, independent sources are used to define each cost dynamic. Sources include the GAO from 2011 testimony Before the Subcommittee on Federal Financial Management, Government Information, Federal Services, and International Security, Committee on Homeland Security and Governmental Affairs, Donald Berwick in a April 2012 JAMA white paper, and the Congressional Research Service in a Report for Congress in 2010:
Fraud—Represents intentional acts of deception with knowledge that the action or representation could result in an inappropriate gain.^{xiv} According to The George Washington University School of Public Health and Health Services in Washington, D.C., researchers identified that eighty percent of fraud was committed by medical providers, followed by consumers (10%). The rest was by others, which included insurers themselves and their employees.^{xv} An example of suspect fraud is where a mid-wife submitted two deliveries for payment for every patient delivery.
Abuse—Represents actions inconsistent with acceptable business or medical practices.^{xvi} This definition can also include patients seeking treatments that are potentially harmful to them (such as seeking drugs to satisfy addictions), and the prescription of services known to be unnecessary.^{xvii} An example of suspect abuse is a surgeon submitting closure codes for each of their surgeries, even though they were included in the overall operation global code.
Waste (or Over-Servicing/Over-Utilization)—Described as administration of a different level of services than the industry-accepted norm for a given condition resulting in greater healthcare spending than had the industry norm been applied. Specifically, overtreatment that comes from subjecting patients to care that, according to sound science and the patient's own preferences, cannot possibly help them—care rooted in outmoded habits, supply-driven behaviors, and ignoring science.^{xviii}
Errors—Defined as provider billing mistakes or inadvertent claims processing errors.

Examples include incomplete or duplicate claims, claims where diagnosis codes do not match procedure codes, and unallowable code combinations, which are typically identified by claim edits.^{xix}

### Defining Risk Management

Risk management is the identification, assessment, and prioritization of risks followed by coordinated and economical application of resources to minimize, monitor, and control the probability and/or impact of unfortunate events^{xx}, in this case healthcare fraud, abuse and waste, over-servicing, over-utilization and errors. The concept of risk management was pioneered by the financial services industry almost 30 years ago to combat credit card fraud, which was, at that time, accelerating through the use of electronic payment technologies.

The impact of implementing fraud prevention predictive analytics in a risk management design for the credit card industry was a 50% reduction in fraud within five years of market usage^{xxi}, even with queuing or referring odds of 3:1 on cases to be worked^{xxii}. The value proposition of a risk management solution is in its design and foundation. It utilizes proven technology that mitigates fraud, abuse and waste with a cost structure over 20 times more economical than healthcare solutions today. According to the study by McKinsey, automated transaction technology from financial services has less than 1% in defects and manual review, as compared to healthcare technology that is estimated at up to 40%.^{xxiii}

The typical steps for risk management are broken down in 6 steps. They include:^{xxiv}
Determining the objectives of the organization
Identifying exposures to loss
Measuring those same exposures
Selecting alternatives
Implementing a solution, and
Monitoring the results

Leaders have several alternatives for the management of risk, including avoiding, assuming, reducing, or transferring the risks. This invention describes an Automated Healthcare Risk Management System to target and prevent losses from fraud, abuse, waste and errors.

### Outlining a Risk Management Design

A healthcare risk management design is a systematic approach that incorporates multiple capabilities and services into an overall solution, versus a single capability, to minimize losses based upon the economics of the overall risk and financial benefit. It provides the ability for a one-to-one interaction with customers, to reduce losses from bad actors before they are paid, while at the same time mitigating negative interactions on good customers—in this case providers and beneficiaries.

Risk management is not about having a single capability to fight all issues, it is about the collective benefit of multiple capabilities in a single solution to control ALL types of cost dynamics such as fraud, abuse, waste and errors. A single model, a single dataset, or single set of edits cannot control costs for all four cost dynamics.

The Automated Healthcare Risk Management System utilizes Software as a Service technology to host Real-time Predictive Models, Risk Adjusted Provider Cost Index, Edit Analytics, Strategy Management, Managed Learning Environment, Contact Management, Forensic GUI, Case Management And Reporting System For Preventing And Detecting Healthcare Fraud, Abuse, Waste and Errors individually and uniquely.

Throughout this invention, each cost dynamic is referred to specifically when discussing individual approaches to attack and mitigate them individually. Generic comments around fraud, abuse, waste or errors will be referred to as an improper payment.

### BACKGROUND OF THE INVENTION

The present invention is in the technical field of Analytical Technology for Improper Payment Prevention and Detection. The invention focuses prevention and detection efforts on the highest risk and highest value providers, healthcare merchants, claims, transactions or beneficiaries for fraud, abuse, over-servicing, over-utilization, waste or errors. More particularly, it pertains to claims and payments submitted or reviewed by public sector markets such as Medicare, Medicaid and TRICARE, as well as the private sector market which consists of commercial enterprise claim payers such as Private Insurance Companies (Payers), Third Party Administrators (TPA's), Medical Claims Data Processors, Electronic Clearinghouses, Claims Integrity Organizations, Electronic Payment, Healthcare Intermediaries and other entities that process and pay claims to healthcare providers.

This invention pertains to identifying improper payments by providers, healthcare merchants and beneficiaries or collusion of any combination of each fore-mentioned, in the following healthcare segments:
1. Hospital Facilities
2. Inpatient Facilities
3. Outpatient Institutions
4. Physician(s)
5. Pharmaceutical
6. Skilled Nursing Facilities
7. Hospice
8. Home Health
9. Durable Medical Equipment
10. Laboratories

Healthcare providers are here defined as those individuals, companies, entities or organizations that provide a plurality of healthcare services or products and submit claims for payment or financial gain in the healthcare industry segments listed in items 1-10 above. Healthcare beneficiaries are here defined as individuals who receive healthcare treatments, services or products from providers or merchants. Beneficiary is also commonly referred to as a “patient”. The beneficiary definition also includes individuals or entities posing as a patient, but are in fact not a legitimate patient and are therefore exploiting their role as a patient for personal or financial gain. Healthcare merchant is described as an entity or individual, not meeting the exact definition of a healthcare provider, but having the ability to offer services or products for financial gain to providers, beneficiaries or healthcare intermediaries through any channel, including, but not limited to retail store, pharmacy, clinic, hospital, internet or mail.

The present invention, defined as the Automated Healthcare Risk Management System for identifying Improper Payments, utilizes, for example, research, analysis, reporting, probability models or scores, cost or waste indexes, policy edits and empirical decision strategy management computer software application systems in order to facilitate human interaction with, and automated review of healthcare claims or transactions, providers, healthcare merchants or beneficiaries that have been determined to be at high risk for fraud, abusive, over-servicing, over-utilization, waste or errors.

The Automated Healthcare Risk Management System for Preventing And Detecting Healthcare Fraud, Abuse, Waste And Errors is a software application and interface that assists law enforcement, investigators and risk management analysts by focusing their research, analysis, strategy, reporting, prevention and detection efforts on the highest risk and highest value claims, providers, healthcare merchants or beneficiaries for fraud, abuse, over-servicing, over-utilization, waste or errors.

The objective of the invention is to provide effective fraud prevention and detection while improving efficiency and productivity for investigators. The Automated Healthcare Risk Management System for Healthcare Fraud, Abuse, Waste and Errors is connected to multiple large databases, which includes, for example, national and regional medical and pharmacy claims data, as well as provider, healthcare merchant and beneficiary historical information, universal identification numbers, the Social Security Death Master File, Credit Bureau data such as credit risk scores and/or a plurality of other external data and demographics, Identity Verification Scores and/or Data, Change of Address Files for Providers or Healthcare Merchants, including “pay to” address, or Patients/Beneficiaries, Previous provider, healthcare merchant or beneficiary fraud “Negative” (suppression) files or tags (such as fraud, provider sanction, provider discipline, provider retirement or provider licensure, etc.), Eligible Beneficiary Patient Lists and Approved Provider or Healthcare Merchant Payment Lists. It retrieves supporting views of the data in order to facilitate, simplify, enhance and implement the investigator's decisions, recommendations, strategies, reports and management treatments and actions. More specifically, the invention includes healthcare merchant and provider history, beneficiary or patient history, patient and provider interactions over time, provider diagnosis, actions, treatments and procedures across a patient spectrum, provider or segment cohort comparisons, reports and alternative empirical strategies for managing potentially fraudulent or abusive, over-servicing, over-utilization, waste or errors claims and their subsequent payments.

Provider, healthcare merchant, claim and beneficiary information is prioritized within the Automated Healthcare Risk Management System by differing probability levels or likelihood of improper payment risk and therefore require differing different levels of treatments or actions based upon economic spend and benefit or value, importing and utilizing:
1. Embedded scores generated by multi-dimensional statistical algorithms or probabilistic predictive models that identify segments, providers, healthcare merchants, beneficiaries or claims as potentially fraud or abuse or waste.
2. Embedded over-servicing, over-utilization, waste mathematical benchmarking methodology and provider cost/waste indexing utilizing a health risk adjusted co-morbidity model to provide a normalized, apples to apples cost indexing of all providers, their specialty and co-morbidity or risk groups. It ensures the control and the provider population demographics and co-morbidities are normalized for measurement and cohort comparison purposes.
3. Embedded Edit Analytics that identify industry, compliance or customer specific edit failures.
4. Strategy management algorithms, sometimes referred to as optimized decisions strategies that are designed to quickly adapt to changing patterns of improper payments associated with fraud, abuse, over-servicing, over-utilization, waste or errors.
5. Statistical analyses performed on “similar” types of claims, procedures, diagnosis, co-morbidity, providers, healthcare merchants and beneficiaries, using statistical comparisons, including but not limited to methods such as Chi-Square.
6. Action codes, such as deny payment or pend payment, based on the importance of provider, healthcare merchant, claim and beneficiary characteristics.
7. Treatment optimization, on such treatments as educating a provider, putting a provider on a watch list, requiring ongoing validations or provider credentialing, in which new methods or treatments are tested to improve efficiency and effectiveness, through a managed learning environment utilizing experimental design capabilities.
8. Sub-second, real time access to multiple years of claim, procedure, provider, healthcare merchant or beneficiary data history to aid law enforcement or investigators in decision making such as pay, decline, request more information prior to payment or pursue for legal actions.
9. Software navigation that allows a user or investigator to quickly navigate through a complex collection of data to efficiently identify, for example, suspicious, fraudulent, abusive, wasteful or error activity by provider, healthcare merchant or beneficiary.
10. Policies established by payers or key stack holders, to address and meet business or compliances objectives.
11. Population risk adjustment modeling and profiling capabilities, here defined as episode of care, that allows an investigator a mathematical and graphical capability to normalize population health and co-morbidity and track and analyze beneficiary care and provider services and procedures across all healthcare segments, provider specialty groups, healthcare merchants, geographies and market segments.
12. Analysis and reporting:
   a. Capture feedback loop performance.
   b. Summarize risk management and model performance.
13. Reporting analysis and queries, which allows an investigator to explore complex data relationships and underlying individual transactions, as identified by the mathematical algorithms and probabilistic model scores and their associated reason codes.
14. Providing data filtering capabilities, which statistically compare provider, healthcare merchants or beneficiary activities with activities of similar populations, mathematically normalized, for example by episode of care, to dynamically select different cohort groups for comparing and contrasting behavior or performance—such as specialty group, healthcare merchant, geography or dimension.
15. Dynamic analysis views that contain targeting for improper payments across multiple dimensions, for example, such as illness burden, episode of care, segment, provider, healthcare merchant, claim and beneficiary level.
16. Real-time triggers to activate intelligence capabilities, combined with predictive scoring models, provider cost and waste indexes, to take action on providers, healthcare merchants, claims and beneficiaries when risk predefined thresholds are exceeded for suspect payments.
17. Real time monitoring, measurement, identification, and visual presentation of performance and changing patterns of fraud or abuse in a dashboard format for an operations (“ops”) room, control room or war-room type display environment.
18. Systematic measuring, monitoring and automatic re-optimization of empirical probabilistic decision strategies to address changing patterns of improper payments, such as fraud, abuse, over-servicing, over-utilization, waste, errors or deterioration in model or strategy performance.
19. Workflow Management capabilities, which systematically route healthcare merchants, claims and beneficiaries to investigators for review. Analytical decision technology that provides operations and investigations staff the functionality to manage input volume of suspect claims, providers, healthcare merchants and beneficiaries to be investigated based upon available staffing levels, while providing the capability to measure the incremental benefit, through a Managed Learning Environment, of those populations worked by investigators, versus those that are not worked.
20. Case Management capabilities which investigators use to create cases and manage efficient resolution of suspect claims, providers, healthcare merchants and beneficiaries, associated with all components of improper payments, while maximizing economic value, savings or recovery, and reducing negative impact on “good actors” (good actors are defined as those suspect providers, healthcare merchants and beneficiaries that are initially identified as suspect but are later status as valid—this are also described as false positives).
   21. Satellite mapping and address assessments using standard mapping packages to allow investigators to assess physical locations for potential phantom beneficiary, provider or healthcare merchant fraud.
22. Link Analysis techniques, either separately or incorporating identity predictive analytics:
   a. To identity risk and analyze individual identity elements, not just the entire identity, for fraud behavior patterns.
   b. To evaluate multiple data structures, using multi-dimensional keys, such as name, address, drivers license, phone number, social security number, provider NPI, email address, for example, to identify collusion between providers, beneficiaries, healthcare merchants, retail establishments or any combination thereof
   c. To allow address and street level centroid-distance analysis from provider location to beneficiary physical address to identify unscrupulous provider addresses that are invalid or likely fraud.
23. Custom Personal Identification Number creation for linking and aggregating multi-dimensional information within and outside the database, where similar identity profiles are identified, flagged and presented to investigators as work cases.
24. Link Analysis and/or pinning techniques to identify and create a cross market view of providers, healthcare merchants and beneficiaries across multiple markets such as public sector markets such as Medicare, Medicaid and TRICARE, as well as the private sector market which consists of commercial enterprise claim payers such as Private Insurance Companies, Third Party Administrators, Medical Claims Data Processors, Electronic Clearinghouses, Claims Integrity Organizations and Electronic Payment entities that process and pay claims to healthcare providers.
25. Provide for efficient resolution of both fraud and abuse within healthcare—where abusive behavior is often subtle and harder to identify than fraud to find efficient and effective resolution.
26. Contact Management, which works within the GUI, the Strategy Manager, Managed Learning Environment and Workflow Management and Case Management module, to effectively, efficiently and optimally interact and communicate with Providers, Healthcare Merchants and Beneficiaries for education or intervention. Interactions include, but are not limited to, electronic messaging sent directly through email, phone, electronic text message or letter.
27. An embedded real-time Feedback Loop that dynamically “feeds back” outcomes of each transaction that is “worked” in the investigation process. This feedback loop may contain providers, healthcare merchants, claims or beneficiaries flagged as fraud, abuse, over-servicing, over-utilization, wasteful, error or as good. The Feedback Loop allows the system to dynamically update model coefficients or probabilistic decision strategies, as well as monitor emerging improper payment trends in a real-time fashion. Validation and on-demand queue reporting is available to track improper payment identification.
28. Integrate multiple data sources, both internal and external data sources and external models into the strategy manager to further target the identification of improper payments—examples include, but are not limited to credit bureau model scores, negative files of historical perpetrators, SSN death master file or output from industry rules and edit solutions. Other examples of internal data to be used may include, but not be limited to:
   a. Beneficiary health
   b. Beneficiary co-morbidity
   c. Zip centroid distance, per procedure, between patient and provider compared to peer group
   d. Number of providers a patient has seen in a single time period
   e. Proportion of patients seen during a claim day (week/month) that receive the same procedure versus their peer group
   f. Probability of a fraudulent provider address
   g. Probability of a fraudulent provider identity or business

### DESCRIPTION OF THE PRIOR ART

### Overview

Prior Art references interface software applications, for provider, beneficiary and claim payment-monitoring systems, summarized into the following categories:
Workstations
Workflow Management Applications
Case Management Workstations, Case Management Software or Systems,
Queue Management
Business Intelligence (BI) Tools

Their central function, or primary responsibility, is manually reviewing output through an online browser, which may or may not include efficient navigation. Additional capabilities are sometimes provided with the afore-mentioned categories. Those categories may include the following, but typically not more than one:
Data Query Capabilities or Business Intelligence Tools
Data Mining, Data Analytics capabilities
Preprocessing Programs or Creation of Rules
Manual Decision Strategy Management Capabilities or Static Report Trees

Prior Art inventions are less focused on the end-users need for effective improper payment prevention and detection, with efficient resolution, than delivering components and capabilities that emulate and automate the already inefficient and ineffective environment, that currently exists today.

There is little consideration by prior art on how to maximize the business goals of the end user, which is to improve and maximize the identification of improper payments, savings, recoveries, business return and optimize capital invested in the business, while introducing efficiencies that lower defects, resources, staff and overall costs. Most Prior Art applications are designed for business analysts and statisticians to operate, versus meeting the needs nurses, physicians, medical investigators, law enforcement or adjustors within the healthcare industry whose goal is to investigate and have timely resolution to complex improper payment scenarios, versus wasting precious time to learn and perform laborious analysis to locate improper payments.

End-users require efficient resolution, without the need to learn statistics, submit or create custom queries to pull historical data or write or hard code rules to identify fraud or abuse or waste. In particular, Prior Art applications are for creating, viewing and visually analyzing detection results post payment, sometimes defined as descriptive statistics, where users are required to submit queries or run BI Tools to create population statistics, such as means, standard deviations or Z-Scores to compare performance of one observation to another population of its peers. Many times Prior Art references the use of hard copy and electronic reports, graphing capabilities such as Color Columns, Charts, Histograms, Bar Charts, geography maps and dot graphics for visual investigations.

More particular, Prior Art is designed as industry generic, specifically agnostic versions developed in one industry, such as telecom or financial services, for fraud and generically applied to multiple other industries, versus specifically developed and focused exclusively on preventing and detecting multiple healthcare improper payment types such as fraud, abuse, over-servicing, over-utilization, waste and errors. Prior Art tends to copy methods and capabilities from one industry and apply it to other industries without any thought to innovation or customization for that industry's issues or specific user needs and business objectives. Prior Art makes claims across multiple industries, including but not limited to, Credit Card Portfolio Management, Credit Card Fraud, Workman's Compensation Fraud, Healthcare Diagnosis or Healthcare Applications to monitor provider or patient behavior. One size does not fit all applications.

Prior Art does not consider integration of systems and capabilities on the front end, defined as input, nor how each system or capability must tie together on the back end, defined as output. Particularly, Prior Art rarely references Software As A Service (SAAS) as a simple means for integration. More importantly, end users are not considered for the final use and output, specifically contemplating how providers, healthcare merchants, claims or beneficiaries that are identified with improper payments such as fraud, abuse, over-servicing, over-utilization or waste, along with how research, actions or treatments are communicated from Prior Art payment monitoring systems efficiently and effectively to investigators. Prior Art does not consider how actions that are taken within the monitoring system are communicated back to legacy systems for actions upstream within the system or performance reporting.

Prior art does not directly discuss the integration and use of multiple data sources, for example the Social Security Death Master File, external Credit Bureau data such as credit risk scores and/or a plurality of other external data and demographics, Identity Verification Scores and/or Data, Change of Address Files for Providers or Healthcare Merchants, including “pay to” address, or Patients/Beneficiaries, Previous provider, healthcare merchant or beneficiary fraud “Negative” (suppression) files or tags (such as fraud, provider sanction, provider discipline or provider licensure, etc.), Eligible Beneficiary Patient Lists and Approved Provider or Healthcare Merchant Payment Lists.

Prior Art also does not consider the requirement to have real-time monitoring and multiple triggers that fire when thresholds are exceeded for potential perpetrators of improper payments.

Lastly, Prior Art does not consider a key component in any system, which is the feedback loop. It is required for both model and strategy enhancement as well as developing optimized decision strategies, contact management strategies, treatment and actions. The feedback loop is also a key component to measuring results and determining business return on investment. While most Prior Art references standard or ad hoc reporting, it doesn't reference the capability to measure the true incremental benefit of new models, new strategies, new data, new variables, new treatments, new actions or alternative investigator staffing models compared to the current state, which is the control.

### Workstations, Workflow Management, Case Management and Queue Management

Prior Art for workstations, workflow management, case management or queue management monitor only fraud through interface software applications. Additionally, Prior Art mirrors or imitates what was previously done in a paper intensive environment or in a manual, human workflow management system to identify fraud. These types of workstations reference virtually no research, analysis, strategy management capabilities and only basic or standard reports. These are not intelligent systems, but “paper replacement” management “workstations” which offer less sophistication and merely automate what was previously done manually or on paper forms to target fraud—not the broad definition of improper payments which includes multiple cost dynamics such as fraud, abuse, over-servicing, over-utilization, waste and errors. In addition, Prior Art does not address, specifically, improper payments from multiple dimensions, including segment, provider, healthcare merchant, claim and beneficiary.

Prior Art doesn't consider law enforcement's and investigators need to focus on additional compromise points such as enrollment or identity credentialing, in addition to improper payments. There are multiple categories of risk-types that exist within healthcare that correspond to the multiple points of compromise with the healthcare value chain. The majority of risk and overpayment cost originates from the transaction category, and is perpetrated primarily by providers.^{xxv} See the table below for examples summarizing the categories of compromise that a layman familiar in this field must objectively consider for their risk management solution.

| Description | Category |
|---|---|
| Synthetic identity fraud and enrollment | Identity |
| Identity take-over, such as claim | |
| submission by deceased, retired or | |
| inactive providers | |
| Claim submission by sanction providers | Enrollment |
| Multiple enrollment into programs | |
| utilizing differing variations of known | |
| personal attributes | |
| Utilizing someone else's medical | Eligibility |
| identification for care - most common in | |
| government programs | |
| Out of pattern healthcare purchases | Transaction |
| associated with fraud or abuse | |
| Costly behavior associated with over- | |
| servicing, over-utilization or waste | |
| Claims errors - duplicate claims, over- | |
| payments, compliance defects | |
| Durable medical equipment claims | |
| submitted, but never received | |
| Multiple prescriptions acquired for | |
| controlled substances by patients who do | |
| physician shopping | |
| Fraudulent Merchant or Retail transaction | |

Using computer software programs to automate and replicate existing, manual paper based fraud claim review results in only a small number or fraction of claims that can be reviewed at any given time. Specifically, if computers are used to simply automate current processes, then rather than reviewing millions of potentially improper payments, it is still only possible to inefficiently review a very small number of potentially fraud claims per analyst or investigator per day. This issue becomes very apparent when a large payer, may require 4 million claims to be reviewed in a single day. This cumbersome process also means that there are no coordinated, sophisticated review capabilities for not only fraud, but also abuse, over-servicing, over-utilization, waste and errors across multiple geographies, across time, across beneficiary services or even within specialty groups. Prior Art infers an end-state, where a decision is already known, not an intelligent system that automatically targets, identifies and presents suspects to an investigator to work.

Prior Art describes no “managed learning environment”, within the review or assessment process to effectively and proactively, test new actions or treatments and effectively measure the amount of incremental improper payment cost dynamic components, such as fraud, abuse, over-servicing, over-utilization, waste or errors, identified to optimize business return on investment. A managed learning environment is critical for monitoring the performance of each scoring model, characteristic, data source, strategy, action and treatment to allow law enforcement or investigators to optimize each of their strategies or approaches to prevent and detect improper payments as well as adjust to new types, techniques or behaviors of perpetrators—such as identity fraud, collusion, organized crime and rings, providers, healthcare merchants and beneficiaries. A managed learning environment provides the real-time capability to cost-effectively present only the highest-risk claims and highest value providers, healthcare merchants, claims or beneficiaries to investigative analysts to systematically decline or quickly research and take action on high-risk healthcare improper payments. A key requirement of any business is ascertaining, or measuring the effectiveness of capital spent versus the individual cost dynamics compromising improper payments prevented and detected, sometimes referred to as return on investment. Particularly, there is not an ability to quickly and optimally identify emerging patterns of fraud, abuse, over-servicing, over-utilization, waste or errors, or adjust to changes in existing perpetrator behavior without understanding your cost and return trade offs. Prior art does not address either an ongoing managed learning environment or capabilities for measuring and optimizing business return.

Prior Art does not consider how actions that are taken within their monitoring system are communicated back to legacy systems for investigative action revisions upstream within the system. Lastly, Prior Art does not consider a key component in any monitoring system, which is the feedback loop. It is required for both model and strategy enhancement as well as developing optimized decision strategies, contact management strategies, treatment and actions. The feedback loop is also a key component to measuring results and determining business return on investment. While most Prior Art references standard or ad hoc reporting, it doesn't reference the capability to measure the incremental benefit of new models, new strategies, new treatment, new actions compared to the current state, which is the control.

### Business Intelligence Tools, Data Mining or Data Analytics, Preprocessing or Rules, Decision Strategy Management Capabilities or Report Trees Capabilities

Prior Art outlines Data Ad Hoc Queries, Business Intelligence Tools, Data Mining or Data Analytics, Preprocessing or Rules, Decision Strategy Management Capabilities and Report Tree capabilities that may also be combined, or run independent of, interface software applications for monitoring providers, beneficiaries and healthcare claim payments for fraud or abuse.

Data Ad Hoc Queries, Business Intelligence Tools, Data Mining or Data Analytics have several limitations:
Manually intensive for users—performing multiple queries or analysis in order to find a suspect case
Designed for a statistician or a business analyst, or someone who is skilled in the art of programming or data analysis—not a doctor or nurse
Inefficient use of time for law enforcement, a nurse, physician, medical investigator or adjustor—these expensive resource's time and focus should be used for investigating, versus writing data queries or reviewing canned reports to “find” fraud, abuse, waste, over-servicing, over-utilization or errors
Canned reports are not customized—customization requires cost and effort
Will not adjust to changing patterns of behavior, without intervention—data queries and canned reports are static and only identify those behaviors or characteristics which are previously known or pre-defined
Queries, reports and analysis are laborious and unable to focus on multiple dimensions such as provider, healthcare merchant, claims and beneficiaries simultaneously—as well as further dissect for specialty, healthcare segment, geography or illness burden
Singularly focused on fraud versus the multiple cost dynamic components of improper payments such as fraud, abuse, over-servicing, over-utilization, waste or errors—each cost dynamic requires a different approach to identify, evaluate and quantify
Difficult to determine return on investment for software application's findings and the resource's performing the investigation
It is almost impossible to determine what identified the fraud and its value, for a query program that was written, the data that was utilized and reviewed or the investigator who identified the fraud or abuse

Prior Art also describes monitoring system capabilities that complete pre-processing for errors, or have decision strategy management rules, parameters, trees, tree reports, filters or policies that are used to identify fraud or abuse. Categorically, these capabilities are all some form of rules which are both inefficient and ineffective, even though they are intended to help the claim payers or users to determine which of the claims submitted by the providers are within acceptable policies, guidelines, fraud or abuse risk. These approaches do not directly identify, evaluate and quantify ALL cost dynamics associated with improper payments.

Although Prior Art may have the opportunity to import what is generically defined as a predictive model score(s), here defined as scoring, to monotonically rank order claims to be reviewed, these capabilities do not take advantage of the research, analysis and empirical and adaptive strategy management capabilities that modern scoring enables. Particularly these capabilities or applications rely on judgmental, anecdotal and sub-optimal rules, trees, tree reports, filters and policies to manage the investigative review process, in combination with scoring. Additional websites, screens or queues are sometimes required to be created by users using trees or tree reports, in an attempt to create efficiency and effectiveness, but which further perpetuates the issues that are trying to be solved for, effective and efficient identification and resolution of improper payments by investigators, for example law enforcement, nurses, physicians, medical investigators or adjustors within the healthcare industry whose goal is to find timely resolution to complex improper payment scenarios.

In order to manage risk and prevent and detect improper payments on the billions of healthcare claims per year, investigators are unable to focus on an optimal or manageable subset the riskiest, most valuable payments, or ascertain business return. It doesn't matter whether sub-second, state of the art processing platforms or mainframe computer systems are used to conduct reviews because both are sub-optimal for identifying improper payments effectively and resolving it efficiently with decision strategy management rules, parameters, trees, tree reports, filters or hard coded policies.

Prior Art identifies an explosion of manually programmed rules to implement policies as well as detect only fraud and abuse, either independent of monitoring systems or within monitoring systems. During a review process, hundreds of rules may have been breached, or fired, to identify a claim or provider to be reviewed. These large number of rule exceptions cause several major problems for the investigator during the review processes:
1. If hundreds of rule exceptions caused a claim to be sent for review, it is nearly impossible for a human to determine which rule violations were the most important→undermining a key requirement of the investigation process, understanding why a claim was identified as suspect
2. Some rule violations may cause hundreds or even thousands of claims to be sent for review without any prioritization of which claims were most critical for review, or have the highest value or business return→mitigating any opportunity to improve efficiency or work the most economical value claims to maximize business use of capital and business return
3. Large numbers of rule violations require the claims payers to employ a large number of expensive investigative analysts, typically nurses, physicians, medical investigators or adjustors, to inefficiently review the claims that are sent for review.→eliminating any chance for operations to efficiently manage staffing

### Database Analysis

Prior Art describes Business Intelligence (BI) Tools, Data Mining and Data Analytics and Database query capabilities combined with workstations, workflow management, case management or queue management interface software applications for monitoring healthcare providers, beneficiaries and claim payments. Viewing data is their central function, with SQL type query capabilities or enhanced graphing for traversing through data, storing data models and ad hoc data driven analysis. Generic appending or accessing scoring, typically from parametric predictive models, writing or submitting computer programs, creating custom web sites or allowing business analysts to create judgmental report trees are recent additions to these new categories. The Business Intelligence (BI) tools or data queries are utilized to create ad hoc queries or programs, which emulate rules, to identify pockets or segments of potential fraud by accessing a database. None create the environment for a feedback loop to measure performance or improve on effectiveness or address the remaining cost dynamics associated with improper payments.

Prior Art describes parametric measurements, such as attribute means, medians, standard deviations or Z-scores, combined with the queries to ineffectively identify outliers. High false positive rates associated with parametric methods used in healthcare or the reliance on ‘families” of supervised modeling techniques included with the prior art causes investigator ineffectiveness. Additionally, Prior Art also discusses computer implemented methods of analyzing results of a predictive model applied to data pertaining to a plurality of entities displaying rank-ordering of at least some of the entities according to their variance from the mean or median or scores and for each of the displayed entities. Database output is accessed visually using a workstation or programs that populate generic or custom queues, web sites or reports to be accessed by investigators.

Prior Art references a hyper-link to a report tree, which contains a plurality of hyper-linked reports. Report trees systematically emulate the paper environment. The output includes a plurality of reports compromising: a suspect list of entities, each entities activity by a selected categorization of the entities activity, distribution chart, subset reports, and a peer group comparison report. Prior Art approach has the same approach of rules, both from a processing perspective and an ability for an investigator to improve efficiency and information investigator transparency.

It is virtually impossible to apply individual strategies when using rules and it is impossible to report results or effectiveness of rules in detecting fraud and abuse because there is no way to evaluate how effective an individual rule is in detecting fraud or abuse, especially when fraud and abuse each have subtle behavioral differences. Particularly, this is not a focused risk management platform, but a workstation display capability based upon rules outputting data from a database.

Suppose, for example, there are 10,000 rules, not an uncommon number, used to implement claim payer policies and to detect fraud, abuse or improper payments. Suppose also, that a claim to be paid is sent to a fraud investigator for review because 150 of the rule criteria or parameters were exceeded. Suppose further that the claim turns out to be fraudulent. There is no way to identify or report which variable or rule “caused” the fraud claim to be “detected”. Prior Art does not describe an accurate method to report overall performance of the individual rules. This same condition exists for implementation of new policies or procedures. It is impossible to determine which rules are effective at testing and implementing new payer claim procedures or policies when hundreds of rule exceptions might be associated with each potential new or changed procedure. This statement is true whether predictive model scores or individual characteristics are used with the rules or report trees. This issue is further perpetuated when looking at multiple cost dynamics for improper payments such as fraud, abuse, over-servicing, over-utilization, waste or errors.

Overall, Prior Art describes interface software applications, such as workstations, workflow management systems or case management systems with database capabilities which are generally driven by judgmental decision strategy rules, trees, filters, ad hoc database queries and report tree logic. This “passive” approach and cumbersome detection and case management activity is inefficient, even if defined as real-time. Rules, filters, decision or report trees, database queries and parameter driven workstations suffer the same weaknesses in fraud risk case management workstations as they do in fraud detection, even if they include predictive models and real time processing. More particularly, decision strategy management rules-based approaches, including trees and report trees, have the following weaknesses when used in workflow management systems, case management or queue management systems:

### Accuracy Weakness

Judgmental, based upon subjective experience
Parameter and policy driven
Inconsistent across populations when implemented
Cannot screen or manage new, unknown, types of fraudulent behavior
Cannot identify, evaluate and quantify individual cost dynamics such as fraud, abuse, over-servicing, over-utilization, waste or errors
Rules, trees, filters, ad hoc database queries and report tree logic are considered to be “passive” and can not quickly adapt to emerging or changing patterns of fraud or abuse
Fraud and abuse perpetrators quickly adapt to rules, which quickly makes them outdated
Each rule is a judgmental policy directed at controlling one aspect of fraud or abuse risk management
   Determining threshold for rules and parameters is difficult and typically anecdotal
   Rules are used with deterministic issues, versus probabilistic forecasts and strategies
Rules, parameters, policies and filters are easily copied or reverse engineered by perpetrators

### Productivity Weakness

Manual, labor intensive to implement
Rules can be difficult to modify, when hard-coded in system—become outdated quickly
Computer processing intensive
Rules become expensive and even impossible to maintain and update and continuously expand to rule “explosion”

### Measuring Results Weakness

Impossible to track performance results and ultimately return on investment performance (ROI) based upon original decision—or measure incremental investigation rule changes and their financial impact for each individual cost dynamic for fraud, abuse, over-servicing, over-utilization, waste or errors
   Impossible to monitor and track results based upon decision because:
   a. Many rules can “fire” during an event—don't know which rule is most important
   b. Do not know which rule, parameter or filter caused the fraud and therefore cannot track performance by rule

### Resource Management Weakness

Too general—include large segments of potential consumers resulting in a high review requirement and a high insult rate caused by false positives
Too specific—isolate just a small number of high risk accounts, low detection rate—false negative rate
   Rules, parameters and filters do NOT scale—as business and fraud patterns get more complex, effort required to “maintain rules” increases exponentially
   Rules-based methodology cannot efficiently allocate resources such as human review workload or caseload. Therefore, these resources cannot be adjusted up or down to increase or decrease their number for suspect providers, claims or beneficiaries queued and presented for review

As described earlier, Prior Art references the possibility to combine predictive model scores, with associated reason codes, with Business Intelligence (BI) Tools or database queries. Particularly, Prior Art references parametric methods or supervised techniques such as regression, multiple regression, neural nets or clusters and behavioral profiling techniques. Prior Art sometimes describes the use of probability tables based upon historical database performance. Prior Art is describing a redundant version of what is used in Financial Services—credit card, without customization for meeting the needs of healthcare investigators.

Prior Art, also references unsupervised techniques using database analysis or data queries. Particularly, Prior Art refers to Z-Scores models as an input to decision management strategy trees. All of these model methodologies create the same type of ineffectiveness and inefficiency that was introduced with rules and edits. Parametric methods, or outlier analysis, combined with rules, create inaccuracies based upon both sides of a data distribution. This is because of limitations of supervised modeling approaches and Z-scores in ability to only segment a population into the worst 0.5%-1.0% of risk. More particularly, the methodology described neutralizes any rank order capability using rules below the top 1%.

Documenting that Prior Art has the ability to rank order risk within the rules or trees does not make Business Intelligence (BI) Tools, decision management strategies, rules or data queries any more effective or efficient for health care fraud prevention than previous manual methods. See utility patent application Ser. No. 13/074,576 (Rudolph, et al.), filed Mar. 29, 2011 or utility patent application Ser. No. 13/617,085 (Jost, et al.), filed Sep. 14, 2012 for an in depth discussion of modeling weakness of parametric modeling techniques and traditional non-parametric approaches.

Further weaknesses for Prior Art is computer-implemented methods of analyzing results of a predictive model applied to a data pertaining to a plurality of entities. It references predictive modeling and report trees, but does not reference or expand on enhanced capabilities that specifically reference improved detection and prevention, improved efficiency and effectiveness, ease of investigation, ability to better manage staff or information transparency for the user, such as law enforcement, investigators, analysts and business experts. Additionally, Prior Art references sampling capabilities, but they are a simple browser-based method used to sample displayed data, versus the total population in an empirically derived and statistically valid method required for experimental design tests. Prior Art sampling techniques are biased and skewed based upon the displayed data. Lastly, report tree technology is not designed or utilized for creating a managed learning environment to optimize fraud or abuse prevention effectiveness, treatment effectiveness or maximize user business goals or return on investment—they are static trees with hard cut-offs—backed up by static reports.

### Reporting Weakness

Prior Art provides descriptions for summary report trees, report comparisons of activity of the entity to activity of the entity's peers with respect to: procedure code groups, diagnosis code groups, type of service codes or place of service codes, but it does not provide automated statistical comparison references or use of statistical measurements, for example Chi-Square measurements to determine differences decisively. Decisions are based upon anecdotal comparisons by viewing the predefined reports or running queries. Prior Art references comparisons of the activity of the entity in each of a plurality of demographics, such as age groups of the entities clients, to the activities of the entities peers in each group. The basic summary report, for peer-to-peer comparisons, compare one-month of activity for simple activity characteristics, including:
Procedure code groups
Diagnosis code groups
Type of service codes
Place of service codes
Client consecutive visits
Average dollars per claim
Per day activity
Volume of activity
Activity volume per client
Multiple entities seen per day

Prior Art also includes basic figures, graphs and inventory of predetermined reports:
Reports and variable comparisons
Data Grid—peer chart, distribution plot, histogram of peers
Client age breakdown report
Monthly activity report
Client consecutive reports
Group participation report
Dollars per claim report
Per day activity report
Multiple physicians per day report

Prior Art reporting capabilities are manual detection methods that further exaggerate already inefficient improper payment detection and resource management.

### Other Prior Art Limitations

In addition to the limitations referenced in the Prior Art comparisons, several others are worthy of discussion:
Capabilities are limited to generic, one-dimensional, workstations and work flow management systems. An effective and efficient solution must be multidimensional and be able to follow patient care and provider services, here defined as episode of care, across all healthcare segments, provider specialty groups, geographies and market segments:
   Healthcare improper payments are more than extreme fraud outliers. Improper payment components include cost dynamics for fraud, abuse, over-servicing, over-utilization, waste and error. Each component is multi-faceted and requires different approaches, capabilities and treatments. Improper payments have a plurality of actor dimensions that can perpetuate improper payments, for example as providers, healthcare merchants, care givers and beneficiaries.
   Improper payments have different trend and patterns across provider specialty groups, geographies, healthcare segments and market types and must be investigated differently
   Healthcare improper payments have multiple healthcare segments, such as Hospital Facilities, Inpatient Facilities, Outpatient Institutions, Physicians, Pharmaceutical, Skilled Nursing Facilities, Hospice, Home Health, Durable Medical Equipment and Laboratories that must be targeted uniquely
   Healthcare has multiple intermediaries that each may have a different need for use—they include, but are not limited to any entity that accepts healthcare data or payment information and completes data aggregation or standardization, claims processing or program administration or any other entity which handles, evaluates, approves or submits claim payments through any means.
Case management capabilities have a single focus to capture information and emulate paper processes systematically and perpetuate already inefficient processes, versus enhancing detection or prevention of improper payments.
Little consideration is given on how to maximize the business goals of the end users, such as law enforcement, investigators, analysts and business experts, which is to improve business return and optimize capital invested in the business. This will only occur with an optimized managed learning environment that provides empirical strategies that can be monitored for new or changing patterns for improper payments, as well as business metrics that are financial drivers for determining return on investment (ROI).
Prior Art references velocity or utilization variables for detecting healthcare fraud and abuse extreme outliers. An industry-focused solution must have a deeper understanding of healthcare claims data, rather than just extreme provider, healthcare merchant, claim or beneficiary behavior. The solution must also provide measurement and visibility to illness burden and financial resource expended, but with the ability to identify aberrant provider, healthcare merchant, claim or beneficiary behavior over time using procedure level, defined as line-level, healthcare data within both probabilistic decision strategies and predictive probability models. Lastly, a solution offered in healthcare must address the multiple cost dynamics of improper payments confronting users for fraud, abuse, over-servicing, over-utilization, waste and error.
Prior Art describes ad hoc queries, decision strategies, with reporting that is static over time, and not monitoring predictive models or characteristics over time for new or changing patterns of improper payments and notifying a payer or end user of a new risk to their business. A single reference to monitoring and notifying changes to database records comes from Prior Art relating to monitoring credit bureau information for changes—not changes in trend which effect changes in business processes or improper prevention and detection methods.
Prior Art does not specifically focus on pre-payment improper payment prevention—all reference post payment detection, which is inefficient post-payment retrospective recovery methodology. Post payment improper payment detection collects pennies on the dollar. Prevention mitigates 100% of the loss, versus focusing precious resources on recovery that may collect pennies on the dollar.
Prior Art does not provide methods or measurements to ensure each and every predictive model, strategy, action or treatment in the managed learning environment is statistically valid and empirically derived. Some Prior Art references predictive model usage, but none reference empirically derived or statistically valid. None of the Prior Art provides the ability to validate models or strategies, nor does it reference automated methods to ensure model stability and monitoring for a plurality of segments, models, characteristics and types of false positives or false negatives.

### PRIOR ART

### Summary Descriptions

See Appendix 1-3 (attached) for a more detailed description of the prior art.

| | | | | | | Filing Date & |
|---|---|---|---|---|---|---|
| Patent/ | | | | | | Issue Date/ |
| Patent | | | Industry/ | | | Publication |
| Application | Patent Title | Category | Purpose | Description | Inventor(s) | Date |
| 7,835,893 | Method And System | Case | Petroleum | Production simulation that | Cullick, et al. | F: Sep. 3, |
| | For Scenario And | Management | | includes variable inputs and use | | 2003 |
| | Case Decision | | | of economic model for petroleum | | I: Nov. |
| | Management | | | reservoir exploitation. Case | | 16, 2010 |
| | | | | management for model | | |
| | | | | management. | | |
| 6,321,206 | Decision Management | Decision | Financial | Computer-implemented rules | Honarvar; | F: Dec. |
| See | System For Creating | Management | Services | based decision management | Laurence | 21, 1998 |
| 7,062,757 | Strategies To Control | | Telecom | system which is cross-platform, | (Arnold, MD) | I: Nov. |
| Below | Movement Of Clients | | | cross-industry and cross-function | | 20, 2001 |
| | Across Categories | | | to manage clients, customers or | | |
| | | | | applicants of an organization. | | |
| | | | | Applies predictive modeling | | |
| | | | | techniques to customer data. | | |
| | | | | Randomly group cases into | | |
| | | | | different test groups for the | | |
| | | | | purpose of applying competing | | |
| | | | | policy rules, strategy, or | | |
| | | | | experiments. | | |
| 7,103,517 | Experimental Design | Experimental | Computer | Cache architecture simulation, | Gluhovsky, et al. | F: Jul. 3, 2002 |
| | And Statistical | Design | Industry | using Gaussian model | | I: Sep. 5, |
| | Modeling Tool For | Simulation | | experiments, on sample space to | | 2006 |
| | Workload | Models for | | optimize cache performance. | | |
| | Characterization | Cache | | | | |
| | | Management | | | | |
| 7,917,378 | System For Processing | Pre-Adjudication | Healthcare | Claim preprocessing system, with | Fitzgerald, et al. | F: Sep. |
| | Healthcare Claim Data | Claims | | rules, to improve claim accuracy | | 20, 2002 |
| | | Processing | | for healthcare payer institutions. | | I: Mar. 29, |
| | | | | | | 2011 |
| 7,865,373 | Method And | Data Sharing | Healthcare | Method for sharing medical data | Punzak, et al. | F: Oct. 15, |
| | Apparatus For Sharing | Method for | | over a network. Collecting, | | 2003 |
| | Healthcare Data | Patient History | | organizing, storing, distributing | | I: Jan. 4, |
| | | | | medical history for one patient at | | 2011 |
| | | | | a time to nurses or physicians, to | | |
| | | | | reduce healthcare cost and | | |
| | | | | inefficiency. | | |
| 7,925,620 | Contact Information | Data Sharing | Manage | Method and system for storing, | Yoon | F: Aug. 6, |
| | Management | Method for | Contacts | retrieving and sharing personal | | 2007 |
| | | Contact | | and business contact information | | I: Apr. 12, 2011 |
| | | Information | | from a database. | | |
| 7,903,801 | Contact Information | Data Sharing | Manage | Method for identifying and | Ruckart | F: Oct. 6, |
| | Management | Method for | Subscriptions | contacting subscribers during a | | 2006 |
| | | Subscriptions | | disaster. Information is provided | | I: Mar. 8, 2011 |
| | | | | to searching person who is | | |
| | | | | attempting to contact a subscriber | | |
| 7,325,012 | Relationship | Database | Database | System to tie one or more user | Nagy | F: Sep. |
| | Management System | Relational | Management | relationships for a pluratiy of | | 30, 2003 |
| | Determining Contact | Management | | users. | | I: Jan. 29, |
| | Pathways In A Contact | | | | | 2008 |
| | Relational Database | | | | | |
| 6,609,120 | Decision Management | Decision | Strategy | Auto search for strategy | Honarvar, et al. | F: Jun. 18, 1999 |
| See | System, Which | Management | Management | components of a strategy to | | I: Aug. 19, |
| 6,321,206 | Automatically | | | determine each place where the | | 2003 |
| Above | Searches For Strategy | | | strategy component is being used | | |
| Or | Components In A | | | in the strategy, and to determine | | |
| 7,062,757 | Strategy | | | the inter-relationships of the | | |
| Below | | | | strategy component to other | | |
| | | | | strategy components. | | |
| 7,657,636 | Workflow Decision | Workflow | Computer | Computer processor memory | Brown, et al. | F: Nov. 1, |
| | Management With | Management | Industry | management using filters. | | 2005 |
| | Intermediate Message | | | | | I: Feb. 2, |
| | Validation | | | | | 2010 |
| 7,584,239 | System Architecture | Workstation | Network | Platform agnostic workstation | Yan, et al. | F: May 6, 2003 |
| | For Wide-Area | Sharing | Managment | sharing for multiple users. | | I: Sep. 1, |
| | Workstation | | | | | 2009 |
| | Management | | | | | |
| 7,418,431 | Web Station: | Data Analytics | Healthcare | Data analytics, driven by | Nies, et al. | F: Sep. |
| | Configurable Web- | and Case | | hierarchial report trees. | | 27, 2000 |
| | Based Workstation For | Management for | | Reporting, web configuration | | I: Aug. 26, |
| | Reason Driven Data | Fraud | | with case management | | 2008 |
| | Analysis | | | capabiliies. Analyze data and | | |
| | | | | predictive model results. Report | | |
| | | | | summary comparisons to peer | | |
| | | | | groups using different | | |
| | | | | characteristics/attributes. | | |
| 6,373,935 | Workstation For | Case | Telecom | Improved system for detecting, | Afsar, et al. | F: Apr. 21, |
| | Calling Card Fraud | Management for | | analyzing and preventing | | 1998 |
| | Analysis | Fraud | | fraudulent use of telephone | | I: Apr. 16, 2002 |
| | | | | calling card numbers. The | | |
| | | | | invention provides enhanced | | |
| | | | | intelligence and efficiency in | | |
| | | | | detecting fraudulent use of calling | | |
| | | | | card numbers. Workstation | | |
| | | | | access to fraud cases. Assess | | |
| | | | | transaction for fraud potential | | |
| | | | | with alert capabilities driven by | | |
| | | | | rules or filter queries. Case | | |
| | | | | manager builds cases for efficient | | |
| | | | | analysis. | | |
| 5,276,732 | Remote Workstation | Remote | | Remote database access and data | Stent, et al. | F: Aug. 22, |
| | Use With Database | Database Access | | retrieval. | | 1991 |
| | Retrieval System | | | | | I: Jan. 4, |
| | | | | | | 1994 |
| 4,872,197 | Dynamically | Data | | Dynamic networking for | Pemmaraju | F: Oct. 2, |
| | Configurable | Transmissions | | transmissions through a network. | | 1986 |
| | Communications | | | | | I: Oct. 3, |
| | Network | | | | | 1989 |
| 7,761,481 | Schema Generator: | Data | Healthcare | Reformating and parsing data for | Gaurav, et al. | F: Mar. 14, |
| | Quick And Efficient | Standardization | | XML schema. Specifically, | | 2005 |
| | Conversion Of | | | transforming encoding rules to | | I: Jul. 20, 2010 |
| | Healthcare Specific | | | validate messages. | | |
| | Structural Data | | | | | |
| | Represented In | | | | | |
| | Relational Database | | | | | |
| | Tables, Along With | | | | | |
| | Complex Validation | | | | | |
| | Rules And Business | | | | | |
| | Rules, To Custom | | | | | |
| | HL7XSD With | | | | | |
| | Applicable | | | | | |
| | Annotations | | | | | |
| 6,151,581 | System For And | Data | Healthcare | Acquisition, management and | Kraftson, et al. | F: Dec. 16, |
| | Method Of Collecting | Management | | processing of patient clinical data | | 1997 |
| | And Populating A | | | and patient survey information | | I: Nov. 21, |
| | Database With | | | from a plurality of physicians, for | | 2000 |
| | Physician/Patient Data | | | practice performance information. | | |
| | For Processing To | | | This includes health outcomes, | | |
| | Improve Practice | | | clinical practice information for | | |
| | Quality And | | | physician practice and practice | | |
| | Healthcare Delivery | | | quality improvement. | | |
| 7,752,157 | Healthcare Workflow | Workflow | Healthcare | Utilize fuzzy logic for managing | Birkhoelzer | F: Sep. |
| | Management System | Management | | clinical workflow for hospitals/ | | 30, 2003 |
| | And Method With | | | departments to deliver | | I: Jul. 6, 2010 |
| | Continuous Status | | | instructions for activity | | |
| | Management And | | | management. Can also use rules, | | |
| | State-Based | | | probability based modeling or | | |
| | Instruction Generation | | | general weighting. | | |
| 7,509,280 | Enterprise Healthcare | Database | Healthcare | Using a master index to acurately | Haudenschild | F: Jul. 21, 1999 |
| | Management System | Management | | associate medical information for | | I: Mar. 24, |
| | And Method Of Using | | | a given person from a plurality of | | 2009 |
| | Same | | | healthcare facilities. | | |
| 5,596,632 | Message-Based | Workstation | Telecom | Monitor and detect fraud, at a | Curtis, et al. | F: Aug. 16, |
| | Interface For Phone | Management for | | plurality of workstations, based | | 1995 |
| | Fraud System | Fraud | | upon an occurance of an alarm. | | I: Jan. 21, |
| | | | | Each monitoring plan has three | | 1997 |
| | | | | features: thresholds, risk factors | | |
| | | | | and suspect numbers. | | |
| 5,852,819 | Flexible, Modular | Data | | Database solution, with a modular | Beller | F: Jan. 30, |
| | Electronic Element | Management | | infrascructure, for acquiring, | | 1997 |
| | Patterning Method | | | storing, analyzing, integrating, | | I: Dec. 22, |
| | And Apparatus For | | | organizing, transmitting and | | 1998 |
| | Compiling, | | | reporting data. | | |
| | Processing, | | | | | |
| | Transmitting, And | | | | | |
| | Reporting Data And | | | | | |
| | Information | | | | | |
| 5,099,424 | Model User | Data | Healthcare | Acquiring and storing patient test | Schneiderman | F: Jul. 20, 1989 |
| | Application System | Management | | results as data records to access, | | I: Mar. 24, |
| | For Clinical Data | | | review and report on one patient | | 1992 |
| | Processing That | | | at a time. | | |
| | Tracks And Monitors | | | | | |
| | A Simulated Out- | | | | | |
| | Patient Medical | | | | | |
| | Practice Using Data | | | | | |
| | Base Management | | | | | |
| | Software | | | | | |
| 5,307,262 | Patient Data Quality | Data | Healthcare | Data quality assessment by | Ertel | F: Jan. 29, |
| | Review Method And | Management | | aggregating and tracking case | | 1992 |
| | System | | | level data for a patient for time | | I: Apr. 26, 1994 |
| | | | | trending and reporting. | | |
| 5,253,164 | System And Method | Data Mining | Heatlhcare | Using a predetermined database, | Holloway, et al. | F: Jan. 29, |
| | For Detecting | | | via examination of service codes | | 1991 |
| | Fraudulent Medical | | | with rules, representing medical | | I: Oct. 12, |
| | Claims Via | | | judgement, within an expert | | 1993 |
| | Examination Of | | | system, to detect fraud. | | |
| | Service Codes | | | | | |
| 5,873,082 | List Process System | List Processing | | List processing using identifiers | Noguchi | F: Jul. 31, 1997 |
| | For Managing And | | | to merge or extract data. List | | I: Feb. 16, |
| | Processing Lists Of | | | process system and a method for | | 1999 |
| | Data | | | effectively processing a plurality | | |
| | | | | of lists, each of which is | | |
| | | | | composed of plurality of data, and | | |
| | | | | extracting the features thereof. | | |
| 6,629,095 | System And Method | Data Mining | | Data mining, using a plurality of | Wagstaff, et al. | F: Oct. 13, |
| | For Integrating Data | | | sources and a relational database, | | 1998 |
| | Mining Into A | | | which outputs a model output | | I: Sep. |
| | Relational Database | | | table. provides a data mining | | 30, 2003 |
| | Management System | | | model including a definition for a | | |
| | | | | relational “PREDICT” table | | |
| | | | | providing multiple relationships | | |
| | | | | between input values and output | | |
| | | | | values. | | |
| 7,778,846 | Sequencing Models Of | Data Mining | Healthcare | Transition probability (2-way) | Suresh, et al. | F: Feb. 15, |
| | Healthcare Related | | | sequencing models and metrics | | 2002 |
| | States | | | are created using claims data to | | F: Jul. 23, 2007 |
| | | | | identify potential fraudulent or | | I: Aug. 17, |
| | | | | abusive practices. The metrics can | | 2010 |
| | | | | be further analyzed in predictive, | | |
| | | | | unsupervised or parametric, or | | |
| | | | | rule based models, or other tools. | | |
| 6,633,962 | Method, System, | Data Security | Network | System, method, program, and | Burton, et al. | F: Mar. 21, |
| | Program, And Data | | | data structures for restricting | | 2000 |
| | Structures For | | | access to physical storage space. | | I: Oct. 14, |
| | Restricting Host | | | | | 2003 |
| | Access To A Storage | | | | | |
| | Space | | | | | |
| 6,735,601 | System And Method | Data Access | Network | System for remote access of files, | Subrahmanyam | F: Dec. 29, |
| | For Remote File | | Remote | executable files/programs and | | 2000 |
| | Access By Computer | | Access | data files, via network, on one or | | I: May 11, 2004 |
| | | | | more other computers Including | | |
| | | | | operating system, storage or file | | |
| | | | | transfer. Access and review | | |
| | | | | results on a central terminal. | | |
| 7,107,267 | Method, System, | Data Security | Network | Background - Locking | Taylor | F: Jan. 31, |
| | Program, And Data | | Security | mechanism to control access to a | | 2002 |
| | Structure For | | | shared resource to control | | I: Sep. 12, |
| | Implementing A | | | execution of concurrent | | 2006 |
| | Locking Mechanism | | | opperations. Two processes can | | |
| | For A Shared | | | not be allowed to submit | | |
| | Resource | | | simutaneously. | | |
| | | | | Invention - provide a technique | | |
| | | | | for implementing a locking | | |
| | | | | mechanism for applications | | |
| | | | | implemented in computer | | |
| | | | | languages that are intended to | | |
| | | | | execute across multiple operating | | |
| | | | | system platforms. | | |
| 7,146,233 | Request Queue | Data | Network | Method/system for receiving a | Aziz, et al. | F: Nov. |
| | Management | Management | Requests | request from a client for work to | | 20, 2002 |
| | | | | be performed and storing the | | I: Dec. 5, |
| | | | | request in a queue. Select | | 2006 |
| | | | | requests from the queue based | | |
| | | | | upon one or more criteria. | | |
| | | | | Methods and apparatus providing, | | |
| | | | | controlling and managing a | | |
| | | | | dynamically sized, highly scalable | | |
| | | | | and available server farm. | | |
| 6,308,205 | Browser-Based | Network | Network | Allow remote network users to | Carcerano, et al. | F: Oct. 22, |
| | Network Management | Management | Configuration | view, access and update | | 1998 |
| | Allowing | | | configurations of network devices | | I: Oct. 23, |
| | Administrators To Use | | | by using a web browser on the | | 2001 |
| | Web Browser On | | | users work station. | | |
| | User's Workstation To | | | | | |
| | View And Update | | | | | |
| | Configuration Of | | | | | |
| | Network Devices | | | | | |
| 5,838,907 | Configuration | Network | Network | Configuration manager for | Hansen | F: Feb. 20, |
| | Manager For Network | Management | Configuration | configuring a network device | | 1996 |
| | Devices And An | | | remotely coupled thereto. | | I: Nov. 17, |
| | Associated Method | | | | | 1998 |
| | For Providing | | | | | |
| | Configuration | | | | | |
| | Information Thereto | | | | | |
| 6,029,196 | Automatic Client | Network | Network | Provides an automatic client | Lenz | F: Jun. 18, 1997 |
| | Configuration System | Managment | Configuration | configuration system. The | | I: Feb. 22, |
| | | | | invention utilizes an efficient, | | 2000 |
| | | | | easily managed and operated | | |
| | | | | centralized configuration file | | |
| | | | | system that allows the user to | | |
| | | | | configure an entire network of | | |
| | | | | clients from a centralized server. | | |
| 7,062,757 | Decision Management | Decision | Financial | Computer-implemented rules | Honarvar, et al. | F: May 9, 2003 |
| See | System Which Is | Management | Services and | based decision management | | I: Jun. 13, 2006 |
| 6,321,206 | Cross-Function, Cross- | | Telecom | system which is cross-platform, | | |
| Above | Industry And Cross- | | | cross-industry and cross-function | | |
| | Platform | | | to manage clients, customers or | | |
| | | | | applicants of an organization. | | |
| | | | | Applies predictive modeling | | |
| | | | | techniques to customer data. | | |
| | | | | Randomly group cases into | | |
| | | | | different test groups for the | | |
| | | | | purpose of applying competing | | |
| | | | | policy rules, strategy, or | | |
| | | | | experiments. | | |
| 6,922,684 | Analytical-Decision | Data Mining | Product Life- | Query quality and cost | Aldridge, et al. | F: Aug. 31, |
| | Support System For | | Cycle | information in product life cycle. | | 2000 |
| | Improving | | Management | Product management analysis, | | I: Jul. 26, 2005 |
| | Management Of | | | process management analysis, | | |
| | Quality And Cost Of | | | service supplier analysis, | | |
| | A Product | | | management analysis, component | | |
| | | | | supplier analysis, warranty | | |
| | | | | analysis, maintenance analysis, | | |
| | | | | and forecasting analysis from the | | |
| | | | | operational data store | | |
| 7,835,983 | Credit Approval | Data Record | Financial | Credit report monitoring, which | Lefner, et al. | F: Sep. 17, |
| | Monitoring System | Monitoring | Services | transmits a message to a customer | | 2004 |
| | And Method | | | indicating changes to the report | | I: Nov. 16, |
| | | | | based upon select criteria. | | 2010 |
| 7,809,729 | Model Repository | Data Mining | | Storing data models (statistical) | Chu, et al. | F: Jul. 12, 2005 |
| | | | | generated by data mining, by | | I: Oct. 5, 2010 |
| | | | | applying tree type structures to | | |
| | | | | variables. | | |
| 8,015,133 | Computer- | Security | Network | Datamining, using time series and | Hu, et al. | F: Sep. 6, |
| | Implemented | Monitoring | | non-time series data, to create | | 2007 |
| | Modeling Systems | | | anomaly detection models, | | I: Sep. 6, |
| | And Methods For | | | defined as predictive models. | | 2011 |
| | Analyzing And | | | Create time series models and | | |
| | Predicting Computer | | | parametric models, for example | | |
| | Network Intrusions | | | unsupervised or neural net to | | |
| | | | | analyze multiple entities to detect | | |
| | | | | outliers. | | |
| 7,882,127 | Multi-Category | Data Mining | Healthcare | System, method and computer | Venkayala, et al. | F: Apr. 22, 2003 |
| | Support For Apply | | Credit Card | program product that provides a | | I: Feb. 1, |
| | Output | | | multi-category apply operation in | | 2011 |
| | | | | a data mining system that | | |
| | | | | produces output with multiple | | |
| | | | | class values and their associated | | |
| | | | | probabilities. Applicable to | | |
| | | | | supervised learning models and | | |
| | | | | unsupervised techniques such as | | |
| | | | | clustering. | | |
| 7,383,215 | Data Center For | Account | Financial | The invention provides an | Navarro, et al. | F: Oct. 26, |
| | Account Management | Management | Services | account manager and database | | 2000 |
| | | | Credit Card | system that allows end users to | | I: Jun. 3, 2008 |
| | | | | bypass the need to integrate such | | |
| | | | | systems in to their legacy | | |
| | | | | information management systems. | | |
| 5,890,129 | System For | Data | Healthcare | System for controlling the | Loren J. Spurgeon | F: May 30, 1997 |
| | Exchanging Health | Management | | exchange of subscriber | | I: Mar. 30, 1999 |
| | Care Insurance | | | demographics, benefit plan, | | |
| | Information | | | eligibility, prior authorization, | | |
| | | | | claims, quality assurance and | | |
| | | | | governmental regulatory | | |
| | | | | information between an insurance | | |
| | | | | company and multiple health care | | |
| | | | | provider groups. Basic | | |
| | | | | integration and normalization of | | |
| | | | | data for payers or third party | | |
| | | | | administrators. | | |
| 10/525,772 | Adaptive Medical | Decision | Healthcare | Expert system for medical | Steven Wheeler | F: Oct. 8, |
| | Decision Support | Management | | decision making. Assist medical | | 2004 |
| | System | | | professional with diagnosis and | | |
| | | | | treatment. Reporting and | | |
| | | | | analyzing outcomes. | | |
| 12/257,782 | Rules Engine | Decision | Healthcare | Integrated development | Kandasamy, et | F: Oct. 24, |
| | Framework | Management | | environment application for | al. | 2008 |
| | | | | development of rules. For | | |
| | | | | example, provider and beneficiary | | |
| | | | | enrollment, claims processing | | |
| | | | | rules and payments. | | |
| 11/284,855 | System And Method | Data Processing | Heatlhcare | Integrated knowledge database. | Avinash, et al. | F: Nov. 22, |
| | For Integrated | | | | | 2005 |
| | Learning And | | | | | |
| | Understanding Of | | | | | |
| | Healthcare Informatics | | | | | |
| 10/321,894 | Distributing Accounts | Workflow | Debt | Efficient distribution of accounts | Tagupa, et al. | F: Dec. 16, |
| | in a Workflow System | Managment | Collections | (assign, move, schedule | | 2002 |
| | | | | Accounts) | | |
| 6,795,071 | Method of Managing | Workflow | Debt | Manage workflow for | Tracy, et al. | F: Dec. 10, |
| | Workflow Information | Managment | Collections | employment in debt collection | | 2002 |
| | | | | | | I: Sep. 21, |
| | | | | | | 2004 |
| 6,798,413 | Workflow | Workflow | Debt | Workflow management with | Tracy, et al. | F: Dec. 3, |
| | Management System | Management | Collections | contact management for debt | | 1999 |
| | | | | collections | | I: Sep. 28, |
| | | | | | | 2004 |
| 10/889,210 | System for Managing | Workflow | Debt | System for managing debtors with | Exline, et al | F: Jul. 12, 2004 |
| | Workflow | Managment | Collections | Graphical User Interfact viewing | | |

### SUMMARY DESCRIPTION OF THE INVENTION

The present invention is an Automated Healthcare Risk Management System for efficient and effective identification and resolution of healthcare fraud, abuse, over-servicing, over-utilization, waste and errors. It is a software application and interface that assists nurses, physicians, medical investigators, law enforcement or adjustors and risk management experts by focusing their prevention efforts on the highest risk and highest value providers, healthcare merchants, medical claims or beneficiaries (sometimes defined as patient) with improper cost dynamic components such as fraud, abuse, over-servicing, over-utilization, waste and error. It uses empirically derived, statistically valid, probabilistic scores to identify medical claim, provider, healthcare merchant and beneficiary related fraud and abuse as inputs to streamline identification and review of potential fraudulent or abusive transactions. Further it utilizes population risk adjusted, provider cost or waste index methodology to identify waste, over-servicing or over-utilization present results to nurses, physicians, medical investigators, law enforcement or adjustors and risk management experts for actions. Additionally, compliance profiling is utilized to identify and present claims that contain errors and should not be paid. The Automated Healthcare Risk Management System applies automated empirical decision strategies to manage risk for suspect claims or transactions, systematically conducts analysis and optimizes the effectiveness of alternative strategies, treatments, actions for investigators. It subsequently reports on the results and effectiveness of risk management operations and its resources to leadership.

More particularly, the Automated Healthcare Risk Management System utilizes real-time Predictive Models, a Provider Cost Index, Edit Analytics, Strategy Management, a Managed Learning Environment, Contact Management and Forensic GUI for targeting and individually identifying and preventing fraud, abuse, waste and errors prior to payment. Probabilistic scores are utilized to optimize return on investment, expected outcomes and resource management. The Automated Healthcare Risk Management System assists healthcare claims investigators and risk management experts by automated review of hundreds of millions of claims or transactions and then focusing their research, analysis, strategy, reporting and prevention efforts on only the highest risk and highest value claims for fraud, abuse, improper payments or over-servicing. Use of the Automated Healthcare Risk Management System does not require the education and experience of a statistician, programmer, or data or business analyst. It is designed for typical investigators in the healthcare industry, such as nurses, physicians, medical investigators or adjustors within the healthcare industry whose goal is to find timely resolution to complex fraud or abuse scenarios, not spending precious time to learn how to build queries perform analysis and search for suspect providers, healthcare merchants, beneficiaries or facilities, for example. The system can be connected to multiple large databases, which include, for example, national and regional medical and pharmacy claims data, as well as provider, healthcare merchant and beneficiary historical information, universal identification numbers, the Social Security Death Master File, Credit Bureau data such as credit risk scores and/or a plurality of other external data and demographics, Identity Verification Scores and/or Data, Change of Address Files for Providers or Healthcare Merchants, including “pay to” address, or Patients/Beneficiaries, Previous provider, healthcare merchant or beneficiary fraud “Negative” (suppression) files or tags (such as fraud, provider sanction, provider discipline or provider licensure, etc.), Eligible Beneficiary Patient Lists and Approved Provider or Healthcare Merchant Payment Lists. It automatically retrieves supporting views of the data in order to facilitate, enhance and implement multiple investigator decisions for claims, providers, healthcare merchants and beneficiaries with systematic recommendations, strategies, reports and management actions. More specifically, the data includes beneficiary history, provider, healthcare merchant and beneficiary interactions over time, provider actions and treatments, provider cohort comparisons, reports and alternative and adaptive strategies for managing potentially risky or costly claims or transactions associated with fraud, abuse, improper payments or over-servicing. The claims, transactions and other provider, healthcare merchant, beneficiary and facility information are prioritized from high fraud risk to low risk based upon:
1. A plurality of empirically derived and statistically valid model scores generated by multi-dimensional statistical algorithms and probabilistic predictive models that identify providers, healthcare merchants, beneficiaries or claims as potentially fraud or abuse
2. Empirically optimized strategy management algorithms, sometimes referred to as optimized decisions strategies, that are designed to adapt to changing patterns of cost dynamics for improper payments
3. Population risk adjustment modeling and profiling capabilities, here defined as episode of care, that allow an investigator a mathematical and graphical capability to normalize population health and co-morbidity and follow beneficiary care and provider services and treatments across all healthcare segments, provider specialty groups, healthcare merchants, geographies and market segments.
4. Empirical comparisons and statistical analyses performed on “similar” types of claims, providers, healthcare merchants and beneficiaries, using statistical methods, including but not limited to methods such as Chi-Square
5. Compliance or policy profiles promulgated and required by regulatory agencies or established by payers or key stakeholders
6. Action codes based on the importance of unique provider, healthcare merchant, claim and beneficiary characteristics
7. Treatment optimization, in which new treatments are tested, using unbiased and scientifically approved sampling methods or techniques, to improve efficiency and effectiveness, through a Managed Learning Environment—examples of treatments include, but are not limited to queue, research, payment, decline payment, educate, add a provider to a warning list
8. Real time Decision Strategy Management edit capabilities to quickly adapt to emerging fraud, abuse, waste or error trends
9. Payment decisions, at the discretion of the user, can be made systematically whether to pay or decline. In the event that a very small percentage of providers, healthcare merchants, claims or beneficiaries require more research, a sub-second, real time access is provided to multiple years of claim, procedure/line level, diagnosis, provider, healthcare merchant or beneficiary data history to aid investigators, such as nurses, physicians, medical investigators and adjustors and risk management experts in decision making such as pay, decline or request more information prior to payment
10. Dynamic navigation through a Graphical User Interface that allows a user to quickly navigate through a complex collection, but efficiently organized, amount of data to quickly identify, for example, suspicious, fraudulent, abusive, wasteful or compliance edit failure activity by an entity, and efficiently bring resolution such as decline or pay or queue
11. Systematic analysis and reporting of score performance results, including:
   a. A Feedback Loop to dynamically update model coefficients or probabilistic decision strategies, as well as monitor emerging improper payment trends in a real-time fashion.
   b. Validation and on-demand queue reporting available to track improper payment identification and model and strategy validations.
   a. Complete cost benefit analysis that provides normalized estimates for fraud and abuse prevention, detection or recovery
   b. Risk adjusted waste, over servicing or overutilization assessments that calculate provider cost or waste indexes, that are presented mathematically and graphically for use in educating the provider or creating cohort benchmarks for determining punitive actions
   c. Error assessment analysis and recovery estimates
   d. Business reports that summarize risk management performance, provide standard, ad hoc, customizable and dynamic reporting capabilities to summarize performance, statistics and to better manage fraud, abuse, over-servicing, over-utilization, waste and error prevention and return on investment
12. Provides real-time triggers to activate intelligence capabilities, combined with predictive scoring models, to take action when risk thresholds are exceeded
13. Provides real time monitoring, measuring, identification and visual presentation of performance and changing patterns of fraud or abuse in a dashboard format for an operations (“ops”) room, control room or war-room type display environment.
14. Securely memorialize investigations, documentation, action, files and data through an internal or external case management system that can be accessed through multiple electronic mediums, including, but not limited to such vehicles as a phone, computer, note pad
15. Investigator analysis and real time filters, which allows a healthcare investigator, not a statistician, programmer or data or business an analyst, to explore complex data relationships and underlying individual transactions, as identified by the mathematical algorithms and probabilistic model scores and their associated reason codes when a provider, healthcare merchant, beneficiary or claim is identified as high risk
16. Statistically and empirically comparing a unique provider's activities with activities of similar populations to contrast provider behavior for those providers who are identified as high risk—this methodology is also utilized for individual healthcare merchants, beneficiaries and claims
17. Dynamically view dimensions, in real time, that contain automated and targeted reports for researching and resolving fraud, abuse, waste, over-servicing or over-utilization quickly and efficiently

Although very recent to healthcare, scoring models have helped alleviate some of the problems associated with the random or rules-based approach to the review of healthcare claims. See utility patent application Ser. No. 13/074,576 (Rudolph, et al.), filed Mar. 29, 2011 or utility patent application Ser. No. 13/617,085 (Jost, et al.), filed Sep. 14, 2012 for an in depth discussion of modeling weakness of parametric modeling techniques and traditional non-parametric approaches. However, Automated Risk Management infrastructure does not exist that makes it more efficient and effective for a nurse, physician, medical investigator or adjustor to identify and quickly resolve fraud, abuse or improper payments for providers, beneficiaries, claims or merchants. For example, some fraud models group the top 0.5%-1.0% of claims based upon an outlier score. Reviewers then sort the claims from highest risk to lowest risk manually within their workstation or within a spreadsheet that has been downloaded to a PC. Infrastructure is not considered for the historical review of procedures, claims or diagnosis codes across provider specialty groups, markets, segments or geographies. Prior Art references that most research is still completed using manual ad hoc pulls of data. More particularly, efficient resolution is not tied to the system containing the score and history. By combining the following capabilities within Automated Healthcare Risk Management System, efficiency and effectiveness can become even greater when assessing, identifying and investigating high risk claims, providers, healthcare merchants and beneficiaries. The major components of the Automated Healthcare Risk Management Include, but are not limited to:

### A Real-Time Scoring Platform and Database→Containing

Source of claim history including claim payers and processors
Data Security
Application Programming Interface, Software as a Service (SAAS)
Historical Claims, Providers, Healthcare Merchants, Beneficiaries, Diagnosis and Demographic Database Storage—also includes a plurality of appended external information, including but not limited to, credit bureau, identity and previous sanctions
Real-time Data Preprocessing and new characteristic creation
Real-time Database—Access to both Internal and External Data
Multi-Dimensional Predictive Model Scoring Engine
Real-Time Scoring Engine and Score Reason Generator
Variable Transformations and Multi-Dimensional Probability Score calculations representing a plurality of payment risks such as, overall fraud, abuse, waste, over-servicing or over-utilization

### Risk Management Platform

Real-Time Predictive Models,
Risk Adjusted Provider Cost Index,
Edit Analytics
Strategy Management, Managed Learning Environment
Contact and Treatment Management Optimization—methodology to estimate, measure and maximize return on investment for a plurality of contact types and costs, as well as a plurality treatment types and costs
Intelligent Forensic GUI, Case Management And Reporting System
Management Reporting Dashboard, providing Real-Time Financial and Performance

Measurements, with Scheduled Dynamics Displayed
Real-time Feedback Loop—Actual Results Process, based upon a plurality of Outcomes
Episode of Care Design—Identifying and displaying a beneficiaries or patient's treatment, care across and financial effort across a plurality of healthcare segments, independent of physician or specialty group, including but not limited to:
   Patients
   Providers/Physicians, Practice groups
   Hospital, Inpatient Facilities, Outpatient Institutions
   Pharmaceutical or Pharmacies
   Skilled Nursing Facilities, Hospice, Home Health, Durable Medical Equipment Facilities
   Laboratories
   Claims Processors and interacting combinations of foregoing entities and other healthcare intermediaries

A plurality of attributes may be actively, versus passively, presented on the Automated Healthcare Risk Management System's Variable Inventory—including, but not limited to:
Procedure per unique patient
Procedure per unique claim
Unique patients per unique diagnosis
Unique Patients per unique procedure
Sum of Payments per Unique Patients
Age of patient for this procedure
Place of service * specialty (indicator variable for abnormal)
Type of service * specialty (indicator variable for abnormal)
Provider intensity of modifier use. How frequently a provider uses a particular modifier with a particular procedures compared to peer group.
Top procedures for a statistical comparison group

### BRIEF DESCRIPTION OF THE DRAWINGS

FIG. 1—High Level Block Diagram Showing Risk Management Process to Identify and Investigate Fraud, Abuse, Waste and Errors

FIG. 2—Shows Flow For Historical Data Summary Statistical Calculations

FIG. 3—Shows Flow For Predictive Model Score Calculation, Validation And Deployment Process

FIG. 4—Shows A Provider Claim Score Reason Summary Screen

FIG. 5—Shows Risk Adjusted Provider Cost Index Calculation and Deployment Process

FIG. 6—Shows Risk Adjusted Provider Cost Index Calculation and Deployment Process

FIG. 7—Shows Risk Adjusted Provider Cost Index Calculation and Deployment Process

FIG. 8—Presents A Provider Over-Servicing, Over-Utilization, Waste Mathematical, Graphical Example

FIG. 9—Presents A Provider Over-Servicing, Over-Utilization, Waste Mathematical, Risk Adjusted Drilldown Example

FIG. 10—Edit Analytics Assessment Process And Deployment Process

FIG. 11—Provider Edit Analytics Landing Page—NCCI and MUE Edit Example

FIG. 12—Fraud Prevention Risk Management Process

FIG. 13—Diagram Combining Analytical Technology With Managed Learning Environment

FIG. 14—Shows An Input Screen Example Of Application View Schematic—Strategy, Managed Learning Environment, Actions

FIG. 15—Strategy With Real Time Queuing Example

FIG. 16—Shows An Example Of A High Score Claims Queue

FIG. 17—Shows A Secure Login Screen Example

FIG. 18—Strategy Manager Hash Input Example

FIG. 19—Strategy Manager Data Input Tables And Input Fields Example

FIG. 20—Contact Management Flow And Deployment

FIG. 21—Provides An Example Of Capability Access And Selection Example

FIG. 22—Example Search Screen For Good And Bad Claims, Providers, Healthcare Merchants And Beneficiaries

FIG. 23—Presents And Example Of Research Screen Column Configuration

FIG. 24—High Score Claims Queue—Instant Profile

FIG. 25—Presents A Multi-Dimensional Mapping Example For Provider Segment

FIG. 26—Displays a Provider Address Verification Mapping Example

FIG. 27—Example Of Feedback Loop Dropdown Box, Notes Inputs And Navigation Tabs

FIG. 28—Shows Provider Claim Procedure Detail Screen

FIG. 29—Provider Sub-claim History Example

FIG. 30—Provides Investigator Provider Profiling Examples

FIG. 31—Shows A Provider Comparative Billing Analysis Screen Example

FIG. 32—Example Schematic For Strategy And Sub-Strategy Targeting

FIG. 33—An example of an Optimized Decision Strategy.

### DETAILED DESCRIPTION OF THE PREFERRED EMBODIMENTS

### Overview

While this invention may be embodied in many different forms, there are described in detail herein specific preferred embodiments of the invention. This description is an exemplification of the principles of the invention and is not intended to limit the invention to the particular embodiments illustrated.

The present invention is an Automated Healthcare Risk Management System. The present invention utilizes Software as a Service design, Analytical Technology and a Risk Management design in order to optimally facilitate human interaction with and automated review of hundreds of millions of healthcare claims or transactions, or hundreds of thousands of providers or healthcare merchants to determine if the participants are high-risk for fraud and abusive practices or over servicing, wasteful or perpetrators of errors.

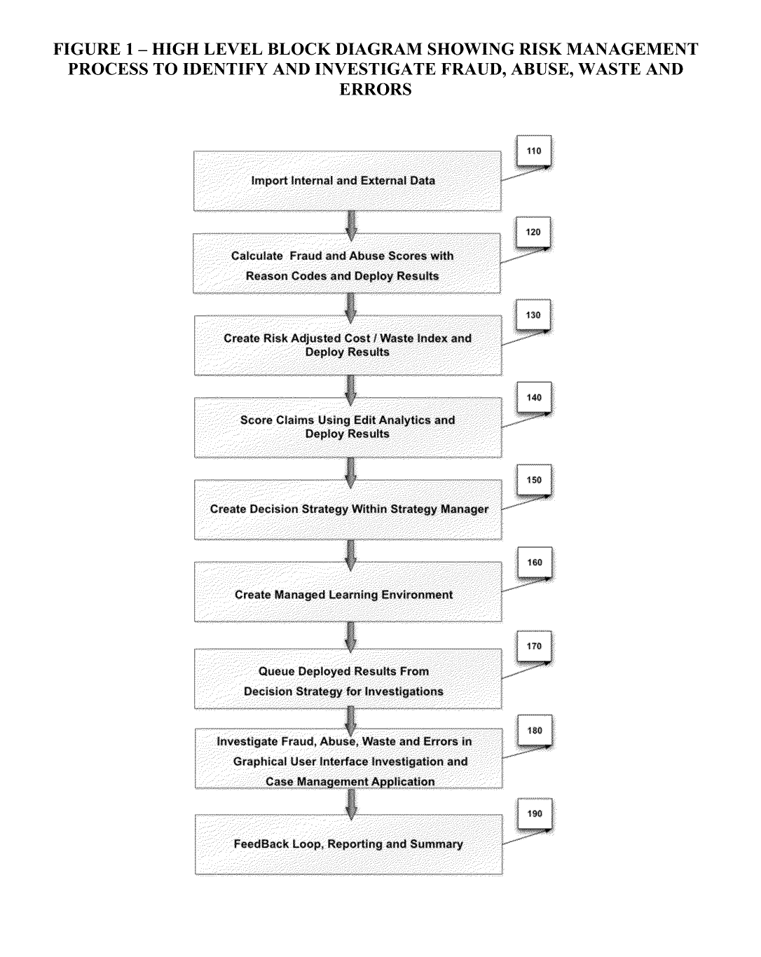

FIG. 1 describes the Risk Management design for the invention. Summary steps include:
1. Import and preprocess internal and external data and external predictive scores (Block 110)
2. Calculate fraud and abuse predictive scores and deploy results and associated reason codes (Block 120)
3. Calculate risk-adjusted cost/waste index, defined as the Provider Cost Index and deploy results and associated cost reasons (Block 130)
4. Assess claims using Edit Analytic decision logic, based upon industry standard compliance criteria (NCCI or MUE for example) and customer specific criteria (limiting payments based upon the number of hours worked in a day by a provider for example), and deploy results and associated reasons (Block 140)
5. Create empirical decision criteria and decision parameters real time, within Strategy Manager, using for example, predictive models, scores, Provider Cost Index, Edit Analytic results or internal or external data to systematically evaluate, trigger and investigate specific claims or transactions, created by providers, healthcare merchants or beneficiaries who were determined to be risky (Block 150)
6. Utilize Managed Learning Environment, with Contact Management Module design embedded within Strategy Manager to randomly test new models, data, actions, treatments and contact methods against control positions and measure incremental benefits (Block 160)
7. Deploy dynamic real time or batch queuing, based upon Strategy Manager criteria, Managed Learning Environment and Contact Management Strategy (where applicable), where immediate results can be accessed via a Forensic Graphical User Interface (GUI), with Case Management by multiple investigator levels of experience and stake holders—for example nurses, physicians, medical investigators, law enforcement or adjustors and risk management experts (Block 170)
8. Utilize nurses, physicians, medical investigators, law enforcement or adjustors and to research and interrogate claims, providers, healthcare merchants or beneficiaries, triggered by decision strategies, and provide timely resolution to complex improper payment scenarios, versus wasting precious time to learn and perform laborious analysis to locate improper payments (Block 180)
9. Execute Feedback Loop and systematically optimized decision strategies, contact management strategies, treatment and actions, as well as measure the incremental benefit of the test over the control position (Block 190)

### Import and Pre-Process Internal and External Data

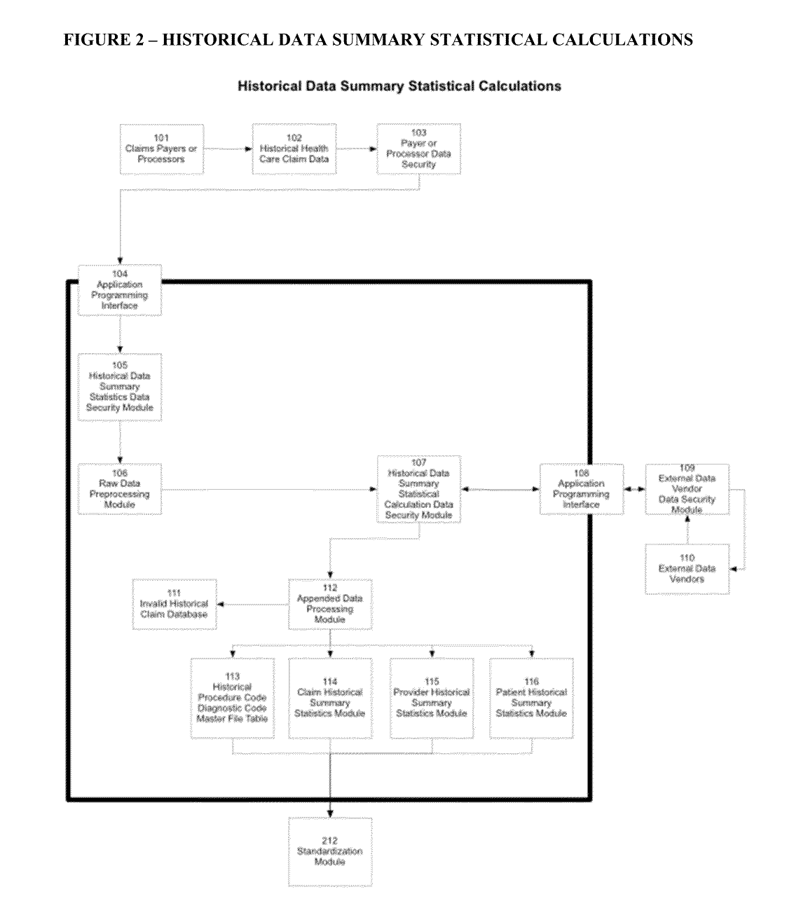

A plurality of external and internal data and predictive models can be made available for processing in the Scoring Engine, Decision Strategies, Strategy Manager, Managed Learning Environment and Forensic Investigation Graphical User Interface. Referring now to FIG. 2, as a perspective view of the technology, data system flow and system architecture of the Historical Data Summary Statistical Calculations, there are potentially multiple sources of historical data housed at a healthcare Claim Payer or Processors Module 101 (data can also come from, or pass through, government agencies, such as Medicare, Medicaid and TRICARE, as well as private commercial enterprises such as Private Insurance Companies (Payers), Third Party Administrators, Claims Data Processors, Electronic Clearinghouses, Claims Integrity organizations that utilize edits or rules and Electronic Payment entities that process and pay claims to healthcare providers). The claim processor or payer(s) prepare for delivery of historical healthcare claim data processed and paid at some time in the past, such as the previous year for example, Historical Healthcare Claim Data Module 102. The claim processor or payer(s) send the Historical Healthcare Claim Data from Module 102 to the Data Security Module 103 where it is encrypted. Data security is here defined as one part of overall site security, namely data encryption. Data encryption is the process of transforming data into a secret code by the use of an algorithm that makes it unintelligible to anyone who does not have access to a special password or key that enables the translation of the encrypted data to readable data. The historical claim data is then sent to the Application Programming Interface (API) Module 104. An API is here defined as an interaction between two or more computer systems that is implemented by a software program that enables the efficient transfer of data between the two or more systems. The API design translates, standardizes or reformats the data accordingly for timely and efficient data processing. The data is then sent via a secure transmission device, such as a dedicated fiber optic cable, to the Historical Data Summary Statistics Data Security Module 105 for un-encryption.

From the Historical Data Summary Statistics Data Security Module 105 the data is sent to the Raw Data Preprocessing Module 106 where the individual claim data fields are then checked for valid and missing values and duplicate claim submissions. The data is then encrypted in the Historical Data Summary Statistics External Data Security Module 107 and configured into the format specified by the Application Programming Interface 108 and sent via secure transmission device to an External Data Vendors Data Security Module 109 for un-encryption. External Data Vendors Module 110 then append(s) additional data such as Unique Customer Pins/UID's (proprietary universal identification numbers), Social Security Death Master File, Credit Bureau scores and/or data and demographics, Identity Verification Scores and/or Data, Change of Address Files for Providers, including “pay to” address, or Patients/Beneficiaries, Previous provider or beneficiary fraud “Negative” (suppression) files or tags (such as fraud, provider sanction, provider discipline or provider licensure, etc.), Eligible Beneficiary Patient Lists and Approved Provider Payment Lists. The data is then encrypted in the External Data Vendor Data Security Module 109 and sent back via the Application Programming Interface in Module 108 and then to the Historical Data Summary Statistics External Data Security Module 107 to the Appended Data Processing Module 112. If the external database information determines that the provider or patient is deemed to be deceased at the time of the claim or to not be eligible for service or to not be eligible to be reimbursed for services provided or is not a valid identity, at the time of the original claim date, the claim is tagged as “invalid historical claim” and stored in the Invalid Historical Claim Database 111. These claims are suppressed for claim payments and not used in calculating the statistical values for the fraud and abuse predictive model score. They may be referred back to the original claim payer or processor and used in the future as an example of fraud. The valid claim data in the Appended Data Processing Module 112 is reviewed for valid or missing data and a preliminary statistical analysis is conducted summarizing the descriptive statistical characteristics of the data.

### Calculate and Deploy Fraud and Abuse Predictive Model Score

Referring back to FIG. 2, one copy of the data is then sent from the Appended Data Processing Module 112 to the Historical Procedure Code Diagnostic Code Master File Table 113 to calculate the summary statistics, such as median and percentile values of the cost, or fee charged, for the procedure codes listed on the claim given the diagnosis code listed on the claim. The Procedure Code Master File Cost Table calculation is a process where the historical medical claim data file, segmented by industry type, is used to calculate the statistics for the cost for procedures billed on a claim given a diagnosis based on prior claim history experience of all providers (This data may also be segmented by geography, such as urban/rural or by state, for example). This table of costs is termed the Historical Procedure Code Diagnostic Code Master File Table 113.

Another copy of claim data is sent from the Appended Data Processing Module 112 to the Claim Historical Summary Statistics Module 114 where the individual values of each claim are accumulated into claim score calculated variables by industry type, provider, patient, specialty and geography. Examples of individual claim variables include, for example, but are not limited to: fee amount submitted per claim, sum of all dollars submitted for reimbursement in a claim, number of procedures in a claim, number of modifiers in a claim, change over time for amount submitted per claim, number of claims submitted in the last 30/60/90/360 days, total dollar amount of claims submitted in the last 30/60/90/360 days, comparisons to 30/60/90/360 trends for amount per claim and sum of all dollars submitted in a claim, ratio of current values to historical periods compared to peer group, time between date of service and claim date, number of lines with a proper modifier, ratio of amount of effort required to treat the diagnosis compared to the amount billed on the claim.

Within the Claim Historical Summary Statistics Module 114, historical descriptive statistics are calculated for each variable for each claim by industry type, specialty and geography. Calculated historical summary descriptive statistics include measures such as the median and percentiles, including deciles, quartiles, quintiles or vigintiles. The historical summary descriptive statistics for each variable in the predictive score model are used in Standardization Module 212 in order to calculate normalized variables related to the individual variables for the predictive scoring models.

Another copy of the data is sent from the Appended Data Processing Module 112 to the Provider Historical Summary Statistics Module 115 where the individual values of each claim are accumulated into provider score variables by multiple dimensions, for example by industry type, provider, specialty and geography. Examples of individual claim variables include (but are not limited to): amount submitted per claim, sum of all dollars submitted for reimbursement in a claim, number of patients seen in 30/60/90/360 days, total dollars billed in 30/60/90/360 days, number of months since provider first started submitting claims, change over time for amount submitted per claim, comparisons to 30/60/90/360 trends for amount per claim and sum of all dollars submitted in a claim, ratio of current values to historical periods compared to peer group, time between date of service and claim date, number of lines with a proper modifier.

Within Provider Historical Summary Statistics Module 115, historical summary descriptive statistics are calculated for each variable for each Provider by industry type, specialty and geography. Calculated historical descriptive statistics include measures such as the median, range, minimum, maximum, and percentiles, including deciles, quartiles, quintiles and vigintiles for the Physician Specialty Group. The Provider Historical Summary Statistics Module 115 for all industry types, specialties and geographies are then used by the Standardization Module 212 to create normalized variables for the predictive scoring models.

Another copy of the data is sent from the Appended Data Processing Module 112 to the Patient Historical Summary Statistics Module 116. The historical summary descriptive statistics are calculated for the individual values of the claim and are accumulated for each beneficiary (patient) score variable by industry type, patient, provider, specialty and geography for all Patients who received a treatment (or supposedly received). An example of this type of aggregation would be all claims filed by a patient in Specialty Type “Orthopedics”, in the state of Georgia for number of office visits in last 12 months 12 (last 30, 60, 90 or 360 days for example) or median distance traveled to see the Provider. The Patient Historical Summary Statistics Module 116 for all industry types, specialties and geographies is then used by the Standardization Module 212 to create normalized variables for the predictive scoring models.

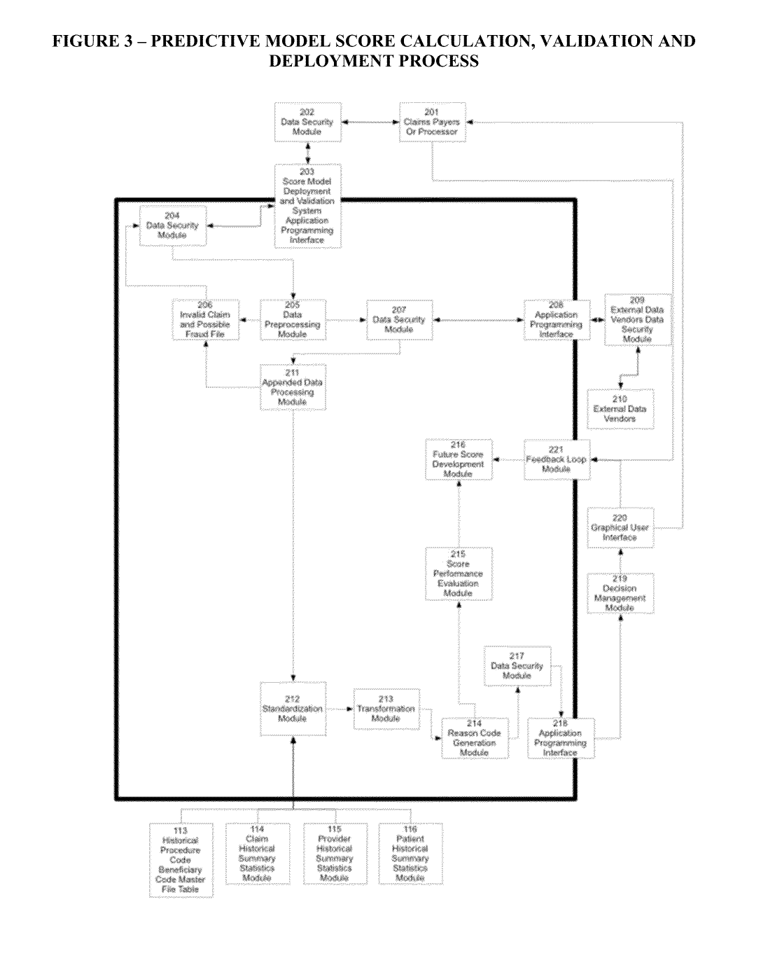

Referring now to FIG. 3 as a perspective view of the technology, data system flow and system architecture of the Predictive Score Calculation, Validation and Deployment Process there is shown a source of current healthcare claim data sent from Healthcare Claim Payers or Claims Processor Module 201 (data can also come from, or pass through, government agencies, such as Medicare, Medicaid and TRICARE, as well as private commercial enterprises such as Private Insurance Companies, Third Party Administrators, Claims Data Processors, Electronic Clearinghouses, Claims Integrity organizations that utilize edits or rules and Electronic Payment entities that process and pay claims to healthcare providers) for scoring the current claim or batch of claims aggregated to the Provider or Patient/Beneficiary level. The claims can be sent in real time individually, as they are received for payment processing, or in batch mode such as at end of day after accumulating all claims received during one business day. Real time is here defined as processing a transaction individually as it is received. Batch mode is here defined as an accumulation of transactions stored in a file and processed all at once, periodically, such as at the end of the business day. Claim payer(s) or processors send the claim data to the Claim Payer/Processor Data Security Module 202 where it is encrypted.

The data is then sent via a secure transmission device to the Predictive Score Model Deployment and Validation System Application Programming Interface Module 203 and then to the Data Security Module 204 within the scoring deployment system for un-encryption. Each individual claim data field is then checked for valid and missing values and is reviewed for duplicate submissions in the Data Preprocessing Module 205. Duplicate and invalid claims are sent to the Invalid Claim and Possible Fraud File 206 for further review or sent back to the claim payer for correction or deletion. The remaining claims are then sent to the Internal Data Security Module 207 and configured into the format specified by the External Application Programming Interface 208 and sent via secure transmission device to External Data Vendor Data Security Module 209 for un-encryption. Supplemental data is appended by External Data Vendors 210 such as Unique Customer Pins/UID's (proprietary universal identification numbers) Social Security Death Master File, Credit Bureau scores and/or data and demographics, Identity Verification Scores and/or Data, Change of Address Files for Providers or Patients/Beneficiaries Previous provider or beneficiary fraud “Negative” (suppression) files, Eligible Patient and Beneficiary Lists and Approved Provider Lists. The claim data is then sent to the External Data Vendors Data Security Module 209 for encryption and on to the External Application Programming Interface 208 for formatting and sent to the Internal Data Security Module 207 for un-encryption. The claims are then sent to the Appended Data Processing Module 211, which separates valid and invalid claims. If the external database information (or link analysis) reveals that the patient or provider is deemed to be inappropriate, such as deceased at the time of the claim or to not be eligible for service or not eligible to be reimbursed for services provided or to be a false identity, the claim is tagged as an inappropriate claim or possible fraud and sent to the Invalid Claim and Possible Fraud File 206 for further review and disposition.

One copy of the individual valid current claim or batch of claims is also sent from the Appended Data Processing Module 211 to Standardization Module 212 in order to create claim level variables for the predictive score models. In order to perform this calculation the Standardization Module 212 requires both the current claim or batch of claims from the Appended Data Processing Module 211 and a copy of each individual valid claim statistic sent from the Historical Procedure Code Diagnosis Code Master File Table in Module 113, Claim Historical Summary Statistics Module 114, Provider Historical Summary Statistics Module 115 and Patient Historical Summary Statistics Module 116.

The Standardization Module 212 converts raw data individual variable information into values required for use in the predictive score models. When using the raw data from the claim, plus the statistics about the claim data from the Historical Claim Summary Descriptive Statistics file modules, the Standardization Module 212 creates input variables for the predictive scoring models. The individual claim variables are matched to historical summary claim behavior patterns to calculate the current individual claim's historical behavior pattern. These individual and summary evaluations are transformations of each variable related to the individual claim.

In order to create normalized variables for the claim predictive score model, one copy of each summarized batch of claims is sent from the Claim Historical Summary Descriptive Statistics file in Module 114 to the Standardization Module 212. The Standardization Module 212 is a claim processing calculation where current, predictive score model summary normalized variables are created by matching the corresponding variable's information from Claim Historical Summary Descriptive Statistics file in Module 114 variable parameters to the current summary behavior pattern to calculate the current individual claim's historical behavior pattern, as compared to a peer group of claims in the current claim's specialty, geography. These individual and summary evaluations are normalized value transformations of each variable related to the individual claim or batch of claims. All of the score variables created in the Standardization Module 212, are then sent to Transformation Module, 213. The purpose of Transformation Module 213 is to transform the raw, normalized value of each variable in the fraud and abuse detection predictive score models into an estimate of the probability that this value likely fraud or abuse. While any supervised or unsupervised modeling approach will work within this agnostic scoring process, it is recommended that unsupervised non-parametric methodology be used to create the individual input variables and scores, due to the weaknesses of most parametric methods and traditional non-parametric methods. See utility patent application Ser. No. 13/074,576 (Rudolph, et al.), filed Mar. 29, 2011 or utility patent application Ser. No. 13/617,085 (Jost, et al.), filed Sep. 14, 2012 for an in depth discussion of modeling weakness of parametric modeling techniques and traditional non-parametric approaches.

In order to create Provider Level variables for the predictive score model, one copy of each summarized batch of claims per Provider is sent from the Historical Provider Summary Descriptive Statistics file in Module 115 to the Standardization Module 212. The Standardization Module 212 is a claim aggregation and processing calculation. Aggregation dimensions for the Provider may resemble the following design, but others may include claims-level, day-of-week and geography:
Provider-Level—To create Provider-Level information, data is aggregated in the following order: Specialty Provider-Level→Geography-Level→Claims-Level→Day-Interval-Level→Provider-Level.

Current, predictive score model summary normalized variables are created by matching the corresponding variable's information from Historical Provider Summary Descriptive Statistics file in Module 115 variable parameters to the current summary behavior pattern to calculate the current individual provider's claims historical behavior pattern, as compared to a peer group of providers in the current claim provider's specialty and geography. These individual and summary evaluations are normalized value transformations of each variable related to the individual claim or batch of claims. All of the score variables created in the Standardization Module 212, are then sent to Transformation Module, 213. The purpose of Transformation Module, 213 is to transform the raw, normalized value of each variable in the fraud and abuse detection predictive score model into an estimate of the probability that this value likely fraud or abuse. While any supervised or unsupervised modeling approach will work within this agnostic scoring process, it is recommended that unsupervised non-parametric methodology be used to create the individual input variables and scores, due to the weaknesses of most parametric methods and traditional non-parametric methods. See utility patent application Ser. No. 13/074,576 (Rudolph, et al.), filed Mar. 29, 2011 or utility patent application Ser. No. 13/617,085 (Jost, et al.), filed Sep. 14, 2012 for an in depth discussion of modeling weakness of parametric modeling techniques and traditional non-parametric approaches.

In order to create Patient Level variables for the predictive score model, one copy of each summarized batch of claims per Patient is sent from the Historical Summary Patient Descriptive Statistics file in Module 116 to the Standardization Module 212. The Standardization Module 212 is a claim aggregation and processing calculation. Aggregation dimensions for the Patient may resemble the following design, but others may include claims-level, day-of-week and geography:
Patient-Level—To create Patient-Level information, data is aggregated in the following order: State/MSA-Level (Geography-Level)→Claims-Level→Day-Interval-Level→Patient-Level.

Current, patient claim summary normalized variables are created by matching the correspond variable's information from Historical Patient Summary Descriptive Statistics file in Module 116 variable parameters to the current claim summary behavior pattern to calculate the current individual patient batch of claim's historical behavior pattern, as compared to a peer group of provider's patients in the current claim provider's specialty and geography. These individual and summary evaluations are normalized value transformations of each variable related to the individual claim or batch of claims. All of the score variables created in the Standardization Module 212, are then sent to Transformation Module, 213. The purpose of Transformation Module 213 is to transform the raw, normalized value of each variable in the fraud and abuse detection predictive score model into an estimate of the probability that this value likely fraud or abuse. While any supervised or unsupervised modeling approach will work within this agnostic scoring process, it is recommended that unsupervised non-parametric methodology be used to create the individual input variables and scores, due to the weaknesses of most parametric methods and traditional non-parametric methods. See utility patent application Ser. No. 13/074,576 (Rudolph, et al.), filed Mar. 29, 2011 or utility patent application Ser. No. 13/617,085 (Jost, et al.), filed Sep. 14, 2012 for an in depth discussion of modeling weakness of parametric modeling techniques and traditional non-parametric approaches.

Each individual fraud and abuse scoring model value and the individual values corresponding to each predictor variable are then sent from the Module 213 to the Score Reason Generator Module 214 to calculate score reasons for why an observation score as it did. The Score Reason Generator Module 214 is used to explain the most important variables that cause the score to be highest for an individual observation. It selects the variable with the highest predictor value and lists that variable as the number 1 reason why the observation scored high. It then selects the variable with the next highest predictor value and lists that variable as the number 2 reason why the observation scored high, and so on.

One copy of the scored observations is sent from the Score Reason Generator Module 214 to the Score Performance Evaluation Module 215. In the Score Performance Module, the scored distributions and individual observations are examined to verify that the model performs as expected. Observations are ranked by score, and individual claims are examined to ensure that the reasons for scoring match the information on the claim, provider or patient. The Score Performance Evaluation Module details how to improve the performance of the fraud detection predictive score model given future experience with scored transactions and actual performance on those transactions with regard to fraud and not fraud. The data is then sent from the Score Performance Evaluation Module 215 to be stored in the Future Score Development Module 216. This module stores the data and the actual claim outcomes, whether it turned out to be a fraud or not a fraud. This information will be used in the future to build future fraud and abuse predictive models to enhance prevention and detection capabilities.

Another copy of the claim is sent from the Score Reason Generator Module 214 to the Data Security Module 217 for encryption. From the Data Security Module 217 the data is sent to the Application Programming Interface Module 218 to be formatted. From the Application Programming Interface Module 218 the data is sent to the Decision Management Module 219. Decision Management Module 219 provides Login Security and Risk Management, which includes Strategy Management, Experimental Design Test and Control, Queue, Contact and Treatment Management Optimization for efficiently interacting with constituents (providers and patients/beneficiaries. It also provides the an experimental design capability to test different treatments or actions randomly on populations within the healthcare value chain to assess the difference between fraud detection models, treatments or actions, as well as provide the ability to measure return on investment. The claims are organized in tables and displayed for review by fraud analysts on the Forensic Graphical User Interface (GUI) in Module 220. Using the GUI, the claim payer fraud analysts determine the appropriate actions to be taken to resolve the potential fraudulent or abusive request for payment. After the final action and when the claim is determined to be fraudulent or not fraudulent, a copy of the claim is sent to the Feedback Loop Module 221. The Feedback Loop Module 221 provides the actual outcome information on the final disposition of the claim, provider or patient as fraud or not fraud, back to the original raw data record. The actual outcome either reinforces the original fraud score probability estimate that the claim was fraud or not fraud or it countermands the original estimate and proves it to have been wrong. In either case, this information is used for future fraud and abuse predictive score model development to enhance future performance of Automated Healthcare Risk Management System. From the Feedback Loop Module 221 the data is stored in the Future Predictive Score Model Development Module 216 for use in future predictive score model developments using model development procedures, which may include supervised, if there is a known outcome for the dependent variable or there exists an appropriate unbiased sample size. Otherwise, part or all of the fraud detection models may be developed utilizing an unsupervised or supervised model development method.

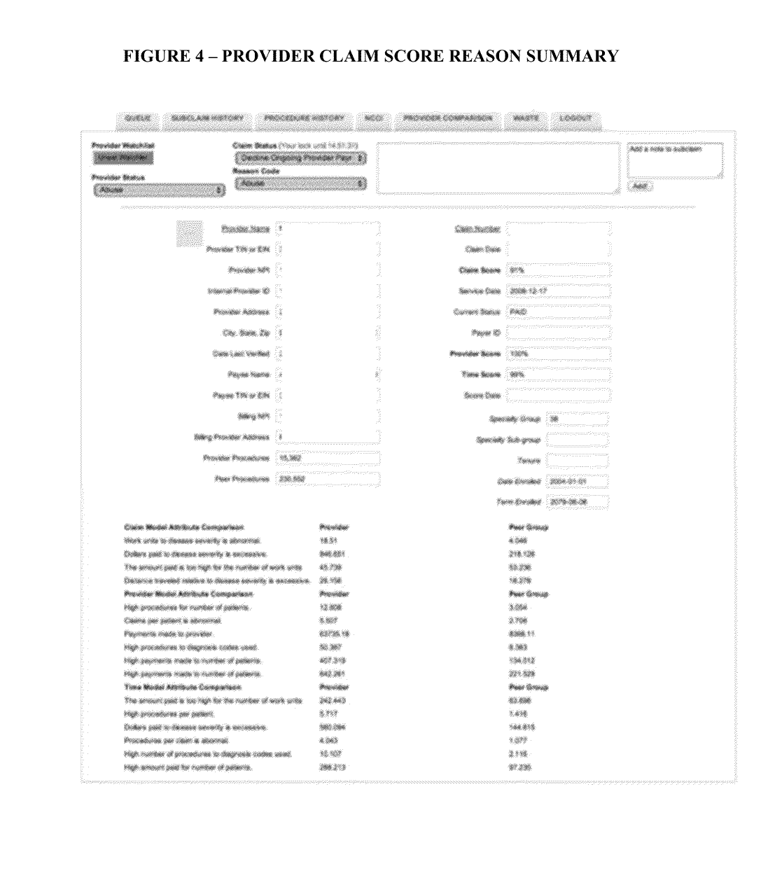

FIG. 4 provides a display on how score results are displayed within the Automated Healthcare Risk Management System. At the bottom of the screen, score reason codes are presented to investigators to guide them in their research when switching to view historical procedures and claims. The measurements for the provider and peer populations are normalized so that the relative multiple of difference (for example Provider numbers are 2 times larger than Peer group), is meaningful.

### Calculate and Deploy Risk Adjusted Provider Cost Index

“Risk adjustment is the process of adjusting payments to organizations, health insurance plans for example, based on differences in their risk characteristics (and subsequent health care costs) of people enrolled in each plan.”^{xxvi} Current risk adjustment methodology relies on demographic, health history, and other factors to adjust payments to plans.^{xxvii} These factors are identified in a base year, and used to adjust payments to plans in the following year. For example, CMS (Centers for Medicare and Medicaid Services), estimates payments based on a prospective payment system, estimating next year's health care expenditures as a function of beneficiary demographic, health, and other factors identifiable in the current year.^{xxviii}

For this invention, the Risk Adjusted Provider Cost Index is derived from risk adjusted groupers using patent diagnosis-based co-morbidity. The Risk Adjusted Provider Cost Index is a score to target and take systematic action on provider waste, over-servicing or over-utilization in concert with the Automated Healthcare Risk Management System's Strategy Manager and Managed Learning Environment. Waste, over-servicing or over-utilization is defined as the administration of a different level of services than the industry-accepted norm for a given condition resulting in greater healthcare spending than had the industry norm been applied.

The risk adjustment process is well known in the healthcare industry and this invention is designed to utilize both internal proprietary or industry/commercial risk groupers, with patent gender, patent age, primary care specialty groups, geography, healthcare segment and fraud and abuse predictive model scores. CMS, for example, created risk adjusters called Hierarchy Category Codes (HCC's) to more accurately pay Medicare Advantage plans.^{xxix}

The Provider Cost Index is created by calculating member month spend (expenditures) of a selected primary care provider, as compared to their cohort group. Member month spend, sometimes referred to as PMPM, is calculated by deriving the average of total healthcare costs for a single member (patient or beneficiary) in a month. PMPM is an indicator for healthcare expenditures that is analyzed by insurance companies to compare costs or premiums across different populations. A primary care physician is defined as the doctor who sees a patient first and provides basic treatment or decides that the patient should see another doctor. An example of a primary care physician specialty is Family Practice. The Provider Cost Index is calculated by dividing primary care member month spend by risk adjusted primary care member month spend. Primary Care specialists with indexes greater than 1.0 have a higher spend than their cohorts for patients with the same co-morbidity or health status. As described earlier, the Provider Cost Index is used within the Automated Healthcare Risk Management System to target providers who have waste, over servicing or over utilization. A high cost provider will be systematically educated to lower their cost, through letters, emails or phone calls. A high cost provider can also be eliminated from a payers (insurance companies) network in order to reduce the cost of the overall network. Spend can be defined in two scenarios: 1) identifying patient costs relating directly to an individual primary care physician's services or 2) calculating total cost for each patient—including other physicians, specialists, hospital and pharmacy spend for example. The same methodology is also transferable for scoring and identifying high cost specialists and healthcare facilities.

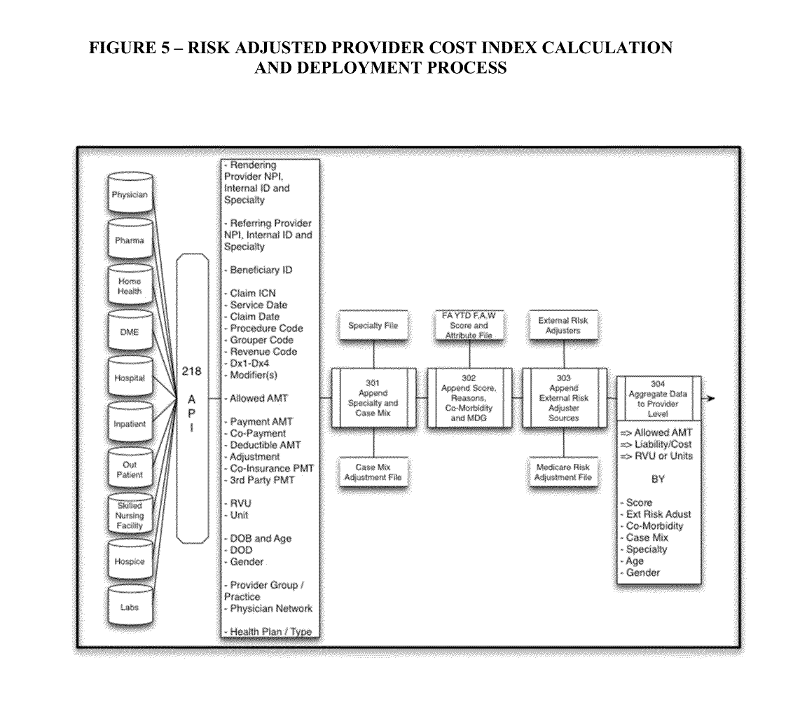

Referring now to FIG. 5, the steps to create the Provider Cost Index to be used within the Automated Healthcare Risk Management System are as follows:
Standardized data is accessed through Application Programming Interface 218. Multiple variables are extracted, and include for example, patient spend, patient age and patient gender to create the case mix risk file. Medical spend resource uses are identified in claims information systems by coding systems. These include CPT Levels I and II, Hospital Revenue Codes, and ICD9/ICD10 Procedure codes. The Provider Cost index typically requires 15 months of history, but can be created with fewer months.
The first step is appending provider specialty codes to the case mix file, as identified in Box 301. This necessary step provides the ability to designate specialty types to identify primary care physicians and their associated cohort group. As described earlier, this approach can also be used to analyze facilities or specialist groups as well.
Box 302 displays the process of appending external information, such as fraud and abuse predictive model scores and reason codes to be used in the analysis. Many times, high cost and fraud and abuse are correlated with other data and scores. In this example, the scores provide another break to overlay for index score creation.
The third step is appending the case mix file, which includes patient spend, demographics and provider specialty group with an internal or external risk grouper file—as outlined in Box 303. Gaining access to risk groupers can take on several forms—in this case we are appending them based upon scoring previous diagnosis history. One can also utilize the risk model to calculate the groupers within the case mix file as well. Models may include category clustering or parametric models for example. The Provider Cost Index is agnostic to the risk classification mathematical scoring methodology. Below is a simple example for Risk Group 33, defined as Diabetes Mellitus/NIDDM. This score is created by clustering a sample of ICD9 Codes into a similar behaving risk group for Diabetes/NDDM.

| ICD9 CODES | DESCRIPTION | SCORE | RISK GROUP |
|---|---|---|---|
| 250 | DIABETES MELLITUS* | 33 | Diabetes Mellitus/NIDDM |
| 250.0 | DIABETES MELLITUS UNCOMP* | 33 | Diabetes Mellitus/NIDDM |
| 250.00 | DMII W/O CMP NT ST UNCNTR | 33 | Diabetes Mellitus/NIDDM |
| 250.02 | DMII W/O CMP UNCNTRLD | 33 | Diabetes Mellitus/NIDDM |
| 250.10 | DMII KETO NT ST UNCNTRLD | 33 | Diabetes Mellitus/NIDDM |
| 250.12 | DMII KETOACD UNCONTROLD | 33 | Diabetes Mellitus/NIDDM |
| 250.20 | DMII HPRSM NT ST UNCNTRL | 33 | Diabetes Mellitus/NIDDM |
| 250.22 | DMII HPROSMLR UNCONTROLD | 33 | Diabetes Mellitus/NIDDM |
| 250.30 | DMII OTH COMA NT ST UNCNTRLD | 33 | Diabetes Mellitus/NIDDM |
| 250.32 | DMII OTH COMA UNCONTROLD | 33 | Diabetes Mellitus/NIDDM |
| 250.40 | DMII RENL NT ST UNCNTRLD | 33 | Diabetes Mellitus/NIDDM |
| 250.42 | DMII RENAL UNCNTRLD | 33 | Diabetes Mellitus/NIDDM |
| 250.50 | DMII OPHTH NT ST UNCNTRL | 33 | Diabetes Mellitus/NIDDM |
| 250.52 | DMII OPHTH UNCNTRLD | 33 | Diabetes Mellitus/NIDDM |
| 250.60 | DMII NEURO NT ST UNCNTRL | 33 | Diabetes Mellitus/NIDDM |
| 250.62 | DMII NEURO UNCNTRLD | 33 | Diabetes Mellitus/NIDDM |
| 250.70 | DMII CIRC NT ST UNCNTRLD | 33 | Diabetes Mellitus/NIDDM |
| 250.72 | DMII CIRC UNCNTRLD | 33 | Diabetes Mellitus/NIDDM |

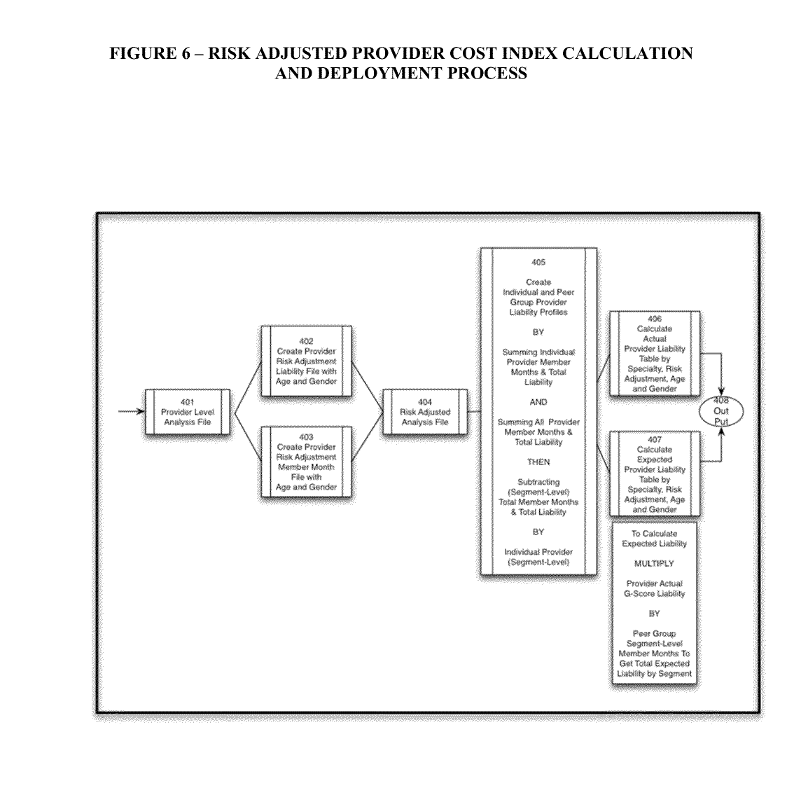

Box 304 defines the aggregation process for creating the final provider-level analysis file identified as Box 401 in FIG. 6.
Box 402 and Box 403 create provider level files segmented at the specialty, risk grouper, fraud and abuse score, age and gender level for overall cost and total member months respectively. The process of combining these two provider level files is defined in Box 404, which creates the inputs to calculate monthly cost for every provider in the population and their affiliated risk adjusted cohort calculations. With the availability of the analysis file in Box 404, the steps to create the Risk Adjusted Provider Cost index can begin.

Following are simple examples on how a Risk Adjusted Provider Cost Index could be scored. For this example, we will use Diabetes/NDDM (Score 33) to calculate the index score. The calculation will take the form of a spreadsheet, but more sophisticated methods can utilize predictive modeling techniques.

The first step is segregating spend and member months for a single provider and his cohort group. The cohort does not include the individual provider in their aggregate sums or calculations in order to not skew results towards an over-performing or under-performing provider. In the example below—we have calculated a PMPM (monthly spend) for an individual primary care provider. We are isolating Females ages 40-64 for this analysis. For this segment, we sum patient spend and divide by total member months (where member months are counted as 1 for each member he sees in a single month). In this example, the PMPM (monthly spend) is calculated to be $147.

Cost/Member Month = PMPM

| Cost | Member Months | PMPM |
|---|---|---|
| $7,414,870 | 50,601 | $147 |

Now we perform the same methodology for all patients this provider has seen. In this example, the primary care physician only treats males and females in age group 40-64. The PMPM varies widely between the individual primary care provider and the cohort group. By breaking on Diabetes Mellitus/NIDDM (patient health), Age and Gender for this analysis, cost is normalized for the cohort group by predictors that may affect spend and outcomes.

Score 33 = Diabetes Mellitus/NIDDM

| | Calculate PMPM Individual Provider | | |
|---|---|---|---|
| Age/Gender | Spend | Member Months | PMPM |
| 40-64F | $7,414,870 | 50,601 | $147 |
| 40-64M | $1,161,915 | 9,137 | $127 |
| Total | $8,576,785 | 59,739 | $144 |

Score 33 = Diabetes Mellitus/NIDDM

| | Calculate PMPM Cohort Group | | |
|---|---|---|---|
| Age/Gender | Spend | Member Months | PMPM |
| 40-64F | $37,523,735 | 476,497 | $79 |
| 40-64M | $32,035,654 | 447,719 | $72 |
| Total | $69,559,389 | 924,215 | $75 |

Next we create the expected provider cost using normalized spend from the cohort group. The cohort group PMPM has been normalized for patient health, age and gender breaks. This estimate is then multiplied by the individual provider's member month to calculate the expected cost.

Score 33 = Diabetes Mellitus/NIDDM

| Inputs for Calculating Expected Cost | | | Calculate Expected Cost | |
|---|---|---|---|---|
| | Cohort | Individual | Expected | Expected |
| Age/Gender | PMPM | Member Months | Cost | PMPM |
| 40-64F | $79 | 50,601 | $3,984,821 | $79 |
| 40-64M | $72 | 9,137 | $653,789 | $72 |
| Totals | $75 | 59,739 | $4,638,610 | $78 |

The final step is calculating the Provider Cost Index and the amount of waste, over-servicing or over-utilization. The index is calculated by dividing the individual primary care PMPM by the Cohort PMPM in the same Diabetes Mellitus/NIDDM group (patient health), Age and Gender group. In this case, the Provider Cost Index is $147 for the individual primary care provider and $79 for the associated cohort group. The index is $147/$79=186 for Females, ages 40-64. The analysis shows this provider is costing significantly more than his cohorts when normalized for health status (Score 33), age and gender. The expected overage is approximately $3.4 million in waste, over-servicing or over-utilization.

Score 33 = Diabetes Mellitus/NIDDM

| Inputs for Calculating Waste Amount | | | Calculate Provider Cost Index | |
|---|---|---|---|---|
| | Actual | Expected | | Provider |
| Age/Gender | Cost | Cost | Waste | Cost Index |
| 40-64F | $7,414,870 | $3,984,821 | $3,430,048 | 186 |
| 40-64M | $1,161,915 | $653,789 | $508,126 | 178 |
| Totals | $8,576,785 | $4,638,610 | $3,938,174 | 191 |

For this example, we made the assumption there was only one health category Diabetes Mellitus/NIDDM (Score=33). In reality, it is not uncommon to have 70 or more different categories. The same methodology applies as outlined above, but with many more cells to identify and target for cost savings. Specifically, the individual categories will each have Provider Cost Indexes assigned to them that can be targeted individually by the Automated Healthcare Risk Management System in real-time.

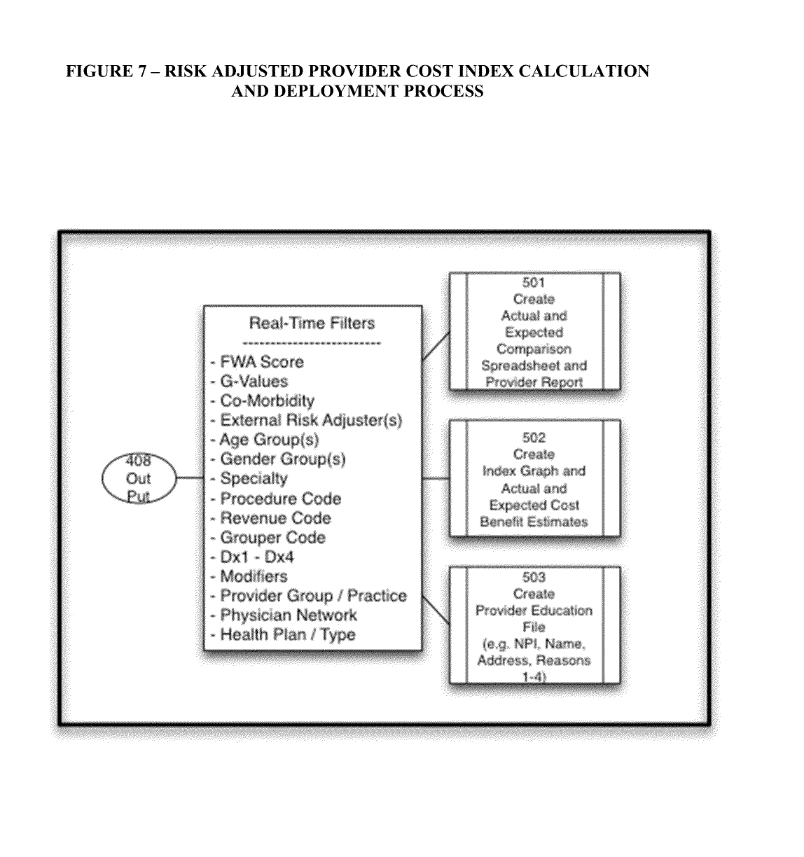

There is significant savings opportunity if this provider can be educated, reduce their costs and bring them more in line with their cohorts. FIG. 7 shows additional breaks that may be used to normalize or filter the Provider Cost Index.

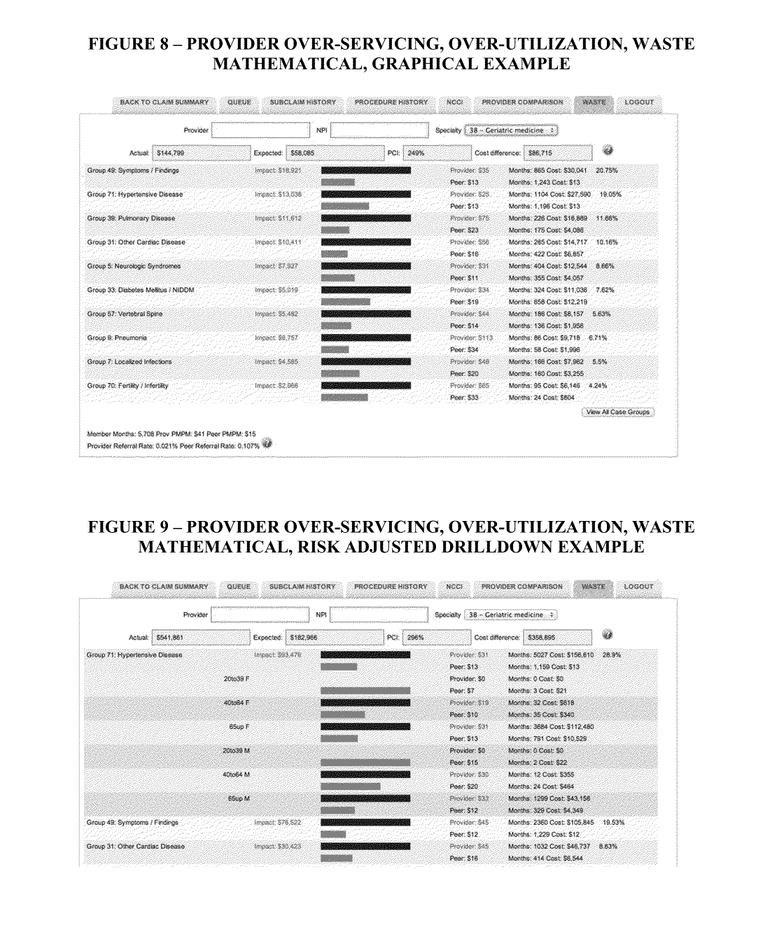

FIG. 8 displays how the Provider Cost Index (PCI) is displayed systematically within the Automated Healthcare Risk Management System. Not only is the overall savings identified, it is segmented by risk group because not all groups will have higher costs. FIG. 9 displays point and click drill down to display the costs within each category, for example displaying Score 71—Hypertensive Disease and associated age and gender cost dynamics. In this example there is also a proprietary specialty filter box displaying specialty 38-Geriatric Medicine. In certain cases a provider may practice under two or more specialties—for example Geriatric Medicine and Family Practice. The Automated Healthcare Risk Management System has the flexibility to isolate sub-specialties, using the specialty filter, within the provider cost index, such as Family Practice, otherwise the Provider Cost Index may be understated or overstated.

### Edit Analytics

Healthcare edits are predefined decision logic or tables that screen claims prior to payment for compliance errors, medically unlikely services scenarios and for known claim payment scams. While the Edits are ineffective for optimally identifying fraud and abuse and fail to identify new and emerging risk trends, they do have a role in thwarting overpayments for healthcare.

CMS has created and published two types of edits, NCCI (National Correct Coding Initiative) and MUE (Medically Unlikely Edits), which together save billions of dollars per year. CMS implemented the National Correct Coding Initiative in 1996. This initiative was developed to promote correct coding of health care services by providers for Medicare beneficiaries and to prevent Medicare payment for improperly coded services. NCCI consists of automated edits provided to Medicare contractors to evaluate claim submissions when a provider bills more than one service for the same Medicare beneficiary on the same date of service. NCCI identifies pairs of services that under Medicare coding/payment policy a physician ordinarily should not bill for the same patient on the same day. Additionally, NCCI edits can be applied to the hospital outpatient prospective payment system (OPPS). NCCI edits can identify code pairs that CMS determined should not be billed together because one service inherently includes the other (bundled services). NCCI edits also identify code pairs that Medicare has determined, for clinical reasons, are unlikely to be performed on the same patient on the same day.^{xxx} CMS developed Medically Unlikely Edits (MUE's) to reduce the paid claims error rate for Part B claims. An MUE for a HCPCS/CPT code is the maximum units of service that a provider would report under most circumstances for a single beneficiary on a single date of service.^{xxxi} Both NCCI and MUE edits are available to the public domain for use.

Healthcare intermediaries, known as rules and edit organizations, have created business models marketing NCCI and MUE edits to Medicaid and Commercial Insurance companies. Some of these companies also hard-code a client's proprietary compliance or improper payment edits into their solution to identify incremental opportunities. Competition in the market place for these entities is based upon who has the lowest price. Typically organizations looking for rules and edit capabilities are responding to RFP's based upon who can offer the lowest price. Most rules and edit companies are now searching for methods for differentiation.

The Automated Healthcare Risk Management System has purposely incorporated predictive models and analytical technology to target the individual cost dynamics of fraud, abuse, waste, over-servicing, over-utilization and errors:
Edit Analytics has an independent purpose of identifying payment errors
Predictive Models are focused on identifying fraud and abuse
Provider Cost Index identifies waste, over-servicing and over-utilization

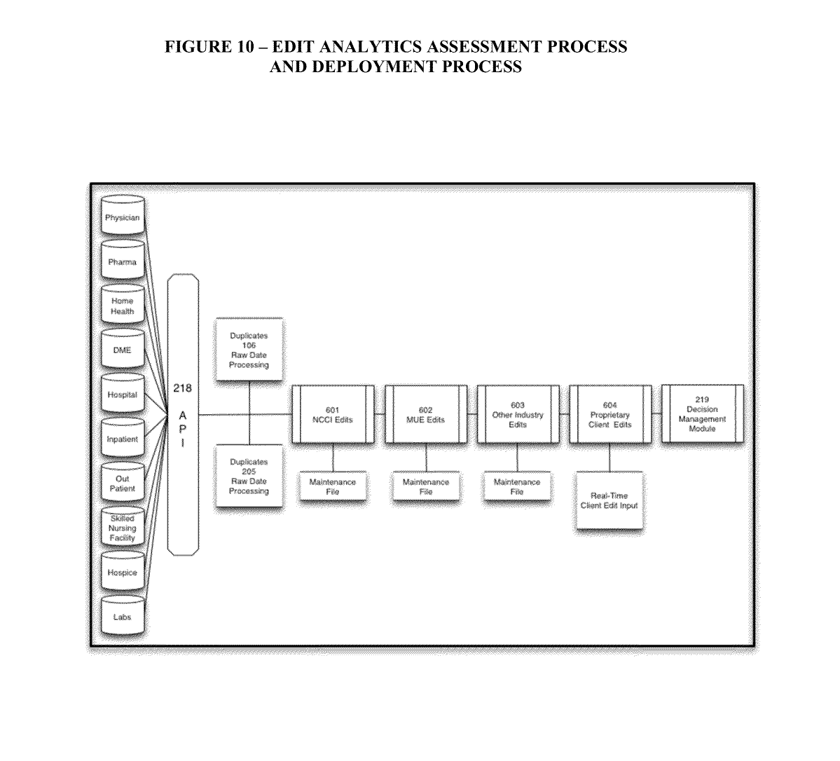

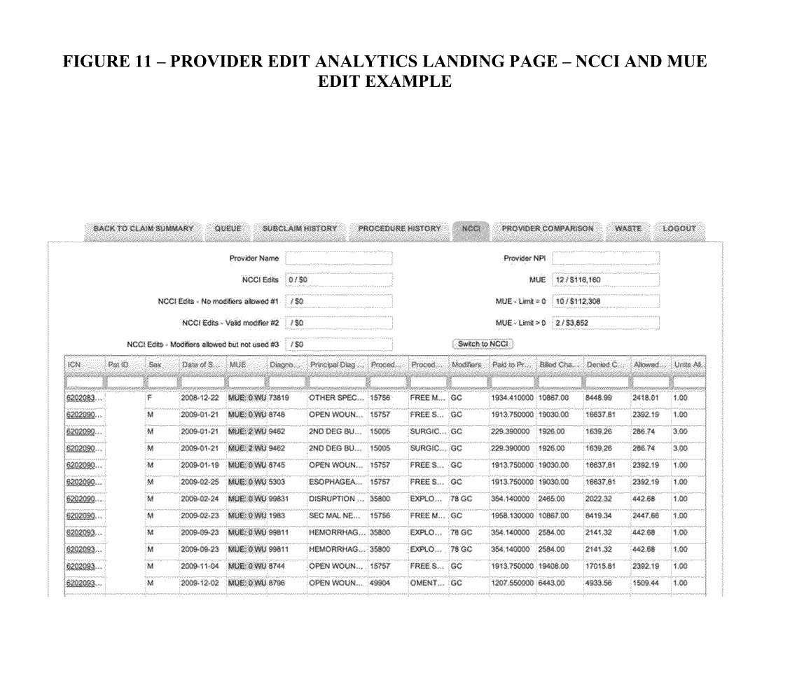

This invention has created Edit Analytics Capabilities within the Automated Healthcare Risk Management System. FIG. 10 provides an overview of the Edit Analytics assessment process through A Software as a Service design. It incorporates NCCI (Box 601), MUE (Box 602) and other industry standard edits (Box 603) in a table design in order to quickly and efficiently make maintenance changes with minimal execution defects. The design also includes the ability to include proprietary client edits. The architecture provides for real-time changes to react to emerging client policy changes (Box 604). Edit Analytics are processed subsequent to predictive analytics and all edit failures “queue” to a “landing page” with the ability to switch between edit types—for example NCCI and MUE edit failures. FIG. 11 provides an example of the Edit Analytics “landing page” that an investigator enters to view and work individual claims identified as improper payments.

### Strategy Manager

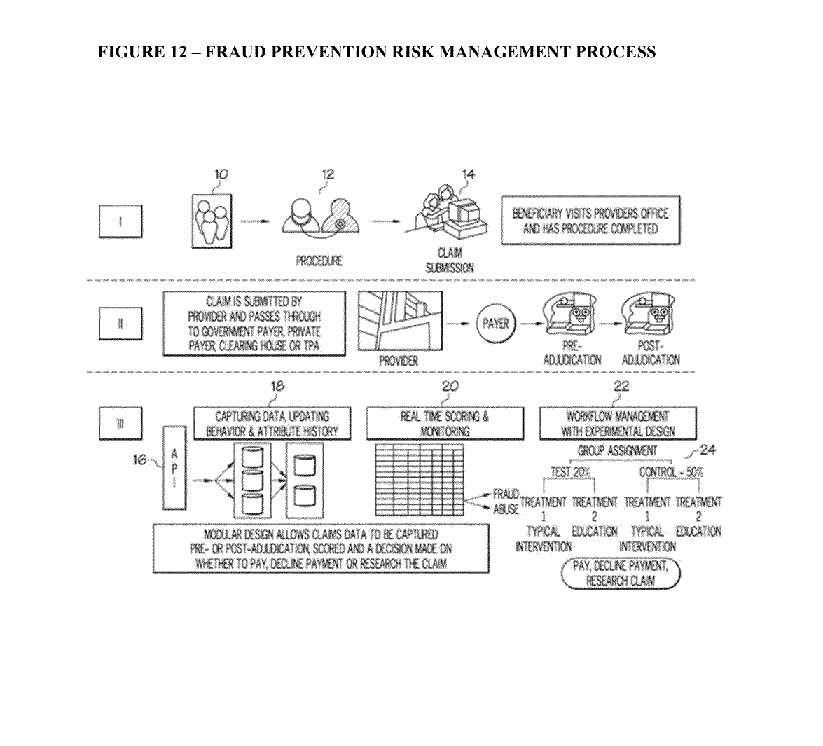

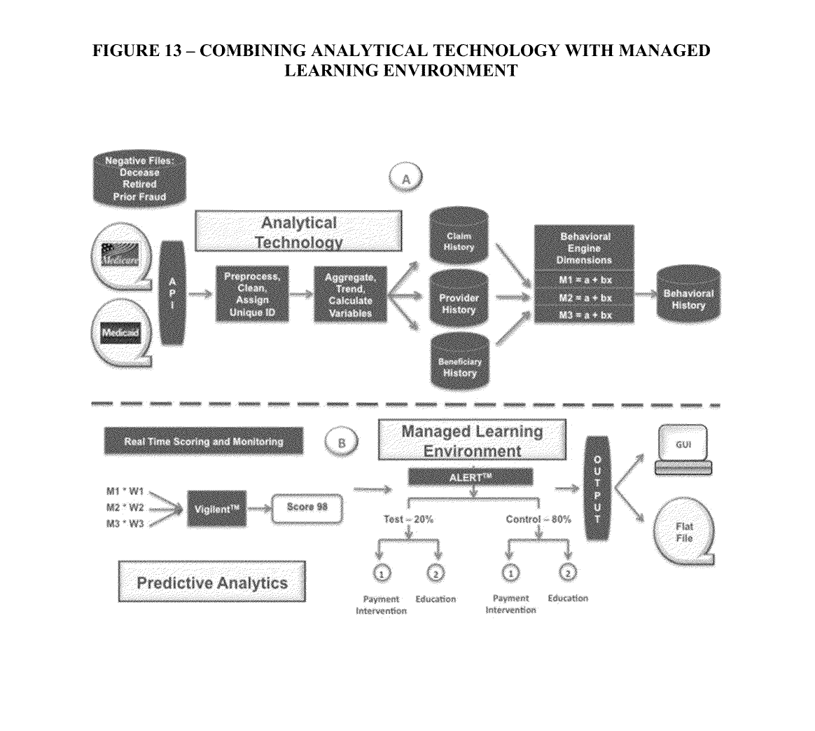

FIG. 12 outlines the overall risk management process design. The patient or beneficiary 10 visits the provider's office and has a procedure 12 performed, and a claim is submitted at 14. The claim is submitted by the provider and passes through to the Government Payer, Private Payer, Clearing House or TPA, as is well known in this industry. Using an Application Programming Interface (API) 16, the claim data is captured at 18. The claim data is captured either before or after the claim is adjudicated. Real time scoring and monitoring is performed on the claim data at 20. The Risk Management design with Workflow Management 22 includes Strategy Management, a Managed Learning Environment, Contact Management, Forensic GUI, Case Management and a dynamic Reporting System. Principles of experimental design methodology provide the ability to create empirical test and control strategies for comparing test and control models, data, criteria, actions and treatments. Claims are sorted and ranked within Strategy Management Decision Strategies based upon empirically derived criteria, such as predictive model score, Provider Cost Index, Edit Analytic Failures, specialty, claim dollar amount, illness burden, geography, etc. The information, along with the claim, is then displayed systematically so an investigations analyst can research and take action. Monitoring the performance of each strategy treatment allows customers to optimize each of their strategies to prevent fraud, abuse, waste, over-servicing, over-utilization or errors, as well as adjust to new types and techniques of perpetrators. It provides the capability to cost-effectively identify, queue and present only the highest-risk and highest value claims to investigators to research. The high risk transactions are then studied at 22 and a decision made at 24 on whether to pay, decline payment or research the claim further. Transactions deemed as fraud or abuse have cases opened within Case Management and are tracked until resolution or hand-off to law enforcement. FIG. 13 also provides a summary of the process outlined in FIG. 12.

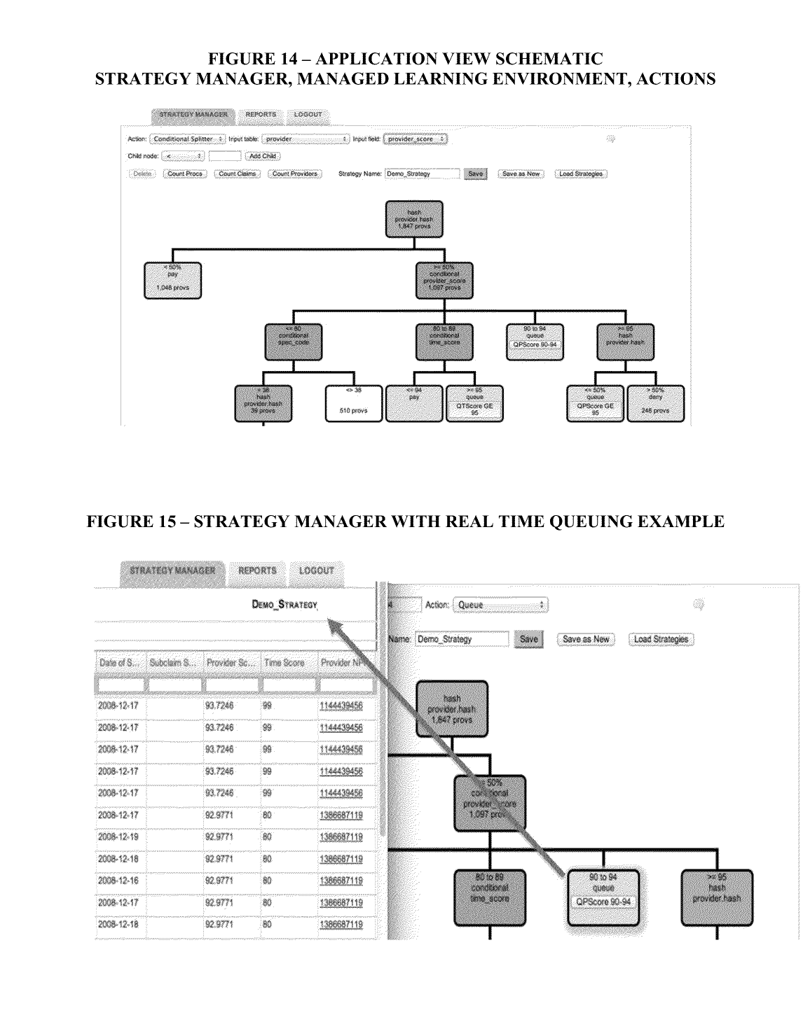

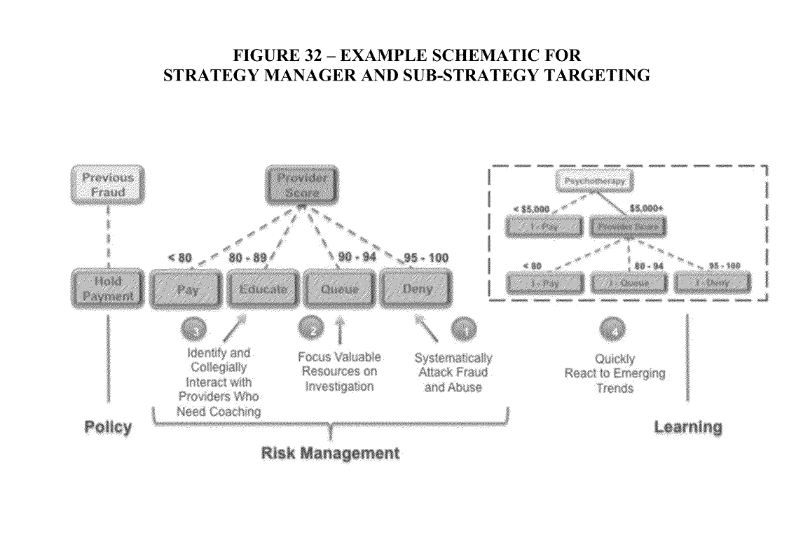

FIG. 14 describes the Strategy Manager capabilities of the Automated Healthcare Risk Management System. It is comprised of real-time capabilities for targeting, triggering and taking action on high-risk claims, providers, healthcare merchants, beneficiaries that exceed pre-determined criteria thresholds. The Strategy Manager creates strategies to identify high-risk, high value payments and queue through Workflow to investigators (circle #2). FIG. 15 demonstrates the real-time queuing of the demo strategy that investigators can enter and work high-risk cases to resolution. The diagram shown in FIG. 32demonstrates how multiple actions are available systematically: educate, queue or decline payments in real-time prior to payment.

The Strategy Manager Design allows:
Trigger thresholds or sub-strategies to target populations differently.
Queuing methodology to tailor workload (claims or providers sent) to existing FTE and return requirements.
Change management—ability to react in real-time to changing patterns for fraud or abuse—in the example below, being more aggressive on Psychotherapy providers.

The Strategy Manager can incorporate any score or data field into the decision strategy and take action. In this case Predictive Models for identifying fraud and abuse, the Provider Cost Index to identify waste, over-servicing and over-utilization, and finally Edit Analytics failures. Multiple levels can be queued real-time, including claim-level, provider-level, beneficiary-level or healthcare merchant-level. Strategies can be subset by industry or segment type.

Referring back to FIG. 14, the Top of the screen identifies the drop down boxes required for creating a strategy. Decision boxes are color-coded:
Blue represents random digits—for testing or reducing queue volume
Green represents conditional criteria—score cutoffs for example
Yellow represents actions or treatments—pay, deny, queue, educate for example

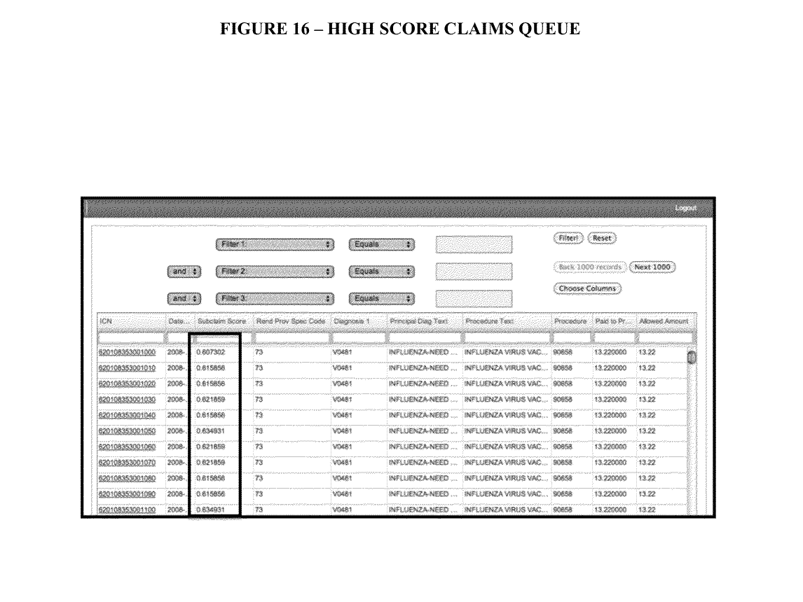

Note that the yellow box with queue referenced in text is real time and can immediately create a queue for an investigator to work in real time with just a click of a mouse. FIG. 16 is an example of a queue that an investigator will log into and start their workday. The strategy is also build for “drag and drop” editing capabilities. “Boxes” can be moved to any position in the strategy.

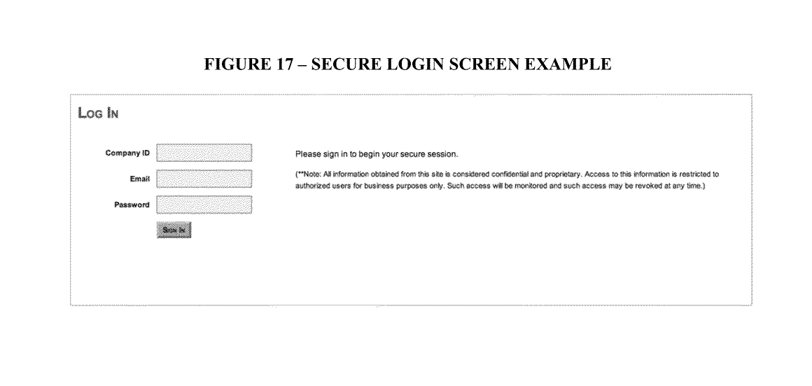

The login, shown in FIG. 17, provides the ability to segment investigator access by customer, market and security need (PHI versus No PHI for example). Output from the Strategy Manager is fed into a GUI workstation as identified in FIG. 3, Box Module 22. GUI infrastructure allows for online Queue Management and “working” of claims (transactions) through an Enterprise Service Bus (ESB) incorporating Service Oriented Architecture (SOA) principles. Output can also be fed via a file (ASP or physical File) to a key decision maker for them to work claims independently of the Fortel Analytics Workflow Management module.

Over the next several sections, component detail of the Strategy Manager and Workflow design will be discussed in detail.

### Decision Strategy Inventory

Decision Strategies “fire” real-time when predefined thresholds or events occur. A real-time action, treatment or status is initiated (in any combination) when the Decision Strategy “fires”. Decision Strategies are empirically derived and utilized to efficiently and effectively evaluate claims, providers, healthcare merchants and beneficiaries for fraud and abuse. Targeted segmentation, utilizing internal or external predictive models and internal and external attributes, combined with optimized treatments in a Managed Learning Environment provide the ability to systematically and automatically evaluate hundreds of millions of claims in a short period of time and identify only the small amount that are potential fraud, abuse, over-servicing, over-utilization, waste or error cost dynamics associated with improper payments.

Strategy Inventory is a database and screen which contains a plurality of empirical strategy management information that will be organized in a table format, similar to the one below:
Company (ABC Company)
Market (Medicare)
Segment (Part A/Hospital)
Strategy Number (PA—123)
Strategy Name (Part A Provider Fraud Challenger)
Strategy Description (Challenger Strategy with new Phantom Provider Model)
Random Digit (Random Digit 1, Range 0-19)
Creation Date (2010 04 31)
Date of Last Change (2010 05 31)
Production Date (2010 05 31)
Status (Production, Inactive, Retired)
Date of Inactivity or Retirement Date (2011 01 04)
User ID of Creator
User ID of Last Change
Screen will have ability to click a Strategy Number to import into an edit screen
Each line of the inventory provides a list of Treatment Numbers and Action Numbers within each Decision Strategy for easy of auditing

### Treatment and Action Inventory

A treatment is optimized within an empirical Decision Strategy. Treatment examples for a provider, healthcare merchant or beneficiary include, but are not limited to, Calling, Emailing, Sending a Letter, Creating a Status for fraud or abuse or Refer to Third Party. Systematically, this provides an efficient and effective method to interact or communicate with a provider or beneficiary to educate and change potentially abusive or wasteful behavior. An action can be optimized within an empirical Decision Strategy by claims, providers, healthcare merchants or beneficiaries identified and presented to the queue—see FIG. 16. Actions for a provider may include, but are not limited to, Pay Claim, Pend Claim Payment, Pend Claim Payment—Research, Pend Claim Payment—Order Medical Records, Decline Claim Payment, Decline all Provider Payments, Assign Provider to a Watch list. Actions are customizable to the client.

Treatment and Action Inventory is a database and screen that will contain a plurality of empirical strategy treatments and actions that will be organized in a table format, similar to the one below:
Treatment:
   Treatment Number (T—123)
   Treatment Name (Provider Status)
   Treatment Description (Provider Status as Abuse)
   Creation Date (2010 05 31)
   Date of Last Change (2010 05 31)
   Production Date of Last Change (2010 05 31)
   Retirement Date or Date of Inactivity (2011 01 04)
   Status (Production, Inactive, Retired)
   User ID of Creator
   User ID of Last Change
   Screen will have ability to click a Treatment Number to move to an edit screen
Action:
   Action Number (A—123)
   Action Name (Provider Payment Decline)
   Treatment Description (Decline Ongoing Provider Payments)
   Creation Date (2010 05 31)
   Date of Last Change (2010 05 31)
   Production Date of Last Change (2010 05 31)
   Retirement Date or Date of Inactivity (2011 01 04)
   Status (Production, Inactive, Retired)
   User ID of Creator
   User ID of Last Change
   Screen will have ability to click an Action Number to move to an edit screen

### New Decision Strategy Creation

The Decision Strategy Creation capability is available to create new Optimized Decision Strategies:
Functionality:
   Point and Click
   Unlimited rows in each empirical Decision Strategy
   Color-coded differentiation between criteria, actions, treatments and random digits within Decision Strategies
   Copy and Edit Capabilities from existing Decision Strategy to create new Strategy
   Decision Strategy Segmentation:
      Attribute Catalog—Access to Attribute Catalog for defining each branch—drop down by category (Attribute, Score, Alert, Tag) for each data base source or link
      Filtering—a key application for filtering will be to hold out records that a user doesn't want to run through a strategy, for example, providers that have been previously reviewed but are unique, score high and are not fraud, abuse, over-servicing, over-utilization, waste or error
      “Date Since”—will be important for the strategy when referencing Filters
      Easy point and click “Pruning”
   Access to Treatment Inventory—drop down boxes
   Access to Action (and Status) Inventory—drop down boxes
   Multiple actions or treatments within the same Decision Strategy—for example multiple queues created from one strategy and assigned to differing levels of skilled investigators
   Point and Click Population Counts, or edit counts, based upon Random samples of a population and applied at the node level
   Dimension Capabilities,
      Incorporate a plurality of predictive models scores and external and internal attributes
      A plurality of dimensions such as claim level, provider level, healthcare merchant level, beneficiary level, geography level, specialty group level or other
      All Dimensions are accessible from database tables within the same decision strategy
      Multiple dimension actions within the same Decision Strategy—for example, decline a procedure, allow a claim payment or queue a provider, healthcare merchant or beneficiary for review
   Draft, Save, and Save Final Capabilities
   Real-time changes to react to changes in fraud trends:
      Drag and drop movement of criteria, actions or treatments within Decision Strategies
      Introduction of new criteria, actions or treatments, for example
   Refresh (reclass) timing flexibility to reflect urgency of changes:
      Real-Time refresh or reclass to immediately push all records, here concerning and data, scores or transactions for claims, providers, healthcare merchants or beneficiaries, through models and/or strategies
      Force re-class within 1 hour—to “push” all records through models and strategies within
      Overnight re-class
      Scheduled re-class
Define Company (ABC Company)
Define Market (Medicare)
Define Segment (Part B/Physician)
Define Decision Strategy Number (PB—123)
Define Decision Strategy Name (Part B Provider Fraud Challenger)
Define Decision Strategy Description—(Challenger Strategy with new Phantom Provider Model)
Set Random Digit and Range (Random Digit 1, Range 0-19)
Default—Creation Date (2010 04 31)
Default—Date of Last Change (2010 05 31)
Default—Status (Draft)
User ID of Creator
User ID of Last Change

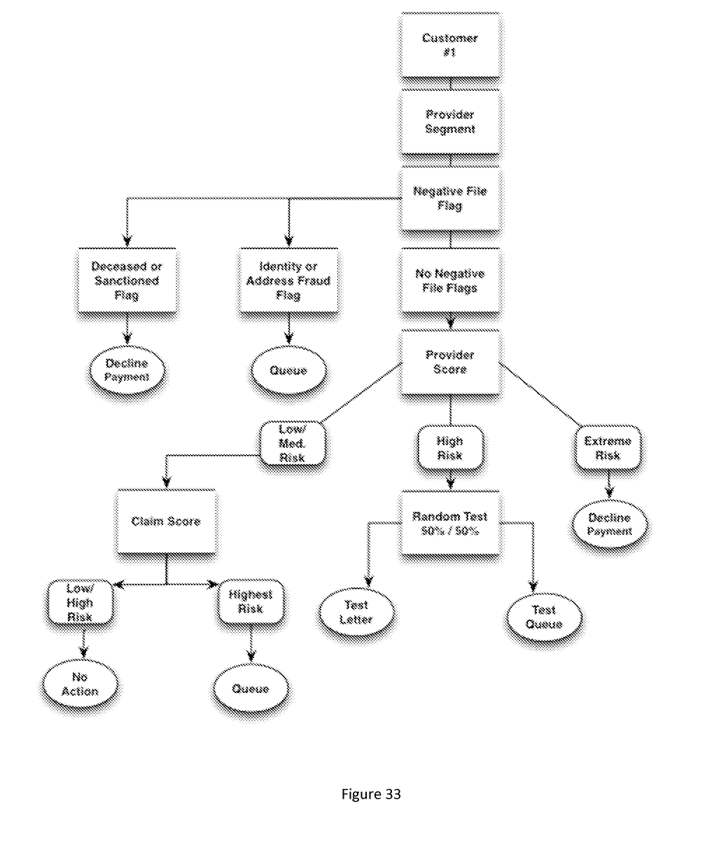

FIG. 33 shows a simple example of an Optimized Decision Strategy.

### Risk Management Design—Decision Strategy Functionality

The Risk Management design will have the following functionality:
Estimator capabilities for running historical records through new Empirical Decision Strategies.
Ability to make real-time changes to react to changes in fraud trends and have a force re-class within 1 hour to repopulate score queues.
Ability to refresh a plurality of random digits separately, holistically or in any combination. Examples of Random Digits include, but are not limited to:
   Provider or Healthcare Merchant:
      Random Digit 1
      Random Digit 2
   Beneficiary:
      Random Digit 3
      Random Digit 4
   Claim:
      Random Digit 5
      Random Digit 6
   Treatment or Action:
      Random Digit 7
      Random Digit 8
      Random Digit 9
Output Reason Codes:
   Model—level:
      Predictive Provider or Healthcare Merchant Model, Predictive Provider Time-Interval Model, Predictive Provider Claim Model
      Predictive Beneficiary Model, Predictive Beneficiary Claim Model
   Node—Level (e.g. Combination of Predictive Provider Score and Attributes)
   Attribute Level (e.g. Deceased Indicator)
Real-time Feedback Loop to database:
   Any outcome or status received from Risk Management Forensic GUI will populate datacenter database in real-time fashion.
   Available to populate other possible claims in queue (e.g. Provider gets statused as Fraud, therefore all of his submitted claims get statused systematically and are not paid).
   Available to populate on-demand reporting to monitor and react to changing patterns for fraud and abuse.
Decision Strategy or Decision Strategy Historical Files:
   Capture attributes at time of execution of empirical Decision Strategy or Decision Strategy
   Retain Treatment Codes for analysis
   Retain Action Codes for analysis
   Retain Status Codes for analysis
   Retain Alert Codes (e.g. Watch list) for analysis
   Utilize for reporting and empirical model validation or Decision Strategy validation.
   Output files to development database.
   Download capabilities to import into spreadsheets (e.g. download and import CSV file).

### Reporting

Predictive Model and Decision Strategy Champion and Challenger validations and tracking
Statistical tests—for example Chi Square and Type 1/Type 2 tests within reporting
Other examples include:
   Daily Queue Reporting
   Queue Aging Report
   Queued, Worked, Statused/Resolved
   Payment Pended Report
   Status by Score and Dimension and Specialty Group
   Model Validation
   Strategy Validation
   Estimators
   Comparative Billing Report
   Productivity Reports—Per Investigative Reviewer and Overall
   Medical and Case Review
   Formal Case Review

### New Treatment and Action Creation

A screen will be available to create new Treatments and Actions to utilize within the Optimized Decision Strategies:
Treatment:
   Functionality:
      Point and click creation
      Copy and Edit capabilities from existing treatment to create or modify
   Create Treatment Number (T—123)
   Create Treatment Name (Provider Education Communication—Letter Low)
   Create Treatment Description—(Provider Letter 123—Low Tone)
   Default—Creation Date (2010 04 31)
   Default—Date of Last Change (2010 05 31)
   Default—Status (Draft)
   User ID of Creator
   User ID of Last Change
Action:
   Functionality:
      Point and click creation
      Copy and Edit capabilities from existing action to create or modify
   Create Action Number (A—123)
   Create Treatment Name (Decline Payment)
   Create Treatment Description—(Decline Provider Claim Payment)
   Default—Creation Date (2010 04 31)
   Default—Date of Last Change (2010 05 31)
   Default—Status (Draft)
   User ID of Creator
   User ID of Last Change

### Attribute Inventory

An attribute in this context is any data element or variable, which can be utilized within any predictive model, empirical model or Decision Strategy. They can be numeric, dichotomous, categorical or continuous. They can also be an “alpha” characteristic containing any quantity and combination of numbers or letters. The Attribute Inventory Screen will be a working library that captures and documents a plurality of inputs available to create or modify Empirical Optimized Decision Strategies and Decision Strategies. A plurality of multidimensional predictive model scores and external and internal Attributes will be grouped into categories based upon their type. Attribute Categories include, but are not limited to:
Strategy Filters—
   Tags/attributes added at the top of strategies to filter claims, providers or providers that shouldn't run through the strategy and flow through the Risk Management Queue or Forensic GUI.
   Dates associated with specific tag/attribute types to manage and ensure that claims, providers or beneficiaries are not held out indefinitely.
Raw Attributes—received as inputs
Derived Attributes—for example, a created interaction attribute, such as miles traveled to Provider combined with illness burden
Risk Scores:
   Dimensions such as Provider, Healthcare Merchant, Time Interval, Beneficiary and Claim
   Sub-Scores such as model attribute input Scores
External Data—data or negative files that contain information such as deceased, sanctioned, retired, previous fraud
External Scores—examples include credit bureau, third party identity scores
Alerts—internal or external flags such as Provider or Beneficiary Watch list
Strategy Attributes:
   Random digit by dimension (e.g. Provider Random digit 1 & Random Digit 2)
   Strategy Number
   Status Reason
   Action
   Treatment

The attribute inventory information may be organized in a table format similar to the one that follows and is displayed in a drop-down box for creation of decision strategies.

| | | | Format | Range or |
|---|---|---|---|---|
| Attribute | Attribute | | (Character | Character |
| Category | Name | Definition | or Numeric) | Example |
| Raw Attribute | RVU | Resource | Numeric | 0 to 20 |
| Category | | Value Unit | 2.0 | |
| | Attribute 1 | | | |
| | . | | | |
| | . | | | |
| | . | | | |
| | Attribute n | | | |
| Score Category | Provider Model | Provider | Numeric | 0 to 100 |
| | | Fraud Model | 3.0 | |
| | Attribute 1 | | | |
| | Attribute n | | | |

### New Attribute Creation

Functionality will exist to create new custom attributes using the attributes that exist within the Attribute Inventory. Requirements will include:
Newly derived attributes will be moved over into the Attribute Inventory upon authorization by an approved authorizer—they will then be available to new Decision Strategies and Decision Strategies.
Newly derived attributes will be available to Fraud Risk Management Strategies in both real-time and batch. Real time access, to react immediately to sudden changes in fraud and abuse, will only be available to Decision Strategies and Decision Strategies upon authorization by the administrator.
Derived attributes can be deleted with dual authorization. They will deleted only after a system backup as not to lose history.

Attribute creation or refinement will use a plurality of transformations or functions, such as the following function examples:
New Attribute Y=X+Y
New Attribute Y=X−Y
New Attribute Y=X*Y
New Attribute Y=X/Y
New Attribute Y=X̂Y
Grouping/collapsing capabilities:
   Numeric→If X<n then Y=1, else Y=0
   Character 4 If X EQ (“a”, “b”, “c”) then Y=“A”, else Y=“B”

### Managed Learning Environment

The Automated Healthcare Risk Management System also provides an Experimental Design capability that provides investigators the ability to test different treatments or actions randomly on populations within the healthcare value chain to assess their difference between treatments (pay, decline or queue for example) or actions (Send A Letter, Call, Email, Output a File for example), as well as measure the incremental return on investment.

The Managed Learning Environment provides for segmenting populations for organizing test/control actions and treatments to measure and maximize return. In order to achieve results that maximize return on investment from capital dollars invested, measuring performance must be in place. However, this is not always the case in healthcare. Neither CMS nor members of the Senate can get an accurate gage on how programs are performing separately or collectively. An example of this issue was highlighted in a hearing on Jul. 12, 2011, where Senator Brown (R-MA) inquired whether $150 million in expenditures for program integrity systems had been good investments—when no outcome performance metrics had been established to measure their actual benefit.^{xxxii}

The ability to tier investigator FTE (Full Time Equivalent) skill set, actions or treatments across different segments, score ranges or specialty groups and measure results is also key. Using a lower paid or lower skilled investigator FTE on easier cases and achieving the same results increases return on investment for the overall business. Shifting the more experienced investigator FTE to more complex cases provides a higher likelihood of success, than would have occurred with a lower skilled investigator. The only way to prove the incremental benefit from salary savings and increased investigation results is through a test and control design. For example:
Split the investigation queue to be worked into two equal groups of 50% with the Managed Learning Environment Random Selection—here defined as Group A and Group B
Have less experienced investigators “work” Group A
Have more experienced investigators “work” Group B
Calculate return, here defined as savings minus costs, of Group A and Group B after a predetermined test period expires
Compare results and pick the winner. Then establish the winner as the new control position

The Managed Learning Environment also provides for real-time claim, procedure or provider counts within the Strategy Manager. The top of FIG. 14 displays the point and click functionality that will populate each strategy box with counts upon request of the investigator. This functionality is important for staffing or determining the appropriate count for the experimental design test.

Program Risk Management oversight is also a critical discipline to ensure claims, providers or beneficiaries correctly traverse models, strategies, actions, treatments and workflows correctly. A very important step to this process is to identify areas of risk. Areas of risk include adverse impacts to program or providers and model and strategy performance. Below are requirements for the development/implementation of new segmentation strategies and scoring models that drive strategy and workflow management.
Adverse impacts to Program or Providers—This is addressed by developing the models or strategies on a robust, recent sample, coupled with a true out-of sample validation.
Validation—All new and existing models and strategies must be validated on a scheduled basis to ensure they are still effective and not deteriorating.

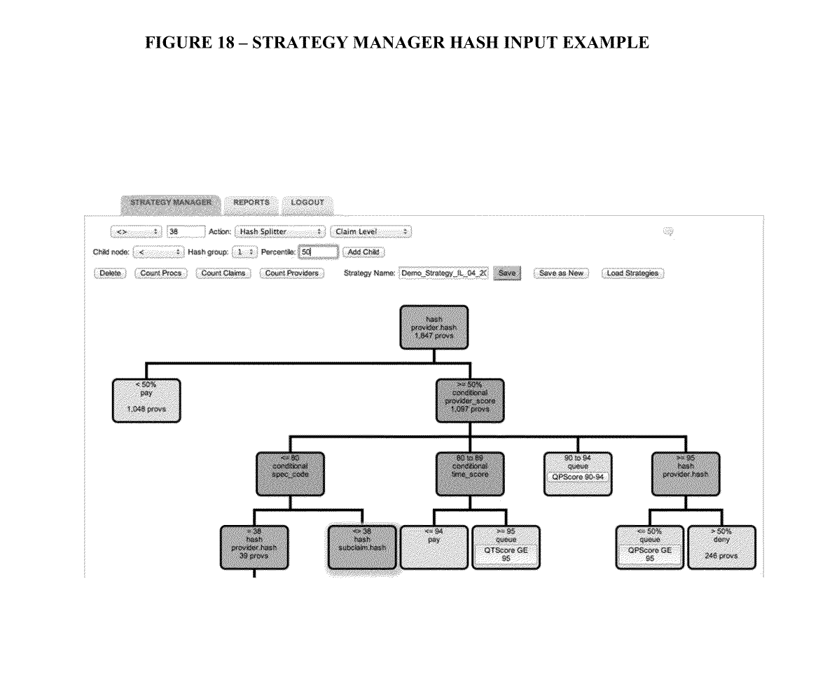

Program Management, using the Managed Learning Environment, ensures there will never be more than the appropriate percent of a segment in a test mode for a market—30% for example. Sample size is set using random digits through the “Hash” function. Referring to FIG. 18, the top of the screen identifies the drop down boxes required for creating a strategy. The Blue cells in the strategy represents random digits (Hash) criteria for testing or reducing queue volume for staffing.

A claim or provider group will be considered truly a part of the test if and only if the action taken within the test differs from the action that would have been taken through the “champion” or control strategy. In other words, only ‘swap-in’ and ‘swap-out’ claims/providers count toward the maximum—30% in this example. The Managed Learning Environment Capabilities also address small sample issues. For example, smaller strategy segments covering a smaller portion of the portfolio may require a larger percentage in test mode to maintain a valid test size. Further sample size may also be needed if strategy node or segment level evaluations are needed for the strategy being tested.

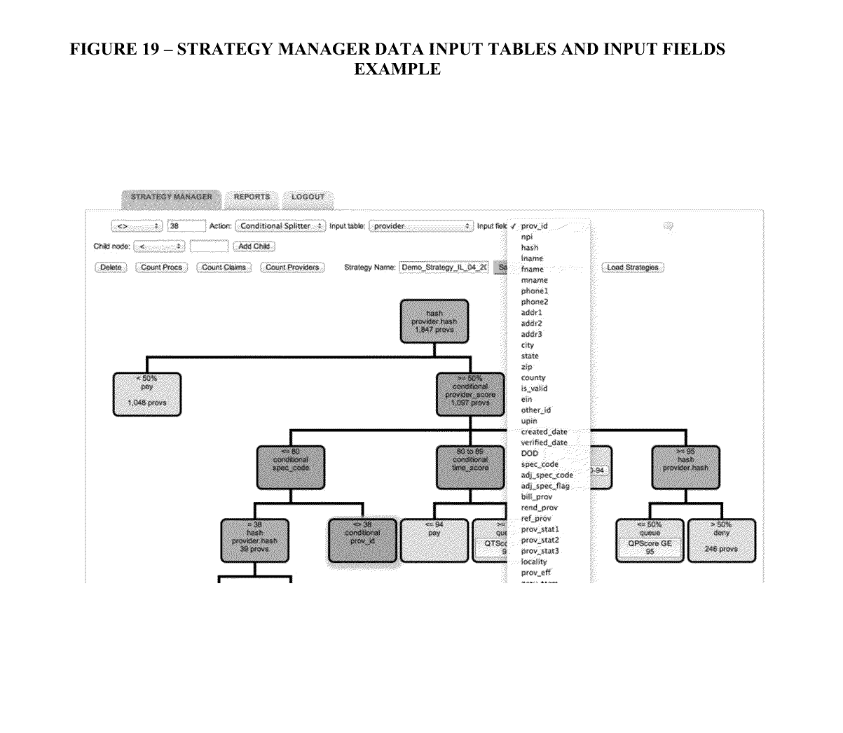

A plurality of raw or derived internal and external attributes, captured or created during the pre processing step and the scoring step, as well as all Predictive Models Scores and Reasons, Provider Cost Index and Edit Analytics are available for testing and use within the Managed Learning Environment. The top of FIG. 19 displays an example of the data table access and data field available for use. All table levels of data are available for access, for example claim, provider, beneficiary, healthcare merchant or industry segment.

Key population reporting and cost benefit analysis supports this solution, with the ability to measure ROI on experimental design. For example:
Dynamic model validation and strategy validation analysis and reporting is made available upon request to ensure that a strategy or predictive model has not degraded over time or is no longer effective.
Reporting is created and made available for population estimates of what claims were flagged, what claims received treatment and ultimately what results occurred—fraud or abuse identification or normal claim, for example (by segment or decile).

Contact Management is a component of the Managed Learning Environment. It works within the Workflow Management process to effectively, efficiently and optimally interact with Beneficiaries and Providers. Interactions can be payment interventions (denials) or messaging sent directly to Beneficiaries, Providers, Healthcare Merchants or Facilities through email, phone, electronic message or letter. The Strategy Manager actions are set up for Provider education or Beneficiary intervention. The capabilities provide for a soft-gloved messaging approach for a marginal Fraud and Abuse score, or phone call with a harder talk-off for a high fraud and abuse score (where a low score is low risk and a high score is high risk and likely fraud or abuse). Each contact has a cost and each outcome an expected return. The objective of the Contact Management component within the Managed Learning Environment is to test and converge towards the optimal outcome and return. In addition to the internal data, external data, external scores, Predictive Models, Provider Cost Index, Edit Analytics, Contact Management also utilizes the following data for targeting:
Promotion history—number of contacts and type of contact (letter, email, phone call, for example)
Response history—outcome of each interaction (no action, adjustment for example)
Financial history—cost per contact and financial savings

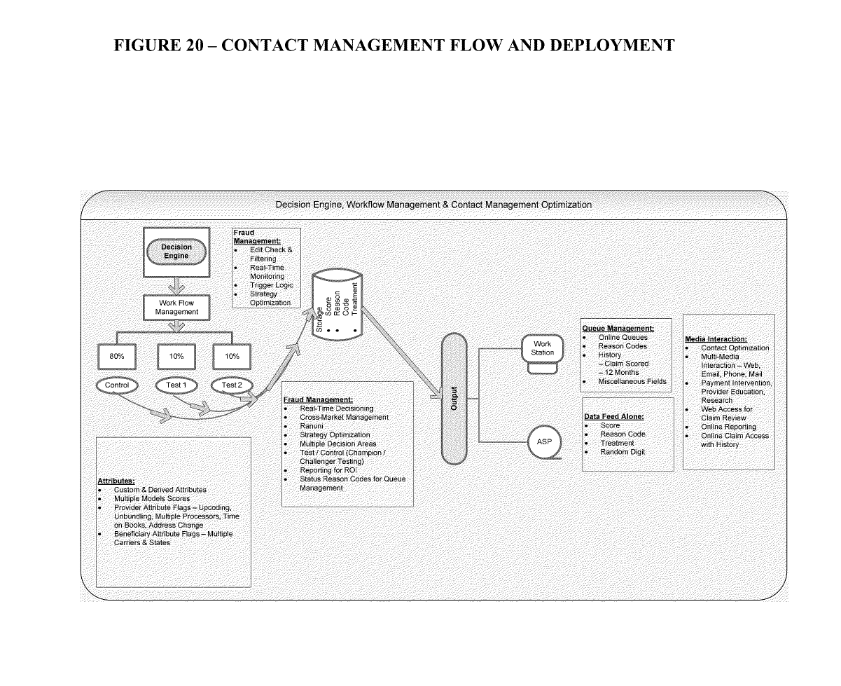

Contact Management is not a capability that stands alone, but an ability that resides inside of the Managed Learning Environment. Contact Management without the ability to test actions and measure results is a sub-optimal capability. See FIG. 20 for an example of the flow.

### Queue Deployment, Forensic Graphical User Interface for Investigations, Reporting

Output from the Strategy Manager and Managed Learning Environment with the Automated Healthcare Risk Management System automatically presents the highest risk and most valuable claims, providers, healthcare merchants and beneficiaries to queues within the Forensic Graphical User Interface (GUI) for an investigator to work. Investigators are not “looking” for suspects, as the case would be in a BI Tool or a Data Mining Tool—they are investigating high likelihood cases that have failed risk management criteria within the Strategy Manager.

FIG. 17 provides an example of the login screen an investigator would enter for accessing the Forensic Graphical User Interface. Security is limited to viewing only the PHI data, Screens and Case Management Authority allowed by User ID. The login also directs investigators to the client (segment) they are allowed to view and work.

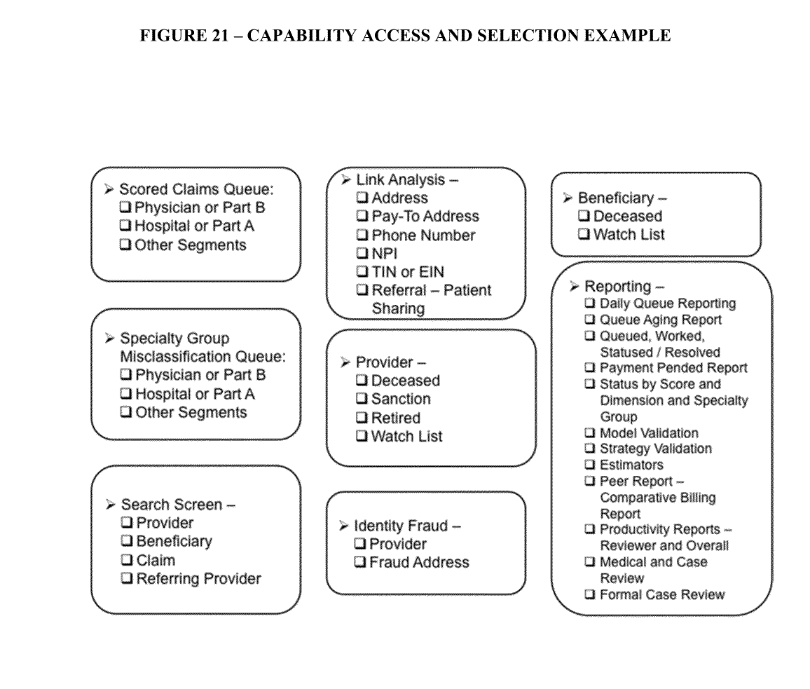

FIG. 21 provides example mapping of the Forensic Graphical User Interface that would be seen after login. An investigator has a choice on where to navigate after the login, but most go directly to queues that are pre-populated with claims, providers, healthcare merchants and beneficiaries who were targeted and identified as potential fraud, abuse, waste, over-servicing, over-utilization or error based upon the claims they submitted. The investigator isn't required to “look” for suspects, the Strategy Manager funnels the highest-risk, most valuable suspects to pre-determined queues that are available in real-time.

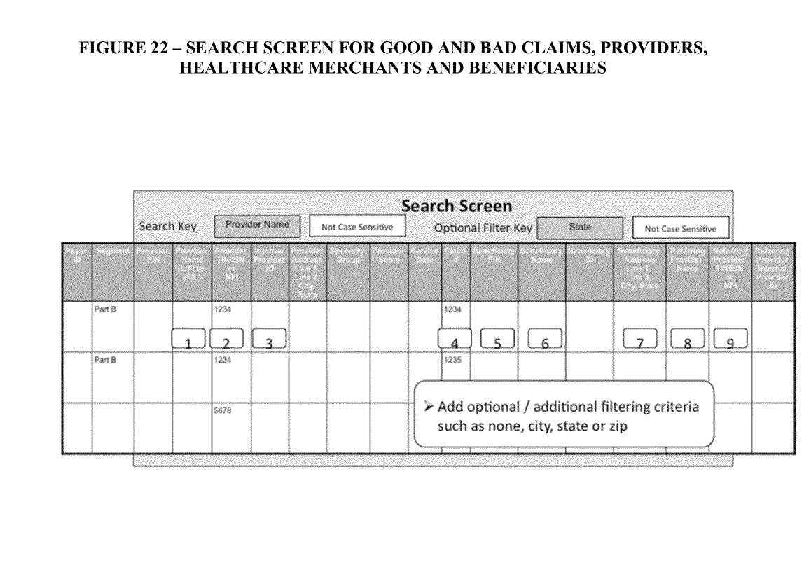

Specialized investigators are allowed to navigate to other screens in order to research fraud and abuse that is more complex:
Misclassification Queue—investigation queue that contains providers or healthcare merchants whose claims submitted don't match their specialty or facility designation, for example a Family Practice physician submitting brain surgery claims
Link-Analysis Simulation and Queuing—investigation capabilities that “link” multiple providers, beneficiaries, healthcare merchants and claims utilizing together using common matching logic to identify collusion
Provider and Beneficiary Deceased and Watch List Queues—Isolates Providers and Beneficiaries who have been designated with a pre-determined issue that doesn't require in-depth investigations, but standardized actions
Identity Fraud Queue—investigation queue that contains suspect participants that are likely fraudulent identities based upon failing identity or address criteria through Strategy Manager
Search Screen—provides ad hoc research capabilities for investigators attempting to identify additional participants within a fraud or abuse case (FIG. 22)
Reporting Screen(s)—immediate access to production and on-demand reporting for a operations leader or investigator in order to fulfill their role

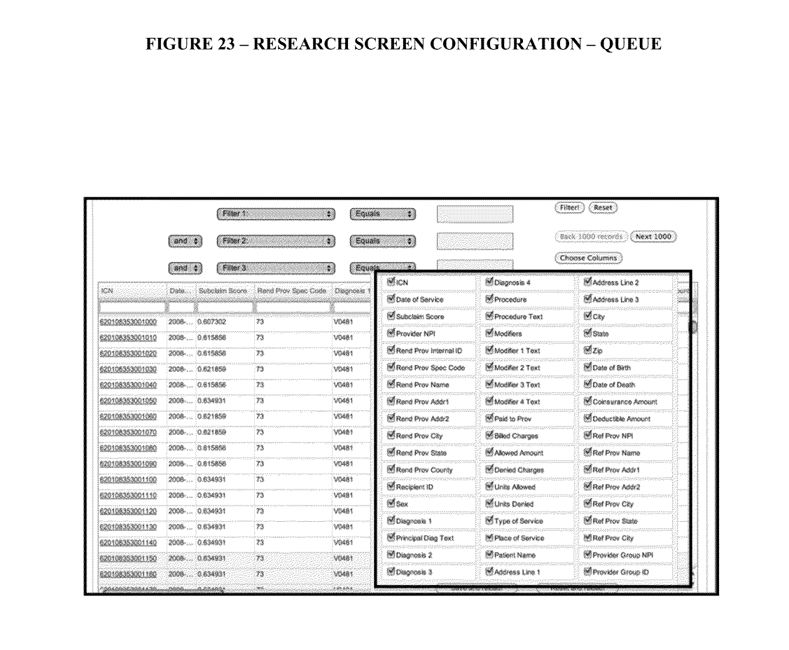

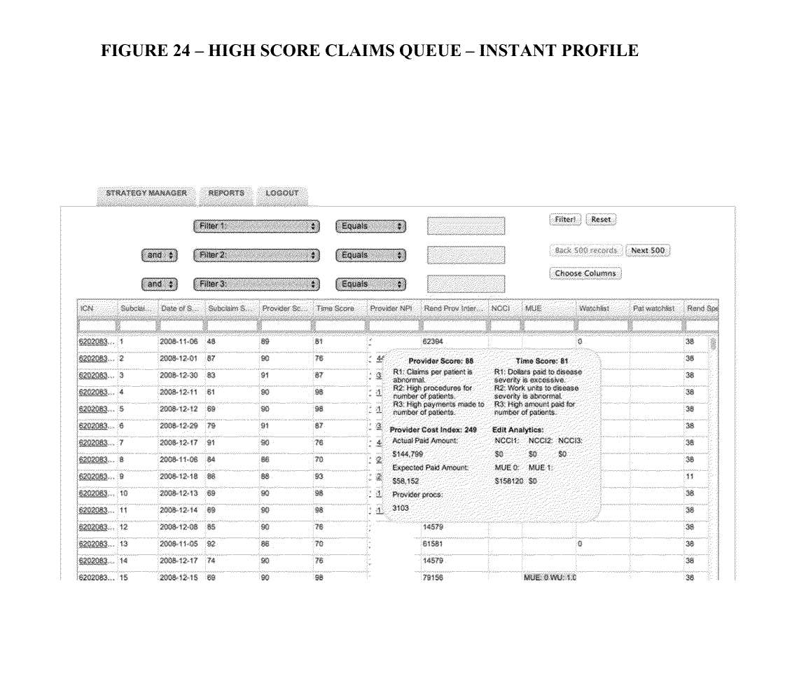

FIG. 16 provides an example of a queue of high-scoring suspect fraud or abuse providers and their claims. It is the investigators starting point when pursing fraud or abuse. The screen is point and click and can drill down on individual claim, provider, healthcare merchant or beneficiary. Each column within the queue is sortable in ascending or descending order. The box below each column heading has a filter capability to group together claims, providers, healthcare merchants or beneficiaries that are similar due to their claim behavior, diagnosis, illness burden or scores for example. Filters also exist at the top of the screen to perform multi-dimensional (and, or, <, >, <=, >=, = for example) filtering from the database to further isolate suspects. Each column is drag and drop, meaning the column order can be rearranged to meet each individual investigators preference. FIG. 23 displays column customization that allows an investigator to include or exclude columns of data from the queuing structure. These preferences are saved and available the next time an investigator logs in. This level of customization allows improved investigator efficiency and effectiveness abilities, which are lacking from prior art case management, workflow or BI Tools. FIG. 24 provides instant risk profile highlights by hovering over a provider, healthcare merchant or beneficiary within the queue. This capability provides an immediate snapshot of risk and opportunity to the investigator. Predictive Model fraud and abuse scores and reason codes, the Provider Cost Index and Edit Analytics are immediately available for the investigator to view. As you can see in FIG. 24, all Predictive Model Scores (sub-claim, provider, time scores for example), Provider Cost Index and Edit Analytics (NCCI and MUE failures) information is available to the investigator in the queue.

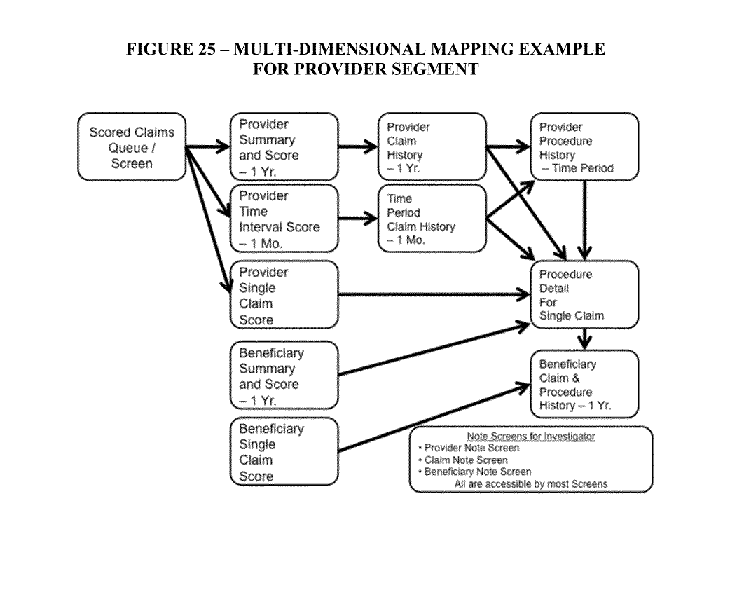

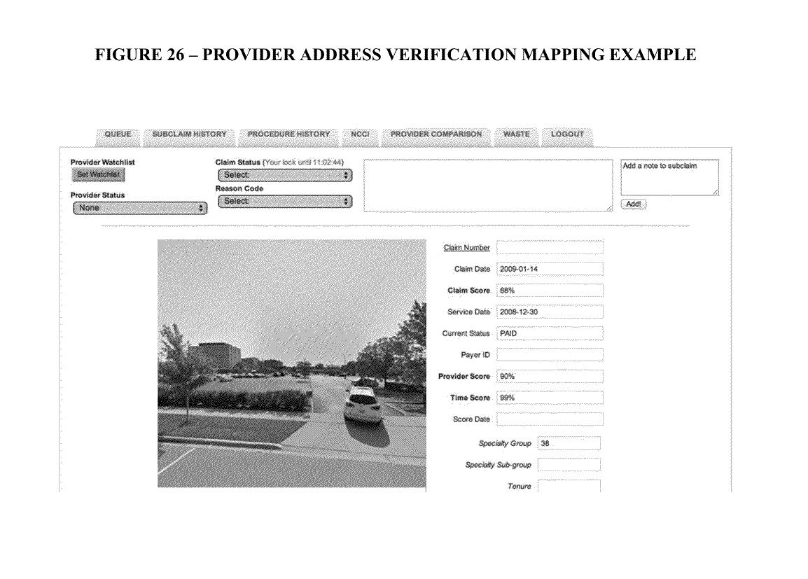

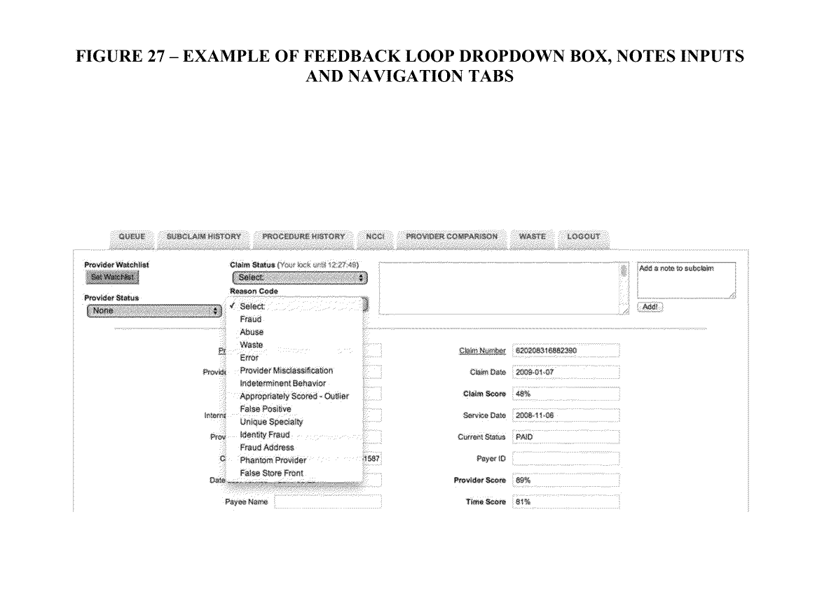

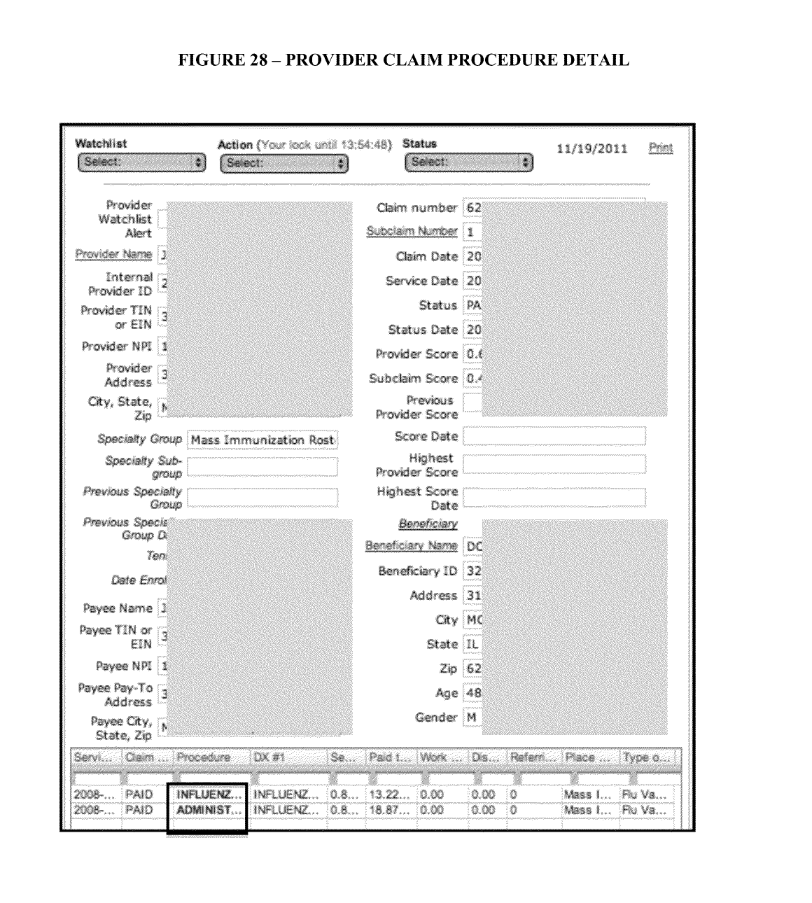

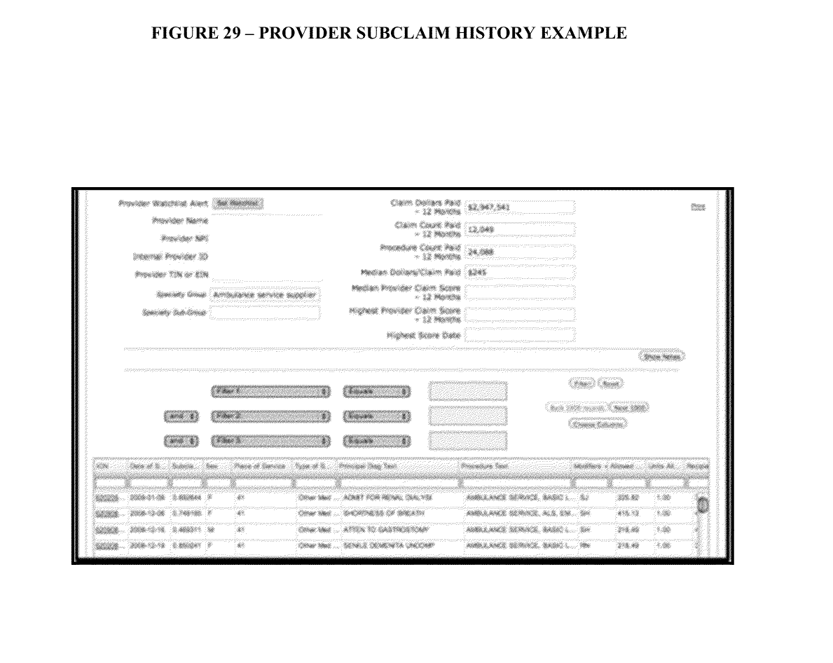

FIG. 25 is a navigational map example, that displays the path an investigator could pursue to research a suspect claim, provider, healthcare merchant or beneficiary. Levels of investigation take multiple paths to pursue suspects, for example:
Navigating from the queue to a provider summary or beneficiary summary screen—each includes individual demographics, behavioral characteristics and scores. It also provides score reason codes to suggest to where an investigator should focus their efforts. This information is highlighted in FIG. 4. FIG. 26 provides an example of address verification capabilities in the provider summary screen. Many times phantom providers (fake providers submitting claims) submit claims from addresses such as parking lots, prisons addresses, check cashing facilities, or motels. This street level visual provides the ability to view the address of the individual submitting the claims. The provider and beneficiary screens also provide drop down boxes at the top for taking action on a claim, provider, healthcare merchant or beneficiary. Providers can be paid, declined, educated for example. FIG. 27 provides an example on how providers can be statused as fraud, abuse, waste, error, false positive or misclassification for example. The statuses and actions are customizable by the client. The ability to put a provider, healthcare merchant or beneficiary on a watch list also exists. Any action taken is captured in a database and published in the notes box at the top of the screen along with the User ID. This information is feed to the system of record for the client and to the feedback loop for subsequent predictive model and strategy monitoring, return analysis and possible redevelopment. Note that any action taken is immediately available to the Strategy Manager for use in identifying new and emerging trends. Free form notes can also be input to capture findings or notes required for Case Management. Separately, these screens have the ability to complete real-time download of screen information to a CSV file required for storage into the Case Management.
The investigator has the ability to navigate from the summary screens to provider, healthcare merchant or beneficiary claim or procedure history. FIG. 28 is an example of provider procedure detail history. In real-time, the investigator can column filter, sort in ascending or descending order or perform complex filters to isolate information for ease of understanding. FIG. 29 is a claim—level view of the provider history. Two views were created for investigators because a single claim can have multiple procedures associated with it. Similar to the provider summary screen, these screens also provide drop down boxes at the top for taking action on a claim, provider, healthcare merchant or beneficiary. Any action can be taken and is captured in a database and published in the notes box at the top of the screen along with the User ID. This information is feed to the system of record for the client and to our feedback loop for subsequent model and strategy monitoring, return analysis and possible redevelopment. Note that any action taken is immediately available to the Strategy Manager for use in identifying new and emerging trends. Free form notes can also be input to capture findings or notes required for Case Management. These screens have the ability to complete real-time download of screen information to a CSV file required for storage into the Case Management.

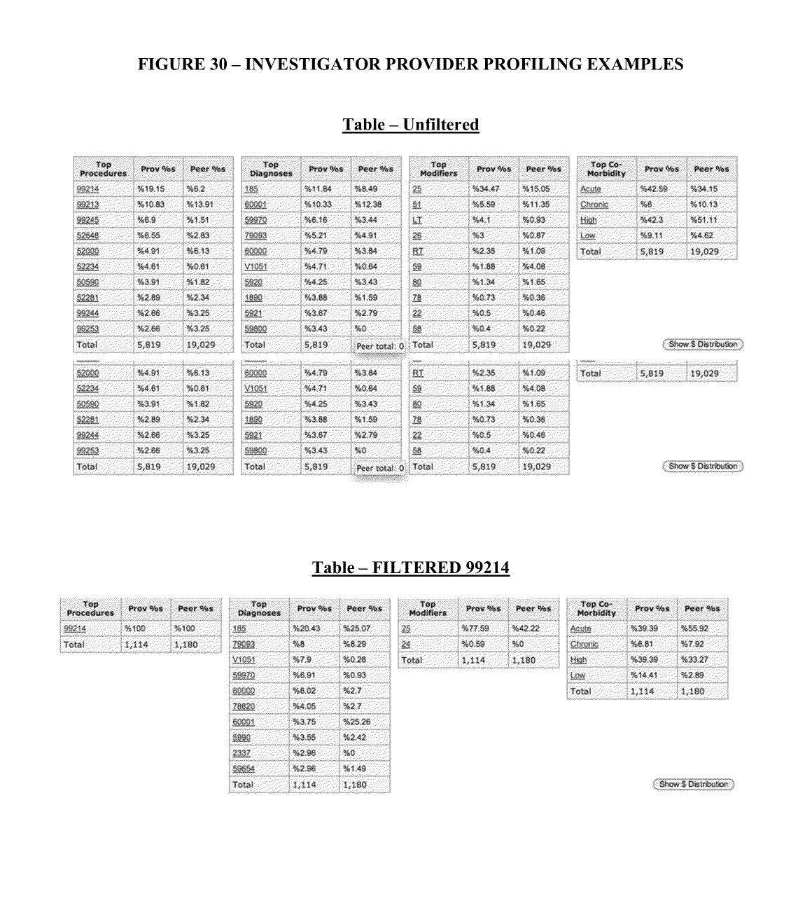

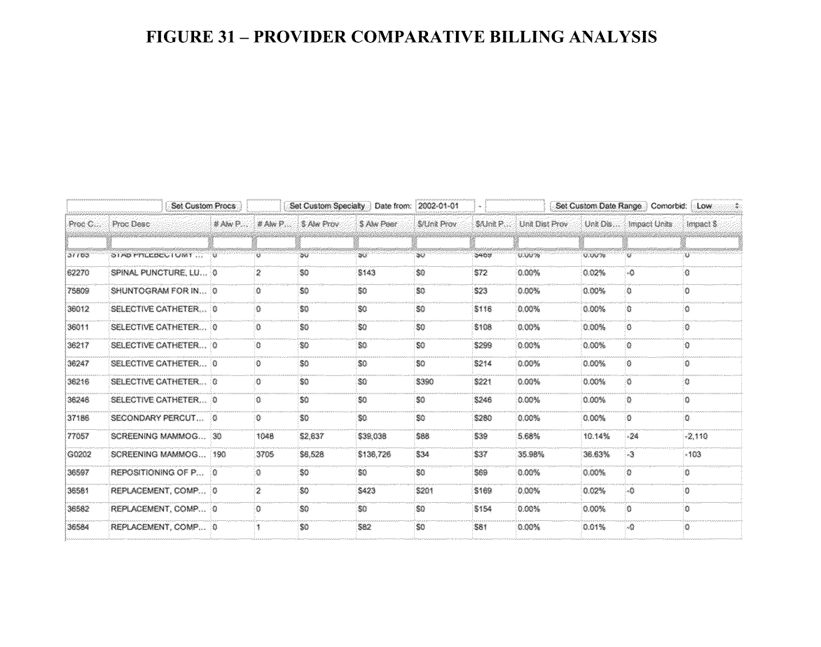

There are occasions where viewing historical procedure or claims information isn't enough to make a decision. Additional analysis screens are included to guide an investigator to a final conclusion:
Top 10 Behavior Comparisons—Procedures, Diagnosis, Modifier Usage and Patient Co-Morbidity is available, for example to compare a provider within his specialty to a cohort to identify up-coding. FIG. 30 provides a view of this provider profile. An investigator can also normalize provider behavior by clicking on, for example a procedure code to filter only the diagnosis, modifier usage and patient health that this procedure was used for—bottom of FIG. 30. In this case 99214 is an expensive procedure code used for more chronic patients, yet in the filtering results, the co-morbidity table indicates that over 14% of the providers patients were low co-morbidity (health) as compared to approximately 2% for the cohort population. Any category (row heading) within the four tables can be used for filtering. There are also separate querying capabilities for procedures not present in the Top 10 table.
Provider Comparative Billing Analysis—FIG. 31 displays procedures of an individual provider as compared to his cohort population. The function of this screen is to verify provider misclassifications (for example a Family Practice physician performing brain surgeries) and to estimate overpayments for a one to one comparison of a provider to his cohorts. In the misclassification example, it will be easy to see how the individual providers performance compares to his cohorts. Many times a providers specialty is captured wrong when they enroll and therefore look like fraud or abuse because they have aberrant behavior as compared to their cohort behavior. The Comparative Billing Analysis also provides the ability to filter and normalize to the right specialty in the case of a misclassification to ensure it is not fraud. Estimating overpayments is an important part of an investigators role once a suspect is identified for fraud or abuse. The Comparative Billing Analysis systematically calculates the overage or underage based upon the procedures submitted. There are additional filtering capabilities to normalize based upon patient health (co-morbidity), procedures, diagnosis and specialty to ensure an apples to apples comparison has been made between the provider and the cohort population. All results are available to download to a CSV file for the Case Management component of the investigation.

Note that neither the Top 10 Behavior Comparison Screen nor the Provider Comparative Billing Analysis Screen is for an investigator to look for fraud, abuse, waste, over-servicing, over-utilization or errors, it is for validating a decision or performing further research to appropriately classify a case. Remember that all of the suspect providers, healthcare merchants or beneficiaries under investigation originated by failing risk management criteria. These are not database mining or BI Tools looking for suspects—they are for providing critical information to resolve a case.

Reporting is upon demand within the Automated Healthcare Risk Management System. FIG. 21 displayed the navigation path and the types of reports that were available to investigators. A feedback loop, integrated into the Workflow Management design, dynamically “feeds back” outcomes of each claim (transaction) that is “worked”. This feedback loop, containing claims flagged as fraud, abuse or good, for example allows the system to dynamically update model coefficients:
Feedback Loop—This reporting involves the tagging (or recording and labeling) of known, confirmed fraud or abuse, for example, and appending this information onto the original claim as an “outcome”. This tagging of the original claim as either “fraud,” “abuse,” or “not fraud” enables the solution to monitor performance and changing fraud trends. It also enables the ability to refine or re-develop score models to enhance their performance. This tagging is termed the “feedback loop” and it is designed to both monitor score performance and to enable development of even more sophisticated predictive models in the future.
Dynamic model validation and strategy validation analysis and reporting available upon request to ensure that a strategy or predictive model has not degraded over time or is no longer effective.
Reporting available for population estimates of what claims were flagged, what claims received treatment and ultimately what results occurred—fraud or abuse identification or normal claim (by segment or decile).

1. A method for identifying and preventing improper healthcare payments, comprising the steps of:
a. access data on historic claims;
b. analyze the data to create a predictive scoring model;
c. access at least one current claim to process;
d. calculate at least one fraud and abuse score for the at least one current claim;
e. provide reason codes to support the calculated fraud and abuse score for the at least one current claim;
f. process the at least one claim against a Provider Cost Index;
g. process the at least one claim using Edit Analytics decision logic;
h. sort and rank the at least one claim based upon the at least one predictive model score, Provider Cost Index and Edit Analytics failures,
whereby the capability to cost-effectively identify, queue and present only the highest-risk and highest value claims to investigate.

2. The method of claim 1 wherein the predictive scoring model is based on using non-parametric statistical measures.

3. The method of claim 1 wherein the at least one fraud and abuse score can comprise one or more of a sub-claim score, a provider score or a time score.

4. The method of claim 1 wherein the at least one predictive model score which is used as part of the sorting and ranking comprises a plurality of empirically derived and statistically valid model scores generated by multi-dimensional statistical algorithms and probabilistic predictive models that identify providers, healthcare merchants, beneficiaries or claims as potentially fraudulent or abusive.

5. The method of claim 1 further including the step of creating empirical decision criteria and decision parameters in real-time, using the predictive models, scores, Provider Cost Index, Edit Analytics results or data to systematically evaluate, trigger and investigate specific claims or transactions, created by providers, healthcare merchants, beneficiaries and facilities who are determined to be risky.

6. The method of claim 1 further including the step of randomly testing new models, data, actions, treatments and contact methods against control positions and measure incremental benefits using a Managed Learning Environment.

7. The method of claim 1 further including the step of deploy dynamic real-time or batch queuing, so that immediate results can be accessed via a Forensic Graphical User Interface (GUI), with Case Management by multiple investigator levels of experience and stake holders selected from the group consisting of nurses, physicians, medical investigators, law enforcement, adjustors and risk management experts.

8. The method of claim 1 further including the step of utilizing nurses, physicians, medical investigators, law enforcement or adjustors to research and interrogate claims, providers, healthcare merchants or beneficiaries, triggered by decision strategies, and provide timely resolution to complex improper payment scenarios.

9. The method of claim 1 further including the step of executing a Feedback Loop and systematically optimizing decision strategies, contact management strategies, treatment and actions, as well as measure the incremental benefit of a test over a control position.

10. The method of claim 1 further including the step of empirically optimizing strategy management algorithms that are designed to adapt to changing patterns of cost dynamics for improper payments.

11. The method of claim 1 further including the step of performing population risk adjustment modeling and profiling capabilities, to allow an investigator a mathematical and graphical capability to normalize population health and co-morbidity and follow beneficiary care and provider services and treatments across all healthcare segments, provider specialty groups, healthcare merchants, geographies and market segments.

12. The method of claim 1 further including the step of performing empirical comparisons and statistical analyses performed on “similar” types of claims, providers, healthcare merchants and beneficiaries, using statistical methods, including but not limited to methods such as Chi-Square.

13. The method of claim 1 further including the step of treatment optimization, in which new treatments are tested, using unbiased and scientifically approved sampling methods or techniques, to improve efficiency and effectiveness, through a Managed Learning Environment.

14. The method of claim 13 wherein the treatments are selected from the group consisting of queue, research, payment, decline payment, educate, and add a provider to a warning list.

15. The method of claim 7 wherein dynamic navigation is provided through the Forensic Graphical User Interface that allows a user to quickly navigate through a complex collection, but efficiently organized, amount of data to quickly identify, fraudulent, abusive, wasteful or compliance edit failure activity by an entity, and efficiently bring resolution such as decline, pay or queue.

16. The method of claim 1 further including the step of systematic analysis and reporting of score performance results, including:
a. A Feedback Loop to dynamically update model coefficients or probabilistic decision strategies, as well as monitor emerging improper payment trends in a real-time fashion;
b. Validation and on-demand queue reporting available to track improper payment identification and model and strategy validations;
c. Complete cost benefit analysis that provides normalized estimates for fraud and abuse prevention, detection or recovery;
d. Risk adjusted waste, over servicing or overutilization assessments that calculate provider cost or waste indexes, that are presented mathematically and graphically for use in educating the provider or creating cohort benchmarks for determining punitive actions;
e. Error assessment analysis and recovery estimates, and
f. Business reports that summarize risk management performance, provide standard, ad hoc, customizable and dynamic reporting capabilities to summarize performance, statistics and to better manage fraud, abuse, over-servicing, over-utilization, waste and error prevention and return on investment.

17. The method of claim 1 further including the step of providing real-time triggers to activate intelligence capabilities, combined with predictive scoring models, to take action when risk thresholds are exceeded.

18. The method of claim 1 further including the step of providing real time monitoring, measuring, identification and visual presentation of performance and changing patterns of fraud or abuse in a dashboard format for an operations (“ops”) room, control room or war-room type display environment.

19. The method of claim 1 further including the step of securely memorializing investigations, documentation, action, files and data through an internal or external case management system that can be accessed through multiple electronic mediums, including, but not limited to a smartphone, a computer, a tablet or a notepad.

20. The method of claim 1 further including the step of providing investigator analysis and real time filters, which allows a healthcare investigator to explore complex data relationships and underlying individual transactions, as identified by the mathematical algorithms and probabilistic model scores and their associated reason codes when a provider, healthcare merchant, beneficiary or claim is identified as high risk.

21. The method of claim 1 further including the step of statistically and empirically comparing a unique provider's activities with activities of similar populations to contrast provider behavior for those providers who are identified as high risk.

22. The method of claim 1 further including the step of statistically and empirically comparing a unique healthcare merchant activities with activities of similar populations to contrast healthcare merchant behavior for those healthcare merchants who are identified as high risk.

23. The method of claim 1 further including the step of statistically and empirically comparing a unique beneficiaries activities with activities of similar populations to contrast healthcare merchant behavior for those healthcare merchants who are identified as high risk.

24. The method of claim 1 further including the step of statistically and empirically comparing a unique claim activities with activities of similar populations to contrast claims behavior for those claims which are identified as high risk.

25. The method of claim 1 further including the step of statistically and empirically comparing a unique facility activities with activities of similar populations to contrast facility behavior for those facilities which are identified as high risk.

26. The method of claim 1 further including the step of dynamically view dimensions, in real time, that contain automated and targeted reports for researching and resolving fraud, abuse, waste, over-servicing or over-utilization quickly and efficiently.

27. An internet software service for identifying and preventing improper healthcare payments comprising:
a server connected to the internet, the server containing a program running in memory which is configured to:
a. access data on historic claims;
b. analyze the data to create a predictive scoring model;
c. access at least one current claim to process;
d. calculate at least one fraud and abuse score for the at least one current claim;
e. provide reason codes to support the calculated fraud and abuse score for the at least one current claim;
f. process the at least one claim against a Provider Cost index;
g. process the at least one claim using Edit Analytics decision logic;
h. sort and rank the at least one claim based upon the at least one predictive model score, Provider Cost Index and Edit Analytics failures,
whereby the capability to cost-effectively identify, queue and present only the highest-risk and highest value claims to investigate.

28. An Automated Healthcare Risk Management System comprised of:
a. Hosted Software as a Service technology design;
b. Real-time multi-dimensional predictive models to identify individual healthcare cost dynamic fraud;
c. Real-time multi-dimensional predictive models to identify individual healthcare cost dynamic abuse;
d. Real-time multi-healthcare segment population risk-adjusted provider cost index to identify individual healthcare cost dynamic waste;
e. Real-time multi-healthcare segment edit analytics to identify individual healthcare cost dynamic errors;
f. Strategy manager to cost-effectively identify, queue and present only the highest-risk and highest value claims to investigators, as identified by any combination of predictive model score, provider cost index or edit analytics;
g. Managed learning environment, combined with contact management, to segment populations for organizing test/control actions and treatments to measure and maximize return;
h. Forensic graphical user interface, combined with case management reporting system to efficiently navigate, investigate and pursue suspect cases as presented by the strategy manager and managed learning environment.

29. Utilizing a computerized method of claim 28 to uniquely identify the individual healthcare cost dynamics of fraud, abuse, waste and errors using individualized methods:
a. Determining the healthcare state of fraud individually using a computer method to review healthcare claims prior to payment;
b. Determining the healthcare state of abuse individually using a computer method to review healthcare claims prior to payment;
c. Determining the healthcare state of waste individually using a computer method to review healthcare claims prior to payment, and
d. Determining the healthcare state of errors individually using a computer method to review healthcare claims prior to payment.

30. Utilizing the computerized method of claim 28 to review millions of healthcare claims over a selected time period in a real-time fashion.

31. Utilizing the computerized method of claim 28 to individually identify healthcare fraud cost dynamic using predictive models to review healthcare claims prior to payment.

32. Utilizing the computerized method of claim 28 to individually identify healthcare abuse cost dynamic using predictive models to review healthcare claims prior to payment.

33. Utilizing the computerized method of claim 28 to individually identify healthcare waste cost dynamic using population health risk-adjusted models to review healthcare claims prior to payment.

34. Utilizing the computerized method of claim 28 to individually identify healthcare error cost dynamic using industry approved compliance edits and client proprietary edits to review healthcare claims prior to payment.

35. The method of claim 31, wherein the healthcare states are providers providing procedures to clients.

36. The method of claim 31, wherein the healthcare states are healthcare merchants providing procedures to clients.

37. The method of claim 31, wherein the healthcare states are facilities providing procedures to clients.

38. The method of claim 31, wherein the healthcare states are services codes, procedure codes, revenue codes or diagnosis related group for healthcare procedures.

39. The method of claim 31, wherein the healthcare states are:
a. The healthcare providers;
b. The healthcare merchant;
c. Are the healthcare facility;
d. Are the healthcare beneficiary (patient, member or customer).

40. The method of claim 31, wherein the healthcare states are:
a. Provider-days, provider-months, provider quarters or provider-years;
b. Healthcare merchant-days, healthcare-months, healthcare quarters or healthcare-years;
c. Facility-days, facility-months, facility quarters or facility-years, and
d. Beneficiary-days, beneficiary-months, beneficiary-quarters or beneficiary-years.

41. A method of detecting fraud or abuse or waste or errors individually, in the healthcare industry, the method comprising:
a. Inputting historical claims data;
b. Developing scoring variables from the historical claims data;
c. Developing claim, provider, healthcare merchant and patient statistical behavior patterns by specialty group, facility, provider geography and patient geography and demographics based on the historical healthcare claims data and other external data sources and external scores, and/or link analysis;
d. Inputting at least one claim, or components of the claim, for scoring;
e. Combining the variables into the predictive model by calculating a probability score, and
f. Determining a score for at least one claim, using the predictive model selected from the group consisting of the predictive model which detects fraud, the predictive model which detects abuse, the predictive model which detects waste.

42. A method of detecting errors individually, in the healthcare industry, the method comprising:
a. Inputting historical claims data;
b. Developing edit analytics variables from the historical claims data;
c. Developing edit compliance errors by specialty group, facility, provider geography and patient geography and demographics based on the historical healthcare claims data and other external data sources and external scores, and/or link analysis;
d. Inputting at least one claim, or components of the claim, for calculating the edit analytics;
e. Combining the variables into the edit analytics by applying compliance or client edits, and
f. Determining an edit failure for at least one claim, using the edit analytics which determines errors.

43. The method of claim 41 including the step of creating empirical decision criteria and decision parameters real time, within a strategy manager, using for example, predictive models, scores, provider cost index, edit analytic results or internal or external data to systematically evaluate, trigger and investigate specific claims or transactions, created by providers, healthcare merchants or beneficiaries who were determined to be risky.

44. The method of claim 41 including the step of utilizing a managed learning environment, with contact management design embedded within strategy manager to randomly test new concepts, models, data, actions, treatments and contact methods against control positions and measure incremental benefits.

45. The method of claim 41 including the step of deploying real time or batch queuing, based upon strategy manager criteria, managed learning environment and contact management design, where immediate results can be accessed via a Forensic Graphical User Interface (GUI), with Case Management by nurses, physicians, medical investigators, law enforcement or adjustors and risk management experts.

46. The method of claim 41 including the step of executing a feedback loop and systematically capture actions, outcomes and performance.

47. Utilizing the method of claim 43 of the strategy manager to:
a. Create real-time queues for investigators to access suspect providers, healthcare merchants, beneficiaries and facilities;
b. Make real-time changes to strategies, criteria or thresholds to quickly respond to emerging trends of fraud, abuse, waste, errors;
c. Access external data or external scores to include in strategies or criteria;
d. Take automated actions such as pay, decline, queue or educate based upon risk and expected value of suspect claim, provider, healthcare merchant, beneficiary or facility, and
e. Status suspect claim, provider, healthcare merchant, beneficiary or facility as fraud, abuse, waste or error.

48. Utilizing the method of claim 44 of the managed learning environment to:
a. Utilize experimental design with random digits to test different actions or treatments at claim-level, provider-level, healthcare-merchant level, beneficiary-level and facility-level
b. Test new strategies, models, actions, treatments and data against the control position;
c. Measure the incremental benefit of a test over a control position through controlled testing, and
d. Utilize contact management to optimize interaction costs and outcomes from touch points such as letter, email, call, face to face meeting between investigators and participants such as provider, healthcare merchant, beneficiary or facility.

49. Utilizing the method of claim 45 of the forensic graphical user interface to:
a. Investigate fraud, abuse, waste and errors individually within segregated queues and screens;
b. Access 1-2 years of historical procedure, claim, provider, healthcare merchant, beneficiary or facility data with only a click of a mouse;
c. Execute efficient resolution to suspect cases identified using transparent reason codes from models, cost index and edit analytics; and
d. Memorialize case outcomes via notes, actions taken and data in the case management design.

50. Utilizing the method of claim 46 of the feedback loop to:
a. Systematically update predictive model coefficients for fraud models using feedback loop outcomes;
b. Systematically update predictive model coefficients for abuse models using feedback loop outcomes;
c. Systematically update provider cost index using feedback loop outcomes;
d. Automatically adjust strategy manager, including actions and treatments based upon feedback loop outcomes, and
e. Measure the incremental benefit of a strategy, model or data test over the control position.
